(19) United States
(12) Patent Application Publication
(10) Pub. No.: US 2004/0009462 A1
(43) Pub. Date: Jan. 15, 2004

(54) Learning system

(76) Inventor: Linda Kay McElwrath, Corinth, TX (US)

Correspondence Address: GRAY CARY WARE & FREIDENRICH LLP, 153 TOWNSEND, SUITE 800, SAN FRANCISCO, CA, 94107, US

(21) Appl. No.: 10/442,643

(22) Filed: May 20, 2003

Related U.S. Application Data
(60) Provisional application No. 60/382,203, filed on May 21, 2002.

(51) Int. Cl. G09B 3/00

(52) U.S. Cl. 434/350

(57) ABSTRACT

A method of developing a customized electronic course of study includes identifying course content relating to one or more particular courses of study and electronically generating multiple learning modules based on the identified content. The learning modules are stored according to multiple learning preference profiles for selective electronic retrieval and delivery in generating the customized electronic course of study based on a selected learning preference profile.

### PRIORITY

This application claims the benefit of priority to U.S. provisional patent application serial No. 60/382,203, filed May 21, 2002, entitled, “Learning System”, which is hereby incorporated by reference.

### BACKGROUND

1. Field of the Invention

The present invention relates to on-line learning, particularly electronic development, storage, retrieval and/or delivery of customized courses of study.

2. Description of the Related Art

Ninety-five percent of everything we now understand about how human beings learn has been discovered in just the last twenty years of our history. For instance, we now understand that:

1. No two people learn in exactly the same way;

2. Up to 80% of everything that is “learned” is soon forgotten;

3. The first 30 seconds of any new memory formation is crucial;

4. Each of our brains is physically different from any other human being's brain;

5. Our brain continues to change throughout our lifetime because of how we use it;

6. The more senses we use when we are introduced to new information, the better our chances of recalling it later;

7. The timing of the presentation of any new knowledge is important;

8. It is possible to improve recall by as much as 90%;

9. The number of learning strategies used when acquiring new information is more important than the amount of time spent studying; and

10. Specific strategies can be used by learners to radically improve their learning performance.

Many of our schools are in crisis. Almost every week we read about increasing drop-out rates, the poor showing made by students in the United States in math and science, and low standardized test scores.

This is occurring at a time when the body of knowledge in almost every field is exploding. When what is taught can become obsolete in as little as a few months, it is clear that never before in our history has the ability to learn (or relearn) quickly, recall what we learn for long periods of time, and be able to apply what is taught more important.

Yet very little of what has been discovered in the past twenty years about how human beings actually learn has been put into use in our educational systems. The primary methodology for designing and delivering instruction . . . whether in the classroom or on the web . . . is still based on the 500-year-old lecture model that was popularized in the Middle Ages with the rise of the university.

It is our belief that the desired outcome will not happen until the findings of neurological and cognitive research is put into practice in both our school systems and corporate training programs.

For examples of how others deal with this issue, see the demo on www.knowledgextensions.com, the demo of the fire extinguisher instruction on www.infrature.com, and the demo of the PowerPoint instruction using Shockwave technology on www.elementK.com. Note that in the case of KnowledgeXtension, no special attempt has been made to do more than present instruction primarily for visual learners. Only one sense is engaged. In Infrature's fire extinguisher example, note that simple graphics, sound clips, and one activity are included, but all of these sensory elements are very simplistic. In Element K's Power Point demo, an example is provided in regard to the use of sensory stimuli. Each of these online courseware providers utilize “one size fits all” instruction. In other words, all students see exactly the same sensory stimuli, regardless of what their own personal sensory preference is.

In addition to above mentioned web sites, there is Richard Felder's home page at www.ncsu.edu/felder-public/RMF.html. Dr. Felder is one of the proponents of metacognitive styles and his web page contains examples of some of his original research into these. Dr. Felder's approach is, however, applied strictly to the classroom setting. It is desired to have an on-line learning system that utilizes metacognitive research applications, and to use this knowledge to deliver instruction through technology that is generated based on individual preferences.

There are a number of learning preference assessments that are available to learners. They are available in both online and offline formats. Most of those assessments, however, measure only sensory preferences. Those few who do measure metacognitive preferences, do not measure sensory preferences. The ones most often used are built on either the Kolb model, or the Felder-Silverman model.

Howard Gardner, developer of a widely accepted theory of multiple intelligences, summed up the situation during an interview on a tape entitled “Reinventing Our Schools” in 1994 by stating “Whether or not people buy my own theory of different kinds of intelligence, everybody nowadays realizes that the context in which you learn things is very important and that people don't have the same kinds of styles”. Gardner identified eight types of learning preferences that differentiate how individuals learn. According to Gardner, they are visual/spatial intelligence, musical intelligence, verbal intelligence, logical/mathematical intelligence, interpersonal intelligence, intrapersonal intelligence, bodily/kinesthetic intelligence, and natural intelligence. His theory has been utilized in classroom settings in “the Key School”. For further definitions and examples of how he is using these learning preferences, see Gardner, Howard. (1993) Multiple Intelligences: The Theory in Practice, New York, NY: Basic Books, which is hereby incorporated by reference.

Another approach is taken by David Kolb (researcher in the field of experiential learning) who has defined learning styles as cognitive/reflective, abstract/reflective, abstract/active, and concrete/active. His research is also being applied only in the form of suggestions as to how these learning preferences can be utilized by classroom teachers (see www.gyrus.nu/Pedagogical_Resources/learning_Styles_Prompts.html).

Another approach is to define sensory and metacognitive preferences by a stand-alone sense, organizing, or associative sytle. In addition to classroom applications of this approach (see Dunn, R. and Dunn, K. (1987), “Understanding the learning styles and the need for individual diagnosis and prescription”, Columbia, Conn.: The Learner's Dimension), there are examples in the art of using technology to deliver learning experiences by style (see www.langara.bc.ca/biology/HOLMWOOD/whichwebct.htm. In this case, however, a student can only choose to work with one learning preference at a time. It is desired to have a system wherein a student can work with multiple learning preferences at a time, and/or a weighted distribution toward a particular preference or preferences.

Another approach is the Gregorc Model. Gregorc classifies learner preferences as concrete/sequential, abstract/random, abstract sequential, and concrete/random. Gregorc made three inferences based on his research. One inference is that “learning styles emerge from inborn, natural predispositions or proclivities” (see Gregorc, A. F. (1979), Learning/Teaching Styles: Their nature and effects, Student learning styles: Diagnosing and prescribing programs. (19-26)). Another is “The instructional materials and techniques used by teachers have a direct effect on many students. If the approach fit the preferred learning mode, the learner usually reacted favorably. If, on the other hand, the methods were mismatched, the student “worked hard to learn”, “learned some and missed some material”, or “tuned out”. (Gregorc, A. F. & Ward, H. B. February, 1977) A new definition for individual, NASSP Bulletin.)

### RECOGNIZED IN THE INVENTION

It is recognized in the present invention that not all people learn most effectively in exactly the same way, and that learning can be improved overall if students are provided instruction according to their personal learning preferences. Recent neurological research has demonstrated that every person is born with a brain that is physically unique. One person may be born with a larger area to store visual images, while another's brain may be adapted to store auditory or kinesthetic experiences. Neural connections between various parts of the brain differ in both number and location. Brain chemistry may change from one person to the next, and our genetic programming assures that the setup of our nervous system is unique. What's more, research done by numerous cognitive psychologists has found that the brain continues to physically change throughout our lives depending on how if is used.

The lesson learned through these discoveries is that because of both physical and behavioral differences, we have each acquired distinctive personal styles of learning. Trying to store and recall new information with an approach that doesn't match our own unique strengths and weaknesses can be difficult and sometimes even impossible. “One-size-fits-all” teaching methodologies can never address this issue. It is recognized in preferred embodiments that there is a desire to emphasize the sensory preference of the individual by giving them more of the media elements that best suit their learning style. For example, the appearance of a screen that a visual learner may receive for a particular learning module in accordance with a preferred embodiment (see below) may differ from the appearance of a screen that an auditory learner may receive for experiencing the same learning module.

Individual Learning Preferences are Comples

It is further recognized in preferred embodiments herein that not only do humans beings possess one or more individual preferences in storing sensory input, but there are also multiple preferences in how the brain forms mental associations with that data so that what was learned can be effectively recalled at a later date. These preferences make up the metacognitive styles of the human brain.

The message for educators and trainers is that although it is preferable and advantageous to know and present educational material based on which sense or senses that a particular learner favors, e.g., visual, auditory, verbal, and/or kinesthetic, further improvement is possible and achieved in preferred embodiments (see below). While creating curriculum that appeals to sensory preferences is advantageous over that which would utilize a single sensory preference, this strategy can be improved further if the learner is provided material in a way that permits an association with what is observed through the senses in a way that can be easily recalled over time.

It is therefore further recognized herein that it is desired to provide a learning approach that addresses metacognitive preferences. For example, is it easier for the particular student to organize information globally or sequentially? Would the student respond better to a concrete or an abstract presentation of new material? Does the student prefer to work in a group (active) or alone (reflective)? Does the student rely primarily on intuition or on analysis?

A Multisensory Approach is More Effective

It is understood that information received from our environment via our senses is stored in different areas of the brain. For instance, visual images are stored in one area, auditory input is stored in another, the feeling of things you touch are stored in a third area, and so on.

If an individual is exposed to input from multiple senses when they first encounter an object or a concept, the memory is stored in multiple areas of the brain. If a person wants to recall that memory at a later date, they may remember just one of those stimuli and their brain can automatically reassemble the entire memory from all storage areas.

Prove it to yourself. Look at a picture of an orange. While you are viewing the orange, can you instantly recall what an orange tastes like? Smells like? Feels like? The reason that your answer is probably a resounding “yes” is that when you first “learned” what an orange was, you most likely saw, tasted, and smelled the orange within the same few seconds it took you to put a slice of orange into your mouth. Your brain was able to recall all of the original memory just by remembering one of the sensory stimuli.

The importance of this finding for teachers and trainers is that it is more likely that students will be able to remember what they are learning if they are able to use as many senses as possible while the learning is taking place. This multisensory approach is utilized in preferred embodiments, as described below.

Timing is Important

It is recognized in preferred embodiments herein that timing is important. When a human being receives sensory input from the environment, he/she has one second or less for his/her brain to move that sensory memory into short-term memory. Once the input has reached his/her short-term memory, he/she has another fifteen to thirty seconds to convert the short term memory to a long-term memory. That is, the first thirty seconds of any new memory formation has greater importance than later on. If a learner's attention wanders during that time, the stimulus should preferably be repeated until it is actually moved into long term memory.

In addition, research has shown that breaking up material to be learned into small parts and mastering each part before moving on to the next is more effective for learners than long learning sessions, e.g., the typical classroom presentation. It is thus recognized herein based on these discoveries that the duration and timing of when various activities and stimuli occur makes a significant difference in the ability of the learner to remember what is taught.

Relevance is Important

It is recognized herein that that content may be learned more quickly and easily if it has relevance to the learner. Course objectives set by the instructor often do not accomplish this goal. To be effective, time should be spent in helping the learner recognize the personal relevance of what they are about to learn. While some teachers and trainers may understand this, perhaps sufficient attention is not often given to activities that foster the type of self-motivation that can be generated by a guided exercise focused on “what's in it” for the learner.

Rehearse It or Lose It

Research has demonstrated that if you don't actively review information encountered in a learning session within ten to fifteen minutes after the session, you will most likely lose at least 60% of what you learned within an hour. Within one month, that loss can grow to 80 or 90 percent. It is recognized in preferred embodiments herein, that using learning strategies that promote the right kind of rehearsal, it is possible to reverse the normal 90% loss and help the learner recall what they learned for many years.

Use Multiple Strategies

While the amount of time spent studying can be important, it is recognized herein that more important factors include the number and types of learning strategies employed during the process. It is therefore further recognized that multiple strategies and a variety of activities can be introduced into advantageous learning situations.

Form a Habit

Based on research by behavioral psychologists, it is understood that an advantageous way for a learner to consistently apply a newly learned skill is to form a habit. The research tells us that in order to accomplish this, the learner should apply the skill every day for a minimum of twenty days. While this is not a new idea to most educators, very little follow-through on this finding is actually implemented in the typical learning environment.

It is desired to have a revolutionary type of online instruction that combines what we know about how people learn with today's technology to deliver a learning environment that really works. It is recognized in the present invention that this can be achieved, because individuals will learn more efficiently when instruction is customized to match that individual's own learning preferences and/or meeting the special needs of an individual may be achieved by applying research findings and strategies that address how people actually learn.

It is desired to have a system that makes it easier for students to learn by providing instruction that is geared to individual's needs rather than a “one-size-fits-all” presentation.

It is desired to significantly improve the recall of most students.

It is desired to provide teachers an easy-to-use tool for incorporating new learning methodologies into their classrooms.

It is desired to improve standardized test scores.

It is desired to empower students with the “know-how” to help themselves.

It is desired to improve student grades in general.

It is desired to foster improved student self-confidence in the student's ability to successfully learn whatever they choose.

It is desired to generate greater understanding among educators of how we learn.

It is desired to provide a forum for how new research might be used to improve our educational system.

### SUMMARY OF THE INVENTION

In view of the above, a method of developing a customized electronic course of study is provided including identifying course content relating to one or more particular courses of study and electronically generating multiple learning modules based on the identified content. The learning modules are stored for selective electronic retrieval and delivery in generating the customized electronic course of study based on a selected learning preference profile. Preferably, the learning modules are stored according to multiple learning preference profiles for the selective electronic retrieval based on the selected learning preference profile.

A learning module may include at least two versions that are configured according to different learning preference profiles. One or more learning preference profiles may include a weighted emphasis on different learning preferences. The electronic generation of the multiple learning modules may include electronically generating multiple learning objects and assembling multiple learning objects to form at least one of the multiple learning modules. A learning module may also include a single learning object. One or more of the multiple learning objects may be configured according to a profile of one or more learning preferences. At least one learning preference profile of the one or more of the multiple learning objects may include a weighted emphasis on one or more learning preferences. Preferably, the learning objects each have a temporal extent of less than five minutes and more preferably less than two minutes. The learning modules preferably have a temporal extent not exceeding twenty minutes.

A learning module may be configured for presentation according to one or more sensory preferences and/or one or more organizational metacognitive preferences, and may include one or more associative metacognitive activity objects. One or more learning modules may be configured with a weighted emphasis on one or more learning preferences. In one embodiment, a learning module may be configured for presentation according to a sensory preference and an organizational metacognitive preference. In another embodiment, the learning module may further include an associative metacognitive activity object. In another embodiment, a learning module may be configured for presentation according to a sensory preference, and may include two associate metacognitive activity objects. The sensory preference may preferably be visual, auditory, verbal and/or kinesthetic. The organizational metacognitive preference may preferably be global or sequential. An associative metacognitive activity object may preferably be concrete or abstract, active or reflective, and/or analytical or intuitive.

The method may further include ordering the multiple learning modules. The storing of the learning modules for retrieval may include tagging the multiple learning modules for retrieval according to the multiple learning preference profiles.

A method of retrieving for delivery a customized electronic course of study is also provided including accessing an electronic storage device containing data corresponding to multiple learning modules based on content relating to a particular course of study. At least one of the learning modules may include at least two versions that are configured according to different learning preference profiles. The method further includes selecting a learning preference profile for the customized course of study, and selectively electronically retrieving one or more of the learning modules from the electronic storage device for delivery based upon a comparison of the selected learning preference profile with learning preference profiles of the multiple learning modules. The selective electronic retrieval may include electronically retrieving one of the two versions based upon a comparison of the selected learning preference profile with the different learning preference profiles of the two versions.

The different learning preference profiles may include weighted emphasis on different learning preferences. The electronic storage device may containing data corresponding to multiple learning objects, and the selective electronic retrieval may include selectively electronically retrieving one or more of the multiple learning objects, and assembling the selected learning objects into one or more learning modules.

The selected learning preference profile may include one or more sensory preferences such as visual, auditory, verbal and/or kinesthetic, and may further include global or sequential organizational metacognitive preferences. A selectively retrieved learning module may include one or more sensory activity objects such as a kinesthetic activity object and/or one or more associative metacognitive activity objects such as a concrete or abstract activity object, active or reflective activity object, and/or analytical or intuitive activity object.

A selectively retrieved learning module may include a weighted emphasis on a learning preference profile. For example, a learning module may include a weighted emphasis on a sensory preference and/or an organizational metacognitive preference. A learning module may further include one or more activity objects such as those mentioned above.

An electronic database is further provided for generating a customized electronic course of study. The database has data stored therein corresponding to multiple learning modules configured for retrieval according to multiple learning preference profiles. The multiple learning modules include content relating to one or more particular courses of study.

The multiple learning preference profiles may include one or more sensory preferences, and/or one or more organizational or associate metacognitive preferences. The multiple learning modules may be configured according to one or more sensory preferences, and/or one or more organizational or associate metacognitive preferences, and may include one or more sensory or metacognitive activity objects. A learning module may preferably include two or more versions that are configured according to different learning preference profiles. The learning modules may also be stored for retrieval according to multiple courses of study. The different learning preference profiles may include weighted emphasis on different learning preferences. One or more learning objects may be stored for retrieval according to forming at least a part of one or more corresponding learning modules. The multiple learning objects preferably each have a temporal extent not greater than five minutes, and more preferably not greater than two minutes. The learning modules preferably have a temporal extent not greater than twenty minutes. The data corresponding to the multiple learning modules may be tagged according to the multiple learning preference profiles.

One or more processor readable storage devices are also provided having processor readable code embodied thereon. The processor readable code programs one or more processors to perform any of the methods of developing a course of study for learning described above.

### BRIEF DESCRIPTION OF THE DRAWINGS

FIG. 1 is a flow chart illustrating a home page of a learning system web site in accordance with a preferred embodiment.

FIG. 2 is a flow chart illustrating a learning assessment page of a learning system web site in accordance with a preferred embodiment.

FIG. 3 is a flow chart illustrating a student home page of a learning system web site in accordance with a preferred embodiment.

FIG. 4 is a flow chart illustrating an instructor home page of a learning system web site in accordance with a preferred embodiment.

FIG. 5 is a flow chart illustrating an administer site page of a learning system web site in accordance with a preferred embodiment.

FIG. 6 is a flow chart illustrating a student course environment page of a learning system web site in accordance with a preferred embodiment.

FIG. 7 is a flow chart illustrating an instructor course environment page of a learning system web site in accordance with a preferred embodiment.

FIG. 8 is a flow chart illustrating a course components page of a learning system web site in accordance with a preferred embodiment.

FIG. 9 is a flow chart illustrating a manage courses page of a learning system web site in accordance with a preferred embodiment.

FIG. 10 is a flow chart illustrating a manage students page of a learning system web site in accordance with a preferred embodiment.

FIG. 11 is a flow chart illustrating a personal tools page of a learning system web site in accordance with a preferred embodiment.

FIG. 12 is a flow chart illustrating a toolkit activities page of a learning system web site in accordance with a preferred embodiment.

FIG. 13 is a flow chart illustrating an access reports page of a learning system web site in accordance with a preferred embodiment.

FIG. 14 is a flow chart illustrating a course setup page of a learning system web site in accordance with a preferred embodiment.

FIG. 15 is a flow chart illustrating a manage instructors page of a learning system web site in accordance with a preferred embodiment.

FIG. 16 is a flow chart illustrating a manage assistants page of a learning system web site in accordance with a preferred embodiment.

FIG. 17 is a flow chart illustrating an administer reports page of a learning system web site in accordance with a preferred embodiment.

FIG. 18 is a flow chart illustrating a configure system page of a learning system web site in accordance with a preferred embodiment.

FIG. 19 is a flow chart illustrating a course content page of a learning system web site in accordance with a preferred embodiment.

FIG. 20 is a flow chart illustrating a testing center page of a learning system web site in accordance with a preferred embodiment.

FIG. 21 is a flow chart illustrating a test builder page of a learning system web site in accordance with a preferred embodiment.

FIGS. 22-24 form a learning assessment flow chart in accordance with a preferred embodiment.

FIGS. 25-27 form a course development and delivery flowchart in accordance with a preferred embodiment.

FIGS. 28-32 form a recall room flow chart in accordance with a preferred embodiment.

### INCORPORATION BY REFERENCE

What follows is a cite list of references each of which is, in addition to that which is described as background, the invention summary, Appendix A and Appendix B, hereby incorporated by reference into the detailed description of the preferred embodiments below, as disclosing alternative embodiments of elements or features of the preferred embodiments not otherwise set forth in detail below. A single one or a combination of two or more of these references may be consulted to obtain a variation of the preferred embodiments described in the detailed description herein:

U.S. published patent applications Nos. 2002/0103818, 2001/0053252, 2002/0057290, 2002/0099770 and 2002/0091800;

PCT published application no. WO 00/67145 and WO 02/15004;

Gardner, Howard. (1993) Multiple Intelligences: The Theory in Practice, New York, N.Y.: Basic Books;

Dunn, R. and Dunn, K. (1987), “Understanding the learning styles and the need for individual diagnosis and prescription”, Columbia, Conn.: The Learner's Dimension;

Gregorc, A. F. (1979). Learning/Teaching Styles: Their nature and effects. Student learning styles: Diagnosing and prescribing programs. (19-26);

Gregorc, A. F. & Ward, H. B. February, 1977) A new definition for individual, NASSP Bulletin;

Web sites that may be accessed at the following URLs:

www.knowledgextensions.com;

www.infrature.com;

www.elementK.com;

www.gyrus.nu/Pedagogical_Resources/learning_Styles_Prompts.html; and

www.ncsu.edu/felder-public/RMF.html.

### DETAILED DESCRIPTION OF THE PREFERRED EMBODIMENTS

The preferred embodiments described in detail below achieve the following advantageous functions, among others:

Assesses the strength of twelve of the student's sensory and associative learning preferences through the use of three proprietary online survey instruments.

Guides the student through an exercise that helps the student identify the personal relevance of the material to be taught.

Matches the student's learning preferences to specific learning strategies stored in our proprietary learning strategies database.

Matches selected strategies to course-specific activities that utilize that particular strategy.

Chooses the general format in which to present the course based on the student's primary sensory preference plus the student's orientation to either a global or sequential organizational pattern.

Selects activities that utilize each of the student's other organizational preferences.

Using the selected strategies and activities, dynamically assembles and delivers a course that plays to the individual student's strengths.

Follows timed instructional modules with the use of specialized recall techniques.

Provides opportunities for immediate application of what was learned.

In addition, the system of the preferred embodiment includes many features and functions that make the system easy for teachers and trainers to implement. The findings of various research results are preferably combined to provide an optimum learning experience for each individual student. In order to do this, a different instructional experience is preferably delivered to individual students having different learning preference. That is, the instruction is tailored according to what works for that person. This approach is difficult to implement in a typical classroom setting where there may be many different types of individual preferences. In accordance with a preferred embodiment, electronic technology is advantageously utilized.

Overview of Learning Approaches

Some approaches that may be used along or preferably in combination in accordance with a preferred embodiment include the following:

First, because everything we learn is presented to our brain through one or more of our senses, the first thing that occurs for learning to occur is that a sensory impression actually reaches our short term memory. As each individual student receives sensory stimuli from different senses with efficiencies that depend on the preferences of the student, material is presented in accordance with a preferred embodiment depending on the sensory preferences of individual students.

It is further understood that the more senses that are active within the 30-second to 2-minute period when new information is presented, the more likely it is that the information can be recalled at a later date. Therefore, in accordance with a preferred embodiment, multiple senses may be used, e.g., visuals, sound, verbal, and/or some kinesthetic activity, and preferably combinations of two of more of these, to present the material.

Second, if by whatever means it occurs, the sensory stimuli mentioned above actually make it to short term memory, then the student still will not be able to remember it at a later date unless the sensory data is transferred to long term memory and is organized for storage in a way that permits that individual to recall it. Since research has identified a number of common methods of organizing and associating new information, and has determined that individuals differ in their organizing and associative preferences, i.e., organizational and associative metacognitive preferences, the presentation of sensory “learning units” are preferably generated or created according to an organizing method such as global or sequential, depending on which method is preferred by the student and/or who is using the instructional material. This makes it easier for the student to understand and process the new information.

Third, since each student also has multiple associative preferences as well, e.g., concrete vs. abstract, active vs. reflective, and analytical vs. intuitive, and since it is preferred to emphasize a greater number and type of ways in which a student uses new information over the time spent studying when trying to predict how much a student can recall at a later date, it is preferred to dynamically insert one or more activities based on one or more of the above or other associative preferences during and/or following a learning unit. The number of activities utilized preferably depends on the overall size of the learning unit, i.e., the larger the unit, the more activities may be preferably utilized.

Fourth, learning units, which may include learning objects, learning modules comprising learning objects or stand-alone learning modules preferably use specific timing to present new information so that the chances of the material being effectively stored in memory are improved. Since a sensory stimulus should be stored in short term memory within approximately 30 seconds of it's being noticed, it is preferred that sensory stimuli are provided more than once and more preferably at least three times in order to give the student improved chances to possibly notice the picture, sound, or kinesthetic impression, for example. All of these opportunities preferably occur within the first two minutes of presenting new information, and alternatively up to five minutes. This is because certain stimuli can generally remain in working memory for up to two to five minutes before being transferred to long term memory. These learning units having a temporal extent of preferably less than two minutes and alternatively less than five minutes are termed learning objects herein.

In addition, the length of each learning unit or learning module is preferably built to be completely delivered to the student within 20 minutes or less. This is based on an understanding that state changes approximately every 15-20 minutes increase the amount of new information absorbed and available for recall. All of the instructional approaches briefly discussed above and in more detail below are preferably further advantageously delivered electronically using technology such as computer databases and/or other data and/or program storage devices, computer networks and computer systems themselves.

The ability of a system in accordance with a preferred embodiment to dynamically deliver courses customized to an individual learner's strengths provides that an initial stimulus can be stored in the student's brain in the area that is most developed in that individual. In addition, it improves the chances that the stimulus will be successfully associated for future recall because the stimulus is preferably delivered in a favored metacognitive style.

The ability of a system in accordance with a preferred embodiment to customize instruction for multiple learning preferences provides the learner the ability to associate the same stimulus in multiple ways and build multiple neural paths through which the information can later be retrieved. The sensory learning preferences being measured in the preferred learning assessment system are visual, verbal, auditory and kinesthetic. The preferred metacognitive associative preferences are global, sequential, concrete, abstract, active, reflective, analytical, and intuitive.

The ability of a system in accordance with a preferred embodiment to deliver instruction in a way that involves multiple senses while the stimulus is being delivered provides the learner with another way to build multiple neural pathways to the memory. Stimuli received from different senses are stored in different areas of the brain. There is a storage area dedicated to visual stimuli, another to auditory stimuli, and so forth. If one wants to recall an original memory at a later date, one can remember just one of those stimuli. The memory will then be automatically retrieved from all areas of the brain in which the initial memory was stored, and will be reassembled in its entirety in the hippocampus. The more senses involved while learning something, e.g., in accordance with a preferred embodiment, the better your chances of being able to recall it at a later date.

The ability of a system in accordance with a preferred embodiment to deliver instruction that is timed to take advantage of what we know about how the mechanics of memory work gives the learner more opportunities to register the stimulus and form associations for later recall. It is understood that there one only has about 15 to 30 seconds to notice a stimulus and convert it from short term to long term memory. By repeating the same stimulus in different ways over a short period of time, the learner is more likely to take notice of the stimulus and begin to process the memory. Furthermore, by breaking up information to be learned into small units, the learner has the opportunity to form appropriate associations before attempting to process the next topic.

The ability of a system in accordance with a preferred embodiment to present the learner with effective memory, motivational, and concentration techniques also improves the likelihood of successful long term recall. Use of these effective techniques improves the odds of a learner being able to remember what was presented. Examples include an exercise to help an individual identify how a topic is personally relevant to him/her, a technique for boosting long term recall from about 30% up to as much as 90%, a motivational aid to help a learner develop new habits, and a variety of learning strategies from which to choose.

Learning Modules

Below, a learning system and methods in accordance with a preferred embodiment are described in detail. The system is divided generally into a learning assessment area, a course development and delivery system, and a recall room. Other elements of the system that are particularly advantageously when provided in on-line learning systems in accordance with preferred embodiments include that which is described as learning goals, habit workshop, a mneumonic feature of the recall room, and a supplemental activity builder or toolkit.

Learning modules may also be referred to as learning units. A learning module can be as little as one “screen” or soundbite, or as much as an entire 20-minute series of “screens”, soundbites and/or other sensory stimuli, in which some instructional content is presented to the student. A course of study preferably comprises many or several learning modules, although the “short course” may include only a single module or two or three or a few modules. In a particularly preferred embodiment, a course of study comprises multiple learning modules that are generally twenty minute or less learning units that would be dynamically generated and presented to the student in an determined order as an entire “course of study”. In that context, a 20-minute or less module may be similar to a chapter in a book, or the lectures for one week of a 14 week class. A learning module can also be merely a stand alone concept delivered to a student on one or more screens, soundbites, etc., e.g., such as a page, or even just a paragraph on a page, that could later be used as part of a number of different instructional presentations.

Learning modules may comprise one learning object or preferably more than one learning object. A learning object will preferably embrace a single concept or idea within the learning module. However, a learning module may comprise a single learning object, and a learning object may comprise a single sensory stimulus, although preferred learning objects use multiple sensory stimuli. Learning objects preferably comprise content, and may also include one or more interactivity features wherein a student performs some action during the course of the presentation of the object.

A learning preference profile may be associated with a student preferably according to the learning assessment feature of the overall system described below. A learning preference profile may also be associated with a learning module or series of learning modules or with a learning object or series of learning objects or with one or more courses of study. A learning preference profile of a learning object or module may provide presentation of content according to a single sensory or metacognitive preference. Generally, a preferred learning preference profile will weight the presentation of content according to a particular weighting of a sensory preference or preferences of a student and/or according to some other selected learning preference profile input by a user of the system. A learning preference profile may also provide for presentation according to a single metacognitive preference, although again, the learning preference profile may preferably weight the presentation according to a particular weighting of one or more metacognitive preferences of a student and/or according to some other selected metacognitive preference profile input by a user of the system. A learning preference profile may include only a sensory preference or weighting of preferences, and/or only a metacognitive preference or weighting of preferences including either or both of an associative metacognitive preference or weighting of preferences, and an organizational metacognitive preference or weighting of preferences. A learning profile may also include a combination of sensory and metacognitive preferences or weightings of preferences including either or both of associative and organizational metacognitive preferences.

Learning modules and/or learning objects and/or courses of study are preferably stored in a database for retrieval according one or more learning preference profiles. This can mean that they are tagged or otherwise indexed, use stream tables, etc., according to any of the many ways that information is stored for retrieval into databases as understood by those skilled in the art. A selected, measured, or otherwise input learning preference profile may be matched or compared or used in some way to pull up the modules, objects, courses of study, etc., that are stored, e.g., indexed, tagged, using one or more tables, etc., according to their own learning preference profiles.

Learning System Overview

The preferred embodiment includes an engine built to surround and support an online development and delivery of courses designed to cater to sensory and/or metacognitive preferences of individual students or as may be selected by a user. These courses can be dynamically generated at will, and may be delivered by selecting, assembling, and displaying appropriate high-level learning objects from a preferred database.

A learning assessment system in accordance with a preferred embodiment measures both how a person prefers to receive stimuli from the outside world through their senses and how their brain prefers to organize that information once it is received. The system measures the strength of a number of user-learning-preferences, e.g., visual, verbal, auditory, and/or kinesthetic sensory preferences, as well as global, sequential, concrete, abstract, active, reflective, analytical, and/or intuitive metacognitive preferences. In a big picture sense, a preferred overall system uses the data collected through this assessment to deliver substantially customized courses to individual students.

What is meant in the preferred embodiment to “customize” courses of study goes beyond what may be typically meant to “individualize” content. Individualizing content can be as little as giving students a pre-test and then delivering a list of instructional units that teaches the material the student doesn't yet know. However, the way the content is delivered may be exactly the same for all students and not dependent on any learning preferences of any student of group of students. That is, the presentation of the individualized content may be “one-size-fits-all”. When a learning object, a learning module and/or an entire course of study is customized for a student in accordance with a preferred embodiment, it is customized to one or more sensory and/or metacognitive learning preferences of the student.

Courses delivered through the learning system of the preferred embodiment are organized and presented in a manner that is based on the findings of neurological and cognitive research. In addition, material is preferably delivered in a multisensory way. Also, instruction is preferably timed to take advantage of what is known about the mechanics of how memory works. Information is organized into delivery units that are designed to promote optimum recall. Students are provided with a number of research-based recall tools. Effective motivational and concentration techniques may be utilized. A wide variety of learning strategies may be incorporated into a course so that a learner can experience the new information in multiple ways. An extensive course environment that features many instructional support tools for student use may be provided.

Learning Assessment

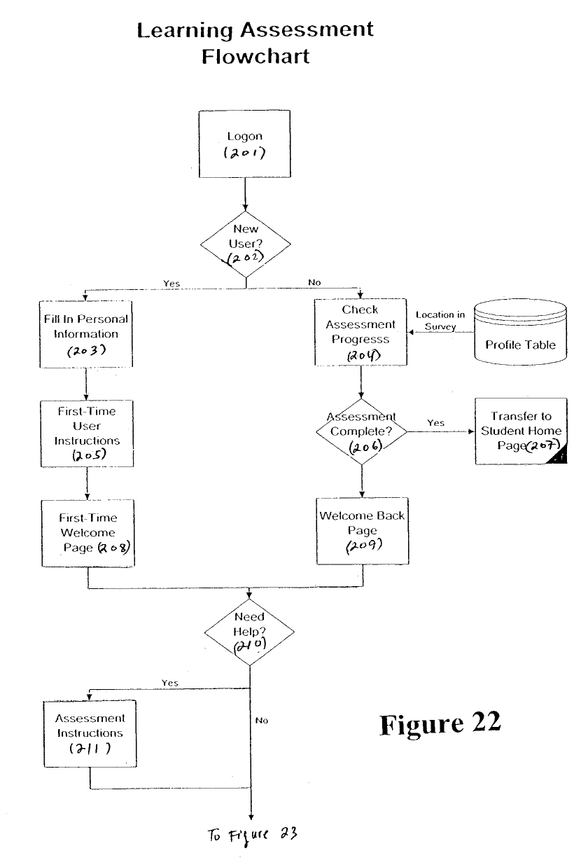

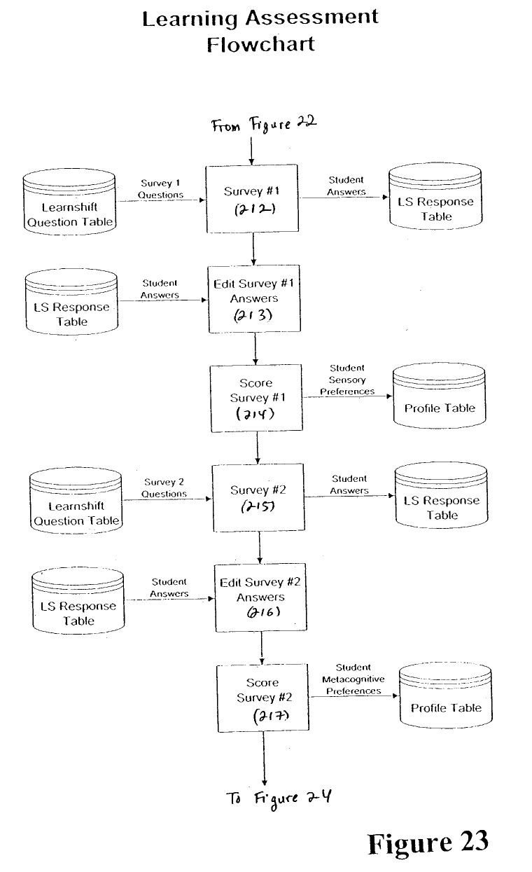

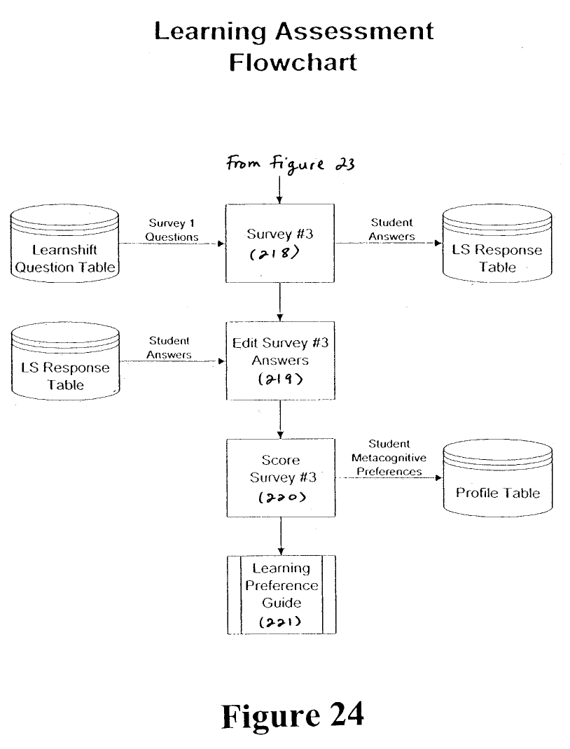

The learning Assessment instrument (see description below with reference to FIGS. 22-24) measures student learning preferences. It preferably includes a number of questions designed to assess specific sensory and/or metacognitive preferences. In the currently preferred assessment, 120 questions are divided into three separate surveys of 40 questions each. Each question is framed as a statement. Students are asked to respond to the statement by dragging a slider across a 10-point Lickert scale that indicates the student's degree of agreement with the statement. Dragging the slider towards the lower end of the scale (“1”) indicates strong disagreement with the statement. Dragging the slider towards the higher end of the scale (“10”) indicates strong agreement with the statement. The learning assessment system of the preferred embodiment advantageously measures both sensory and metacognitive preferences. In addition, preferably multiple sensory and/or metacognitive preferences are measured. The preferred learning assessment system measures metacognitive preferences which include the global, sequential, concrete, abstract, and active preferences that are present in the Kolb model, and some that are present in the Felder-Silverman model, as well as some that are not covered in either of these models.

Course Development and Delivery

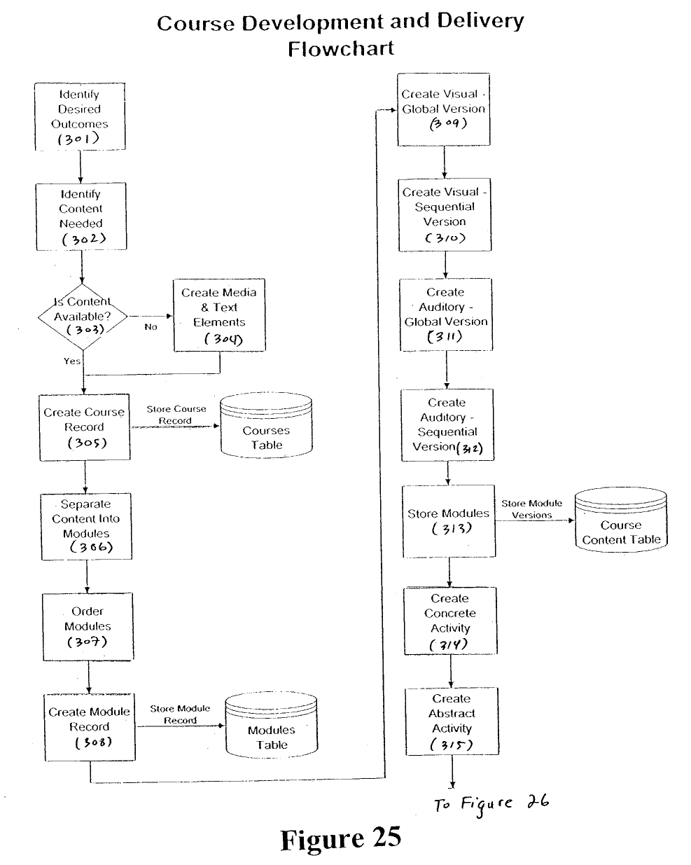

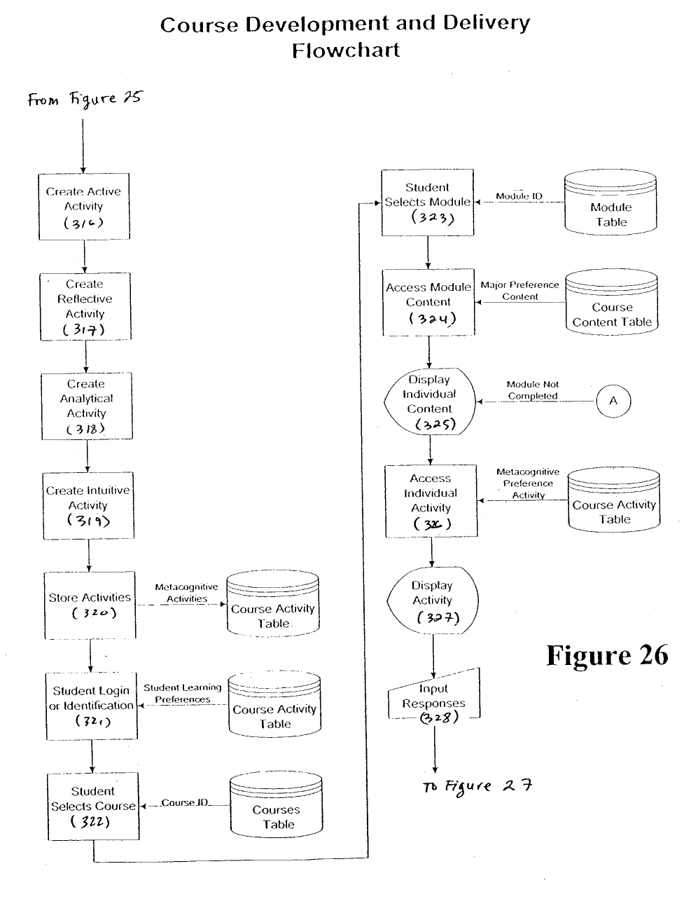

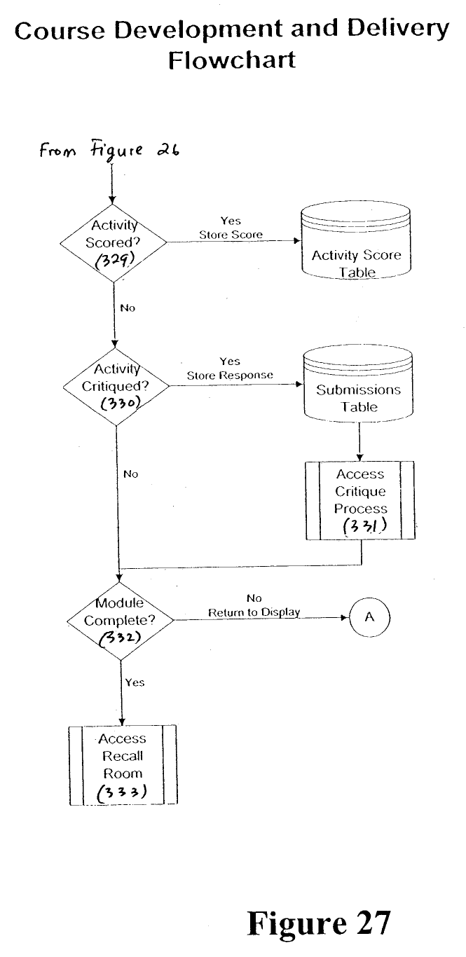

A course development and delivery process in accordance with a preferred embodiment is described with reference to FIGS. 25-27 below. The process may be largely manual or it may be automated so that users can create their own courses from a provided database. The process can be though of in three features of the preferred embodiments. First, there is the creation of learning modules, learning objects and/or entire course(s) of study based on learning preferences. These modules, objects and/or course(s) of study are stored for retrieval according to the learning preferences, e.g., in a database. Second, there is the database itself. A user may have access to the database and can pull up learning modules, objects and/or course(s) of study based on learning preferences. That is, the data is stored in the database and thus retrievable from the database according to learning preferences. Then, a learning module, learning object and/or course(s) of study may be retrieved and delivered to one or more output devices according to learning preferences that may be selected by the user of that may be measured in and uploaded from a learning assessment module.

Preferably, courses of study are made up of instructional modules. Instructional modules are made up of individual learning objects. These learning objects are stored as separate entities in a database. Each learning object is preferably classified as either a content object or an interactive object. Modules may be dynamically assembled by selecting an appropriate content object, or by selecting an appropriate interactive object, or preferably both, and multiple content objects and/or interactive objects may be assembled to form a module. For example, a content object may be selected, followed by an appropriate interactive object, followed by another appropriate content object, followed by another appropriate interactive object, etc. until each element of the module has been displayed. Interactive objects are acted upon by the student before the module moves to the next object. “Appropriateness” is determined by referencing the sensory and metacognitive preferences of the student for whom the course is being assembled.

A module may be delivered according to one sensory mode or may be delivered in a multisensory mode. A module may include visual, auditory, and/or kinesthetic stimuli. Presentation to students with different sensory preferences may be preferably provided differently in the degree to which higher favored stimuli is utilized. For example, a student may favor auditory stimuli, and the module may be presented with a majority of auditory stimuli. For example, 75% auditory stimuli and 25% visual stimuli may be used.

The order in which content and interactive objects are displayed may be different for different learners. The appropriate order is preferably determined by identifying whether the student prefers to form long-term associations by globally or sequentially organizing information.

Preferably, two or more and perhaps several versions of content objects may be created for each module within a course according to one or more and perhaps several preferences. For example, content objects may be assembled for presentation to those who prefer visual sensory input coupled with a global organizing preference, those who prefer visual sensory input coupled with a sequential organizing preference, those who prefer auditory sensory input coupled with a global organizing preference, and those who prefer an auditory sensory input coupled with a sequential organizing preference. While all of these examples of assembled versions may have the same educational goals and may teach the same concepts or skills, they will be delivered with a different mix of visual and auditory stimuli, and in a different order for those who prefer to organize globally vs. sequentially. There may also be differences in the learning strategies used to present the concepts and/or skill sets.

Kinesthetic sensory preferences and concrete, abstract, active, reflective, analytical and intuitive metacognitive preferences may also be addressed by creating interactive learning objects. Assembled modules may contain one or multiple interactive learning objects of different metacognitive types.

In a preferred embodiment, when a student completes a content object within a module, an interactive learning object appropriate for one of the student's metacognitive preferences may be inserted into the module. For each content object, two interactive objects may be built, e.g., one for each member of a metacognitive pair. For example, one concrete and one abstract interactive learning object may be created, or one active and one reflective interactive learning object may be created, or one analytical and one intuitive learning object may be created. Interactive objects involve some degree of kinesthetic involvement on the part of the student. For example, Module 1 may be generated by assembling Content Object A (of the appropriate type), followed by a concrete or an abstract interactive learning object (depending on the strength of the preference for the individual user), followed by Content Object B, followed by an active or reflective learning object, followed by Content Object C, followed by an analytical or intuitive learning object, followed by Content Object D, etc. until the module has been completed.

The use of different types of content learning objects in the preferred embodiment and a variety of interactive learning objects allows us to dynamically create a large number of permutations of the module that is finally displayed to a student. The preferences of students with a particular number combination of different learning preferences can be met without having to build scores of static versions. In a particularly preferred embodiment, twelve preferences are used.

It is advantageous to utilize proper timing in the process of building and assembling courses. As mentioned, courses may be divided into modules whose total content can be presented within twenty minutes or less. This time limit would generally not include the time it may take a student to perform any included interactive exercises. Individual content learning objects are built to be completed within two to five minutes.

A builder of a course of study, learning module or learning object may create objects or modules by “filling in the blanks” of a template using content that meets the requirements for a specific sensory and/or metacognitive type. These templates may be built according to widely accepted and scientifically sound instructional design principles. Custom interactive and content objects can be created in a time-effective way by using automated “wizards”.

### Recall Room

The purpose of the Recall Room is to make sure important concepts, techniques, processes, or skills are transferred to long-term memory and can easily be remembered for long periods of time. The methodology used is based on research that indicates that a person can recall whatever they want for a very long time (possibly even a lifetime) by using a specifically timed review process.

The process preferably involves several brief practice sessions in which the student reviews and practices the material they wish to permanently anchor in their memory. The first review session occurs soon after first exposure to the information (in this embodiment, within 15 minutes). The second session should occur one day after first exposure, the third review should occur one week after first exposure, and the final session should occur one month after first exposure.

While research indicates the process is most effective if the learner rehearses the information for the first time within the first fifteen minutes after exposure, some improvement in recall results could also occur if the elapsed time is greater than 15 minutes. However, in general, the longer the time between exposure to the material to be remembered and the first practice session, the less effective this technique becomes. The degree of degradation of results beyond this time frame would probably depend a great deal on individual motivation and concentration patterns.

Increasing the number and/or spacing of practice sessions might also produce some improvement in recall as compared to the absence of any recall sessions at all. However, using just four sessions that occur as described above seems to be the most effective and least time-consuming process to achieve the desired results.

Learning System Detail

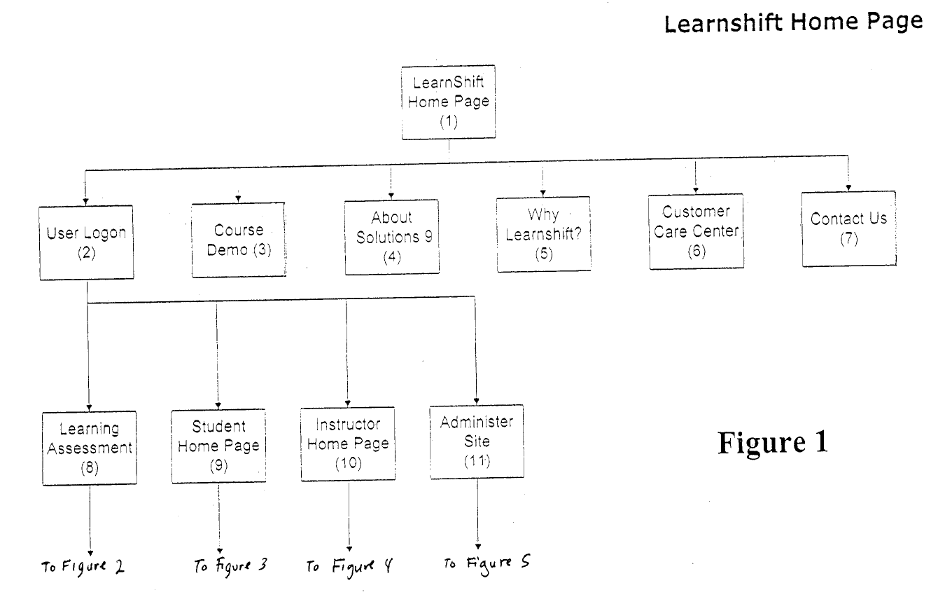

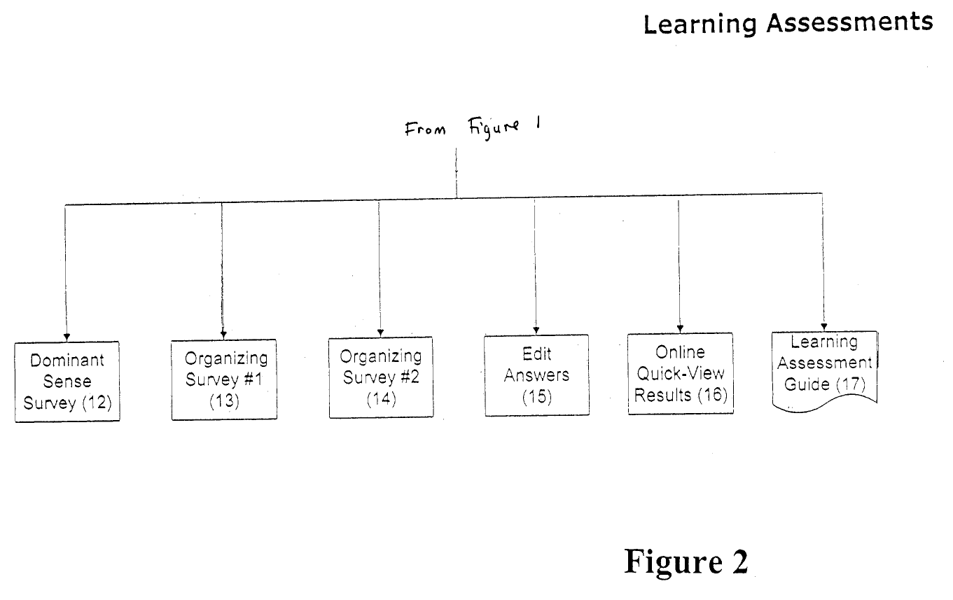

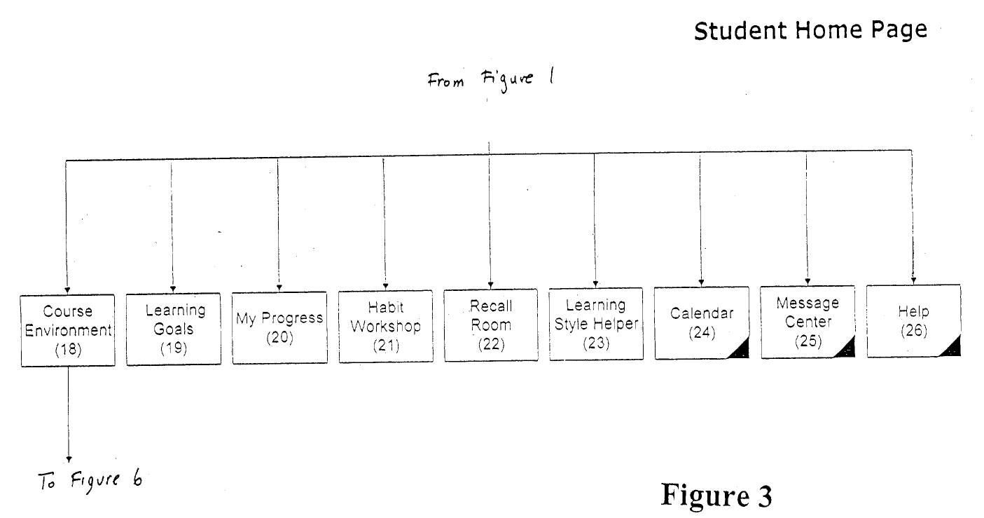

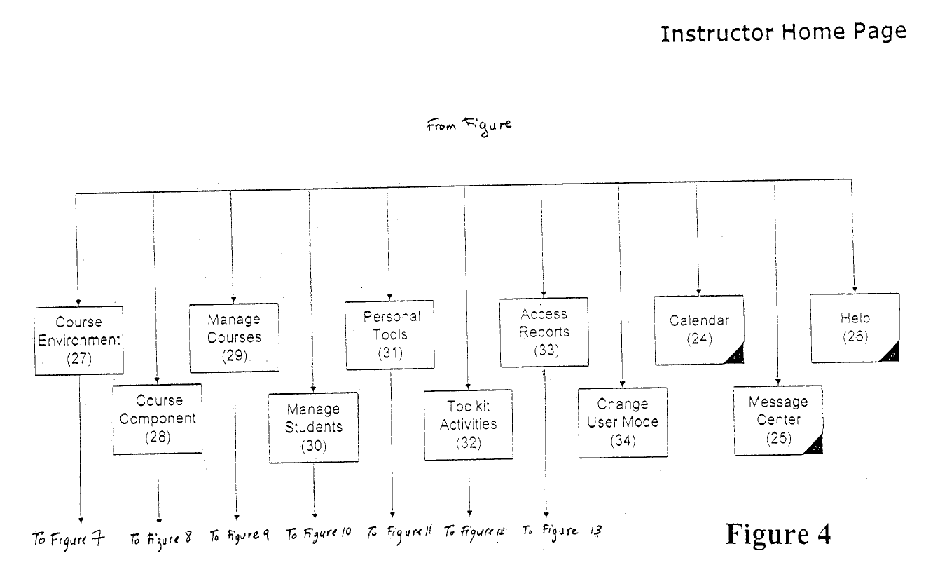

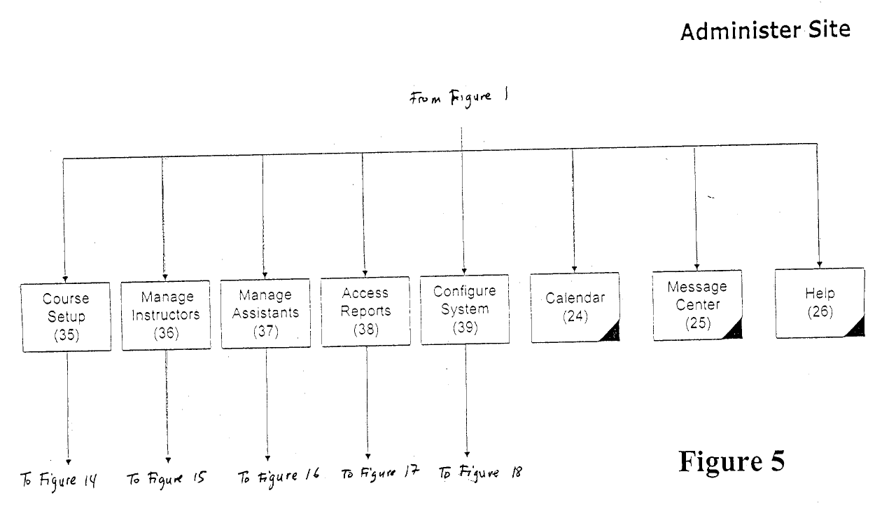

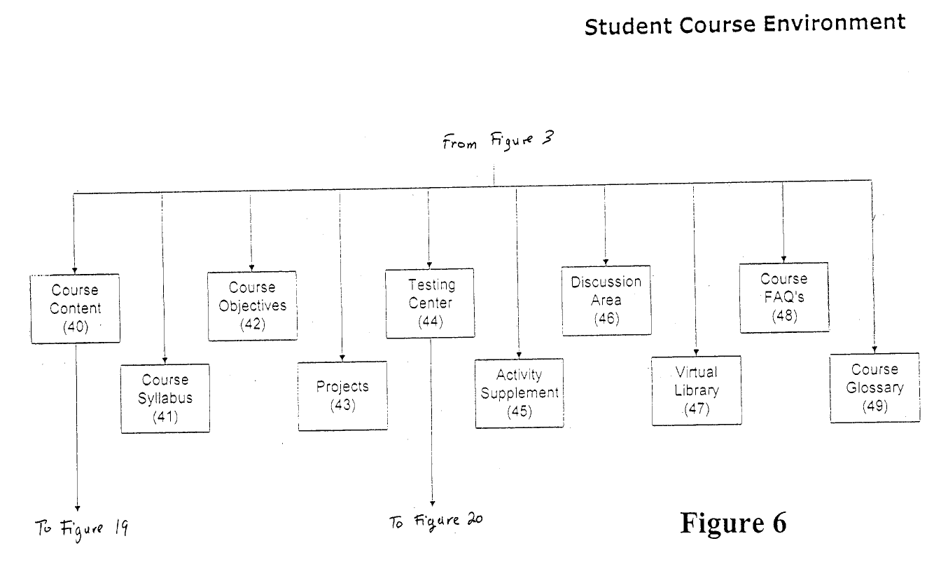

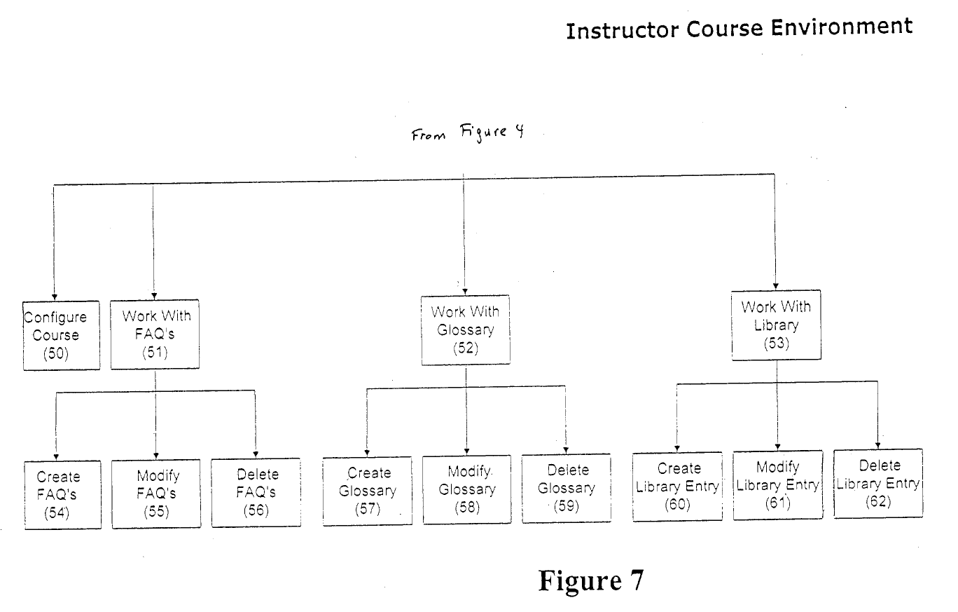

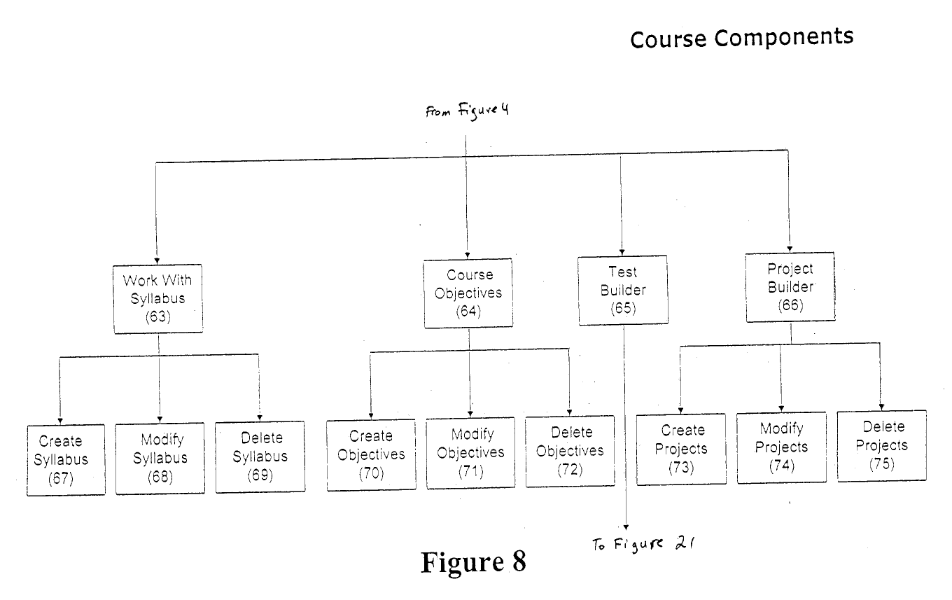

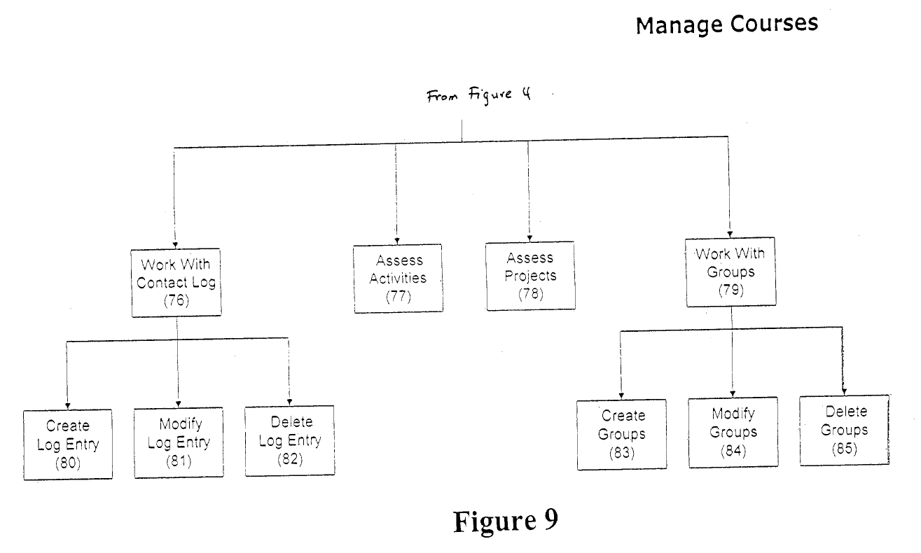

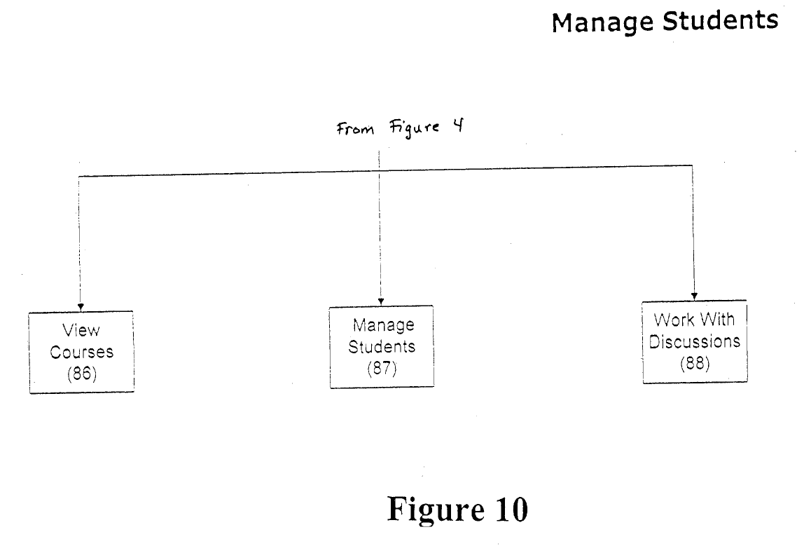

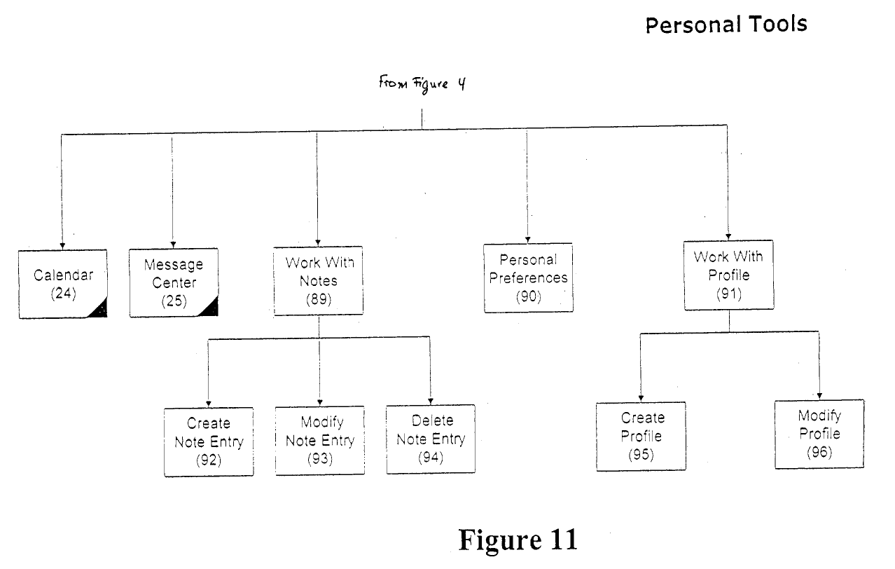

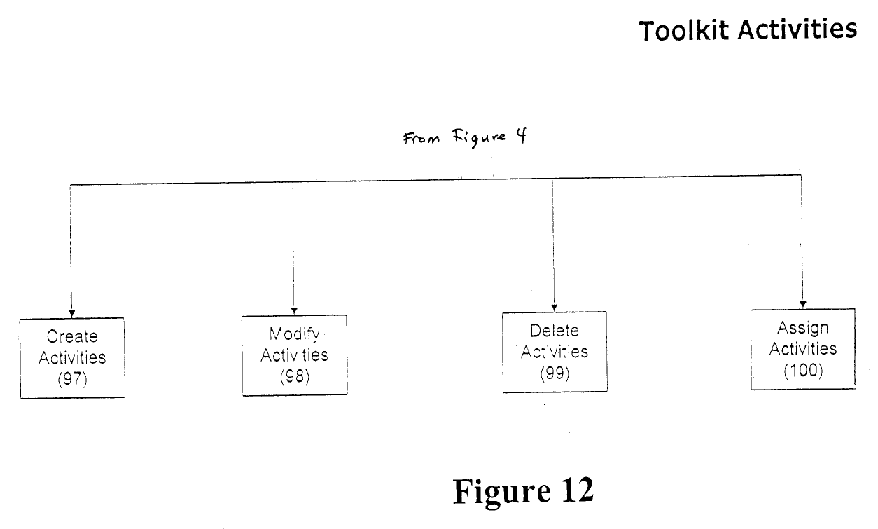

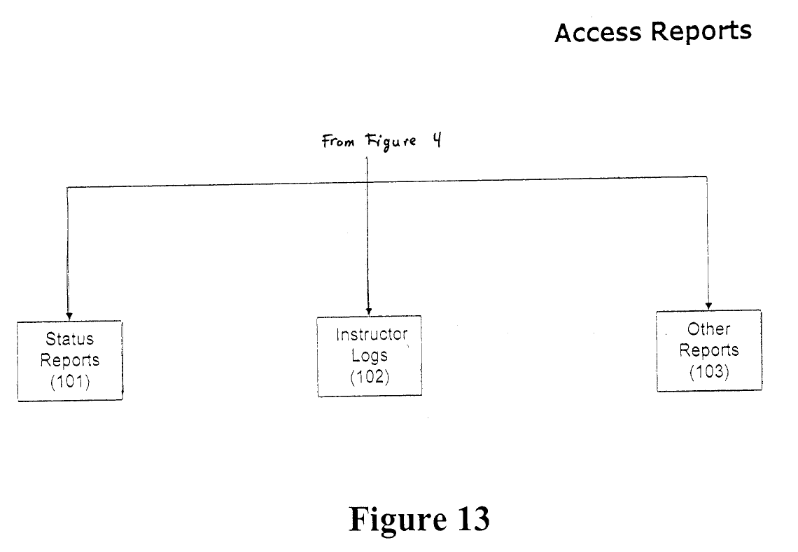

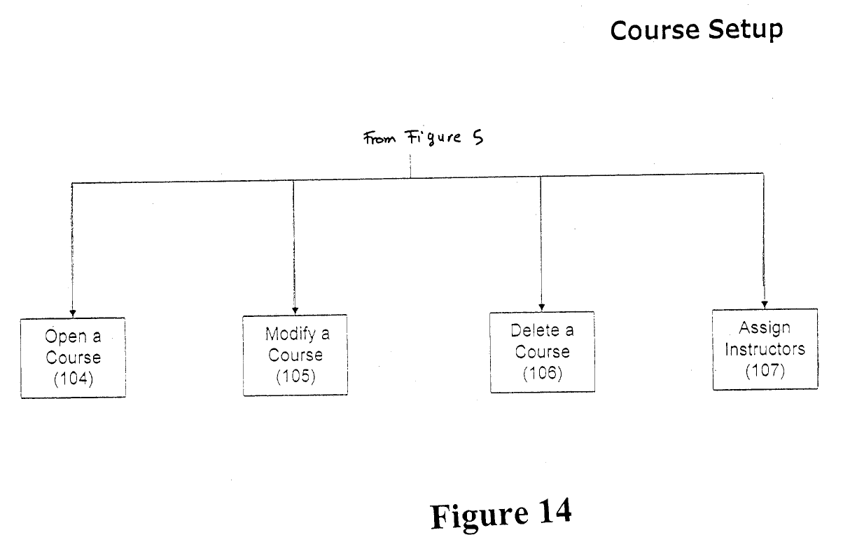

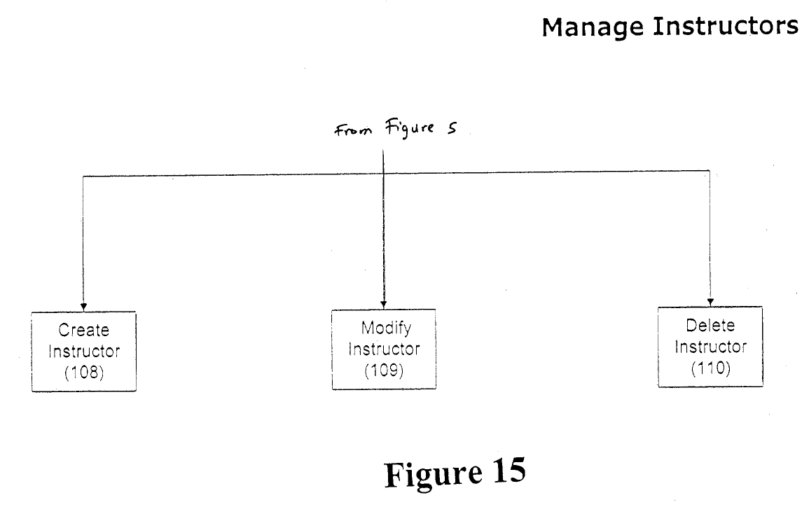

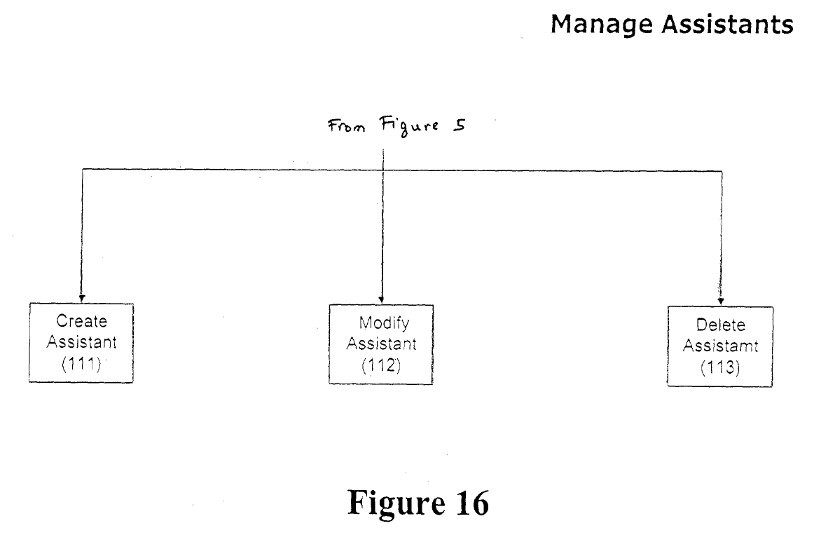

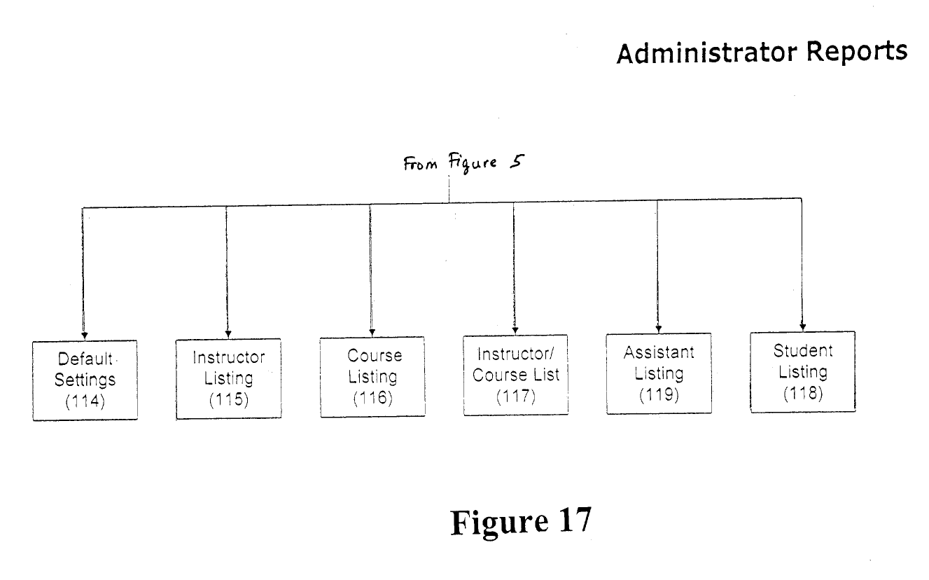

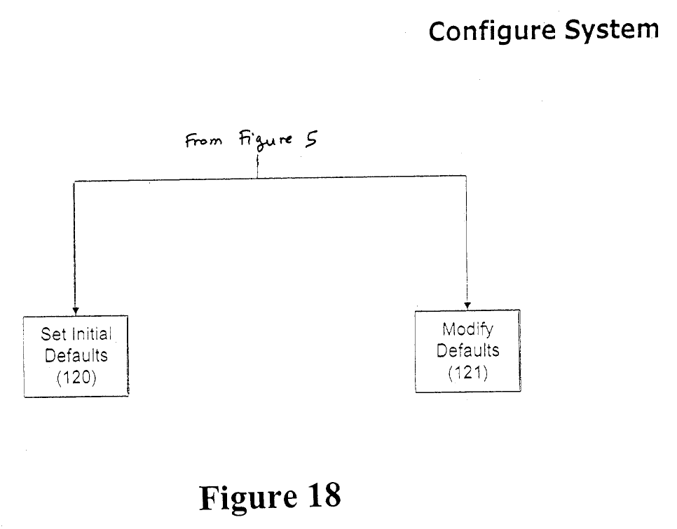

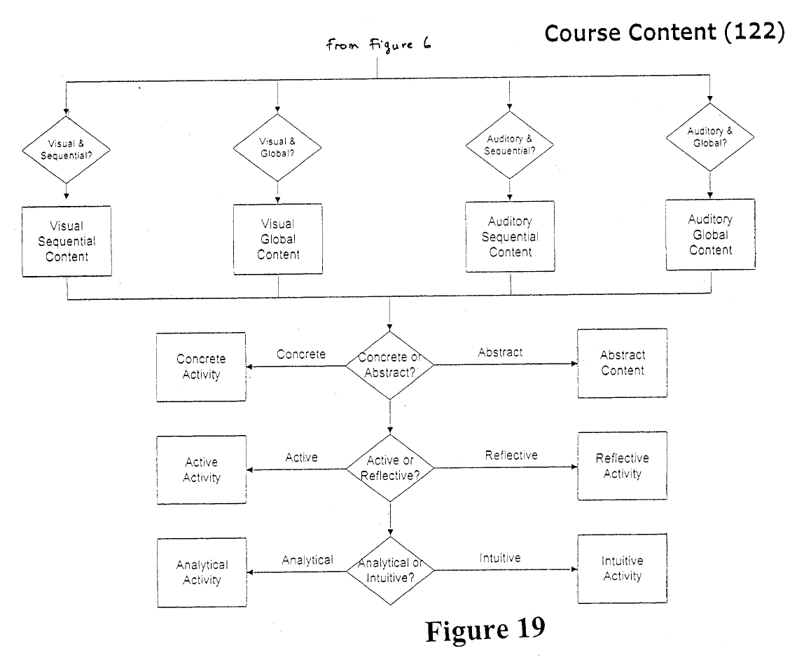

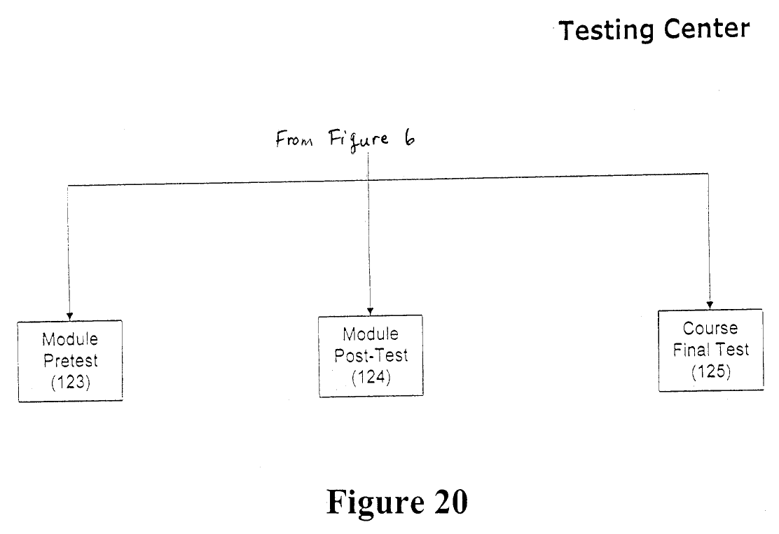

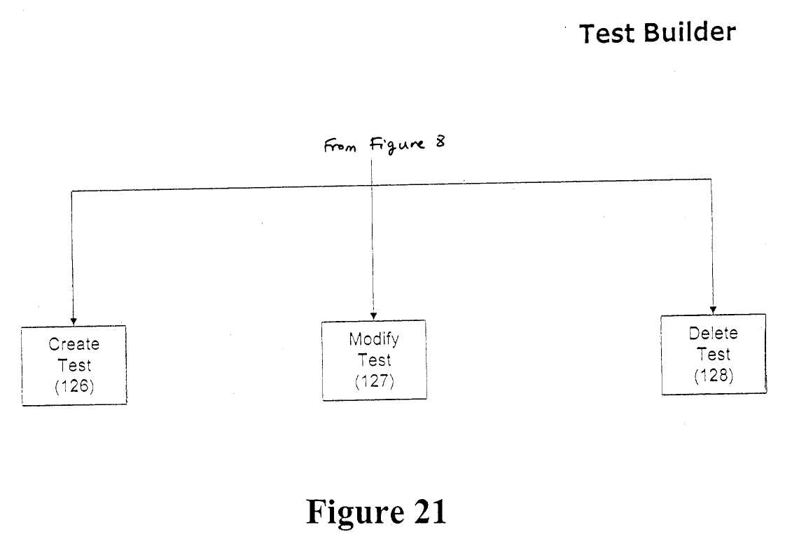

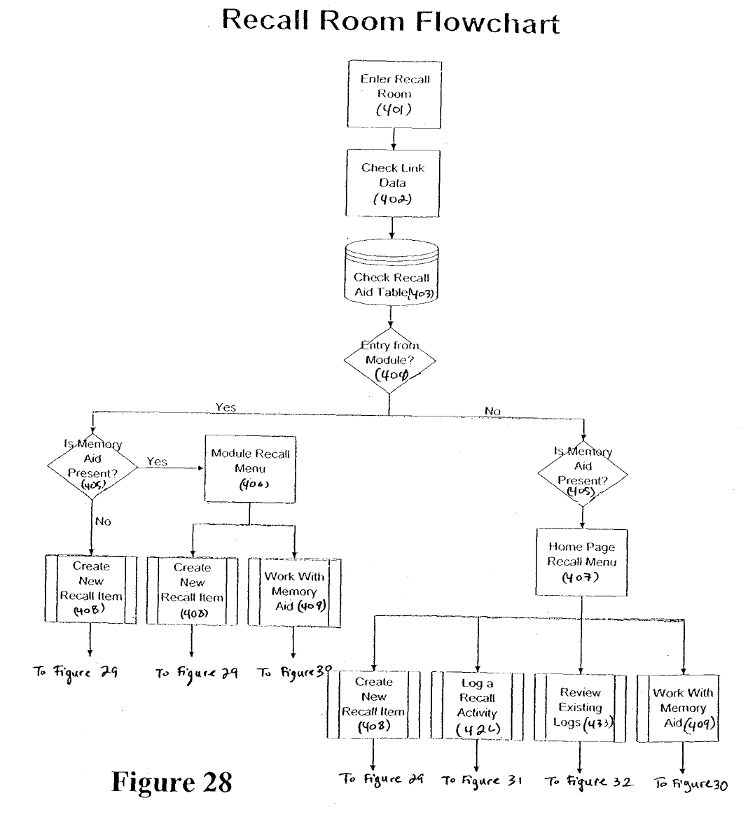

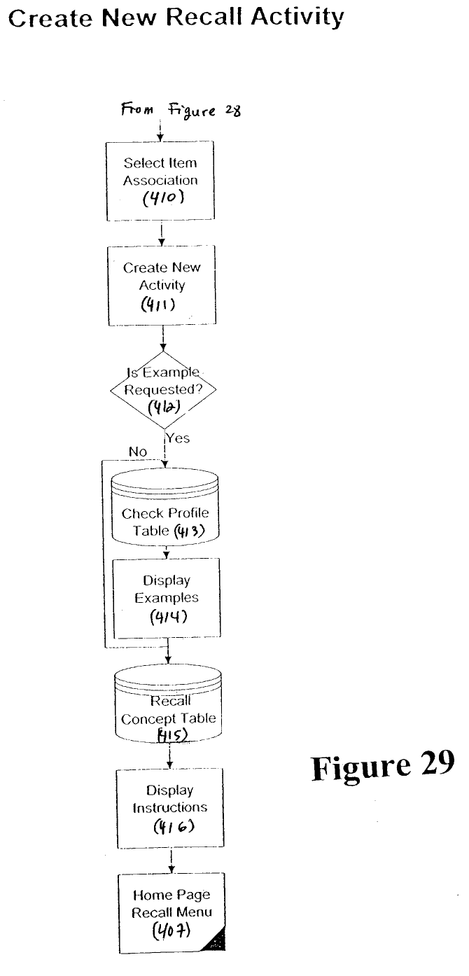

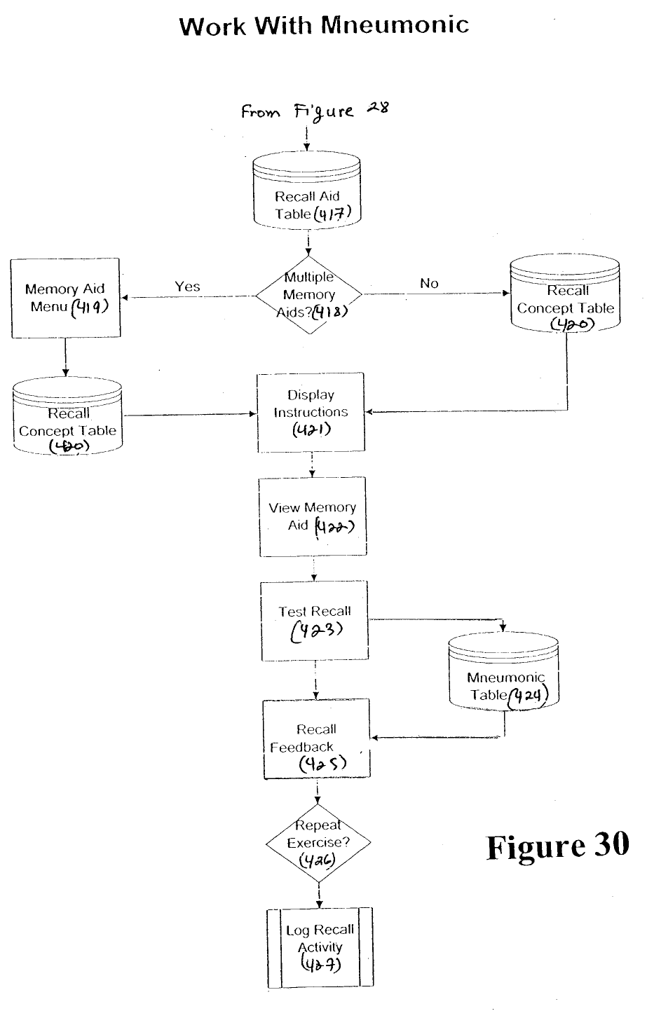

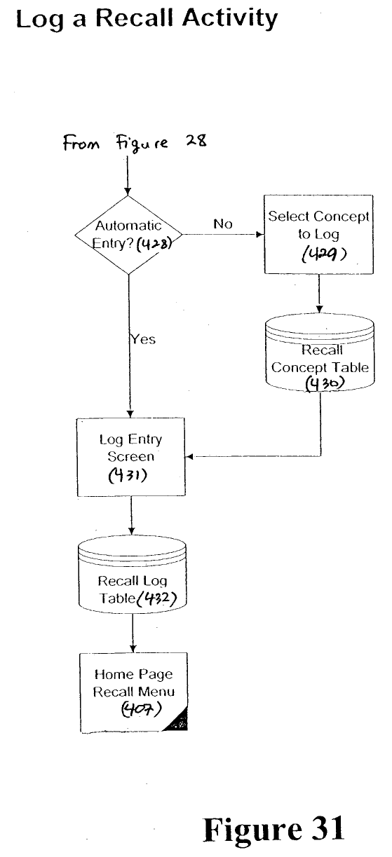

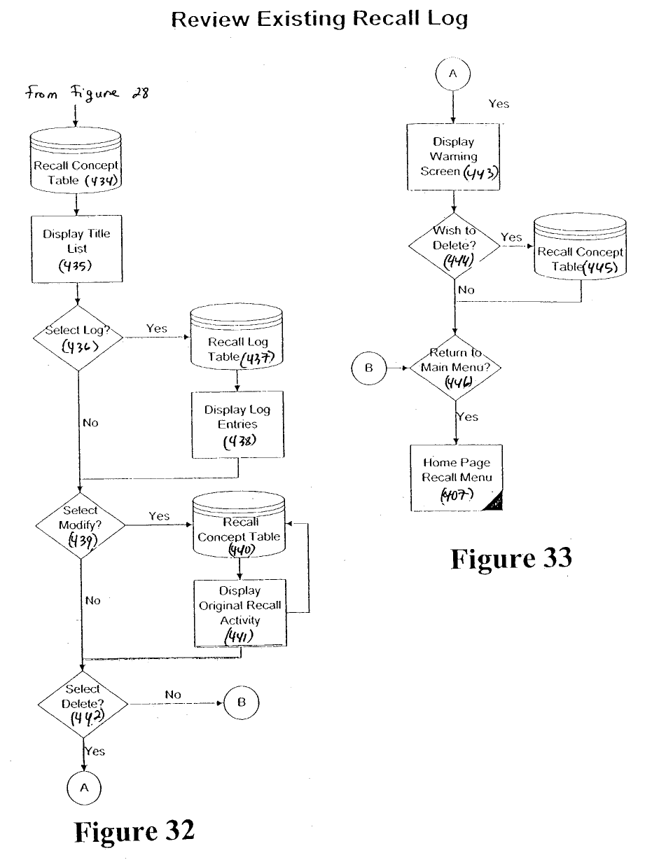

Below, instructions are included for referencing the flow charts and block diagrams of FIGS. 1-32. For an explanation on the meaning of each symbol used within the flowcharts of FIGS. 1-32, please refer to Appendix A, which is hereby incorporated by reference. Each of the numbered paragraphs below represent an explanation of the purpose and content of each module represented by the same number in FIGS. 1-32. FIGS. 1-21 are a flowchart illustrating an several pages of a learning system web site in accordance with a preferred embodiment. The numbers in parentheses within the FIGS. 1-21 correspond to the number below corresponding to a description of what preferably takes place within that process. FIGS. 22-24 relate to a preferred learning assessment process, FIGS. 25-27 relate to a preferred course development and delivery process and FIGS. 28-32 relate to a preferred recall room process.

Learning System Web Site

2—User Logon

This screen is the entry point into the learning system web site. First time users enter a unique key that directs them to the learning Preference Assessment module (#8). All other users are asked to enter a unique user ID and password and are directed to their home page.

8—Learning Assessment

This screen explains the purpose of the learning Assessment, and gives the user directions on how to take the learning surveys. Once these instructions have been read, the first survey is displayed. The assessment instruments are described in #I 2-17 below.

9—Student Home Page

If the user who logged on to the system in #2 above was a student, they will be transferred to this screen. In addition to graphic representations of the student's personal calendar, their mailbox, a cartoon-character learning Style Helper and a reminder area, this page contains links to the areas described in #18-26.

10—Instructor Home Page

If the user who logged on to the system in #2 above was an instructor, they will be transferred to this screen. In addition to graphic representations of the instructor's personal calendar, their mailbox, a reminder area, a contact log area, and a critique area, this page contains links to the areas described in #27-34.

11—Administrator Home Page

If the user who logged on to the system in #3 above is the company or school administrator of the Preferred learning System, they will be transferred to this screen. In addition to graphic representations of the administrator's personal calendar, their mailbox, and a reminder area, this page contains links to the areas described in #35-39.

12—Dominant Sense Survey

This module consists of a series of questions designed to identify a learner's dominant sensory preferences. The survey measures visual, auditory, verbal, and kinesthetic preferences. Once the student completes the survey, the results are stored in a database table for future reference.

13—Organizing Survery #1

This module consists of a series of questions designed to measure the strength of four of a person's metacognitive preferences. This survey measures concrete, analytical, abstract and intuitive preferences. Once the student completes the survey, the results are stored in a database table for future reference.

14—Organizing Survery #2

This module consists of a series of questions designed to measure the strength of another set of metacognitive preferences. This survey measures active, reflective, global and sequential preferences. Once the student completes the survey, the results are stored in a database table for future reference.

15—Edit Answers

At the end of each survey, the user is given the opportunity to change any answer to any question. Once they are satisfied with their responses, they click “Submit” and the answers they have chosen become final.

16—Online Quick-View Results

After all three surveys have been completed; a brief description of the user's learning preferences is displayed. Users may also link to an in-depth individualized analysis as represented in #17 below.

17—Learning Preference Guide

The learning Preference Guide is provided to each student online, but is also available in print format. It consists of several pages and/or screens of detailed information about a student's individual learning preferences, information about how people learn, suggestions on how to utilize individual preferences, and tips on how to improve recall.

18—Student Course Environment

This is a link (entitled student clicks on this “Course”) that appears on the Student Home Page. If a button, they will be transferred to a screen where they may select the course in which they wish to work. They are then transferred to the course environment as described in ##40-49.

19—Learning Goals

This is a link that appears on the Student Home Page. If clicked, the student will be transferred to a module where he/she is led through a process of identifying why he/she wants to learn a specific concept, skill, or process. The importance of identifying personalized goals is explained. Students are then asked to specify exactly what it is they want to learn, and what's in it for them if they do so. They can create goals related to specific courses and modules, but are also able to create goals that are non-course related. Goals are stored in a database table and can be periodically reviewed by the student.

20—My Progress

This is a link on the Student Home Page that displays a report showing the student's current progress through a course. A screen is displayed that graphically shows what modules within a course have been completed, what the student last worked on, and any grades that the student has earned to date.

21—Habit Workshop

This is a link on the Student Home Page that leads to a module where the student works on forming a habit. Once a student clicks this button, they are transferred to a screen that explains the importance of habits, particularly in the area of learning new skills or procedures, and how they can be built. They are then guided through the process of identifying the skill or process they want to turn into a habit, and the process of creating an exercise that they will repeat every day for twenty days.

Once the habit-in-the-making has been identified and described, the student will be reminded (through the automated calendar reminder system) to repeat the appropriate exercise every day. They will also be instructed to return to the Habit Workshop each day to log their progress. All log entries, as well as the habit title, description, and exercise will be stored in a database table for the student's future reference.

22—Recall Room

This module can be reached either by clicking the “Recall Room” button on the Student Home Page, or from a link at the end of a course module. Once in the Recall Room, the student can review the material they want to be able to recall using an existing mneumonic memory aid, or they can create and/or review a recall activity of their own. Students are expected to participate in four of these practice sessions of 5 to 15 minutes four times over the period of a month. In addition to creating new recall items and working with an existing mneumonic, students are also able to log individual recall activities and view their recall log. Mneumonic memory aids are used to provide out-of-the-ordinary visual and auditory pegs to which students can attach information they want to recall.

Because of their colorful, active, and unusual nature, these pegs are easy to remember. Therefore, students who are able to recall the pegs are also able to recall the information attached to them.

As is explained elsewhere in this document, some improved results in a student's ability to recall targeted information might occur by utilizing more or longer practice sessions. However, using just four sessions of 5 to 15 minutes each seems to be the most effective and least time-consuming methodology to produce the desired results.

23—Learning Style Helper

This is a link on the Student Home Page that will display the student's individual learning Preference Guide as described in #17 above.

24—Calendar

The Calendar link can be found on the Student Home Page, the Instructor Home Page, and the Administrator Home Page. When clicked it transfers the user to hide her own personal online calendar. The calendar can be viewed in day, week, or month format. Users can create, modify, or delete calendar entries and can set reminders that will automatically be posted to their individual home page on specific dates.

25—Message Center

The Message Center link can be found on the Student Home Page, the Course Environment Page, the Instructor Home Page, and the Administrator Home Page. When clicked users will be transferred to the Message Center module where they can read or send messages. This messaging function can be used to send messages to an entire class or an individual student. Any user of the system can communicate with any other user of the system through this facility.

26—Help

The Help link is available on every page of the Preferred learning System. By clicking the Help icon, users are transferred to an extensive online help system. They can access the appropriate area using an index, a search feature, or go directly to help for individual pages when they click on help from that page.

27—Work with Course Environment

This is a link found on the Instructor Home Page. When clicked, a sub-menu is displayed that permits the user to choose to configure a course, work with course FAQ's, work with a course glossary, or work with a course virtual library. These items are described in #50-53.

28—Work with Course Components

This is a link found on the Instructor Home Page. When clicked, a sub-menu is displayed that permits the user to choose to work with a course Syllabus Builder, work with a Course Objectives Builder, work with the Test Builder, or work with the Project Builder. These items are described in #63-66.

29—Manage Courses

This is a link found on the Instructor Home Page. When clicked, a sub-menu is displayed that permits the user to choose to work with their Student Contact Log, Assess Activities, Assess Projects, or work with Groups. These items are described in #76-79.

30—Manage Students

This is a link found on the Instructor Home Page. When clicked, a sub-menu is displayed that permits the user to choose to view a course using the sensory and metacognitive preferences of an individual student, manage student records (i.e: add new students, modify student data, delete a student record), and participate in, monitor, or moderate online discussions. These items are described in #86-88.

31—Personal Tools

This is a link found on the Instructor Home Page. When clicked, a sub-menu is displayed that permits the user to choose to work with their Personal Note Log, take the learning Assessment or view their learning Preference Guide, and create or modify their personal profile record. These items are described in #89-91.

32—Toolkit Activities

This is a link found on the Instructor Home Page. When clicked, a sub-menu is displayed that permits the user to choose to create supplemental course activities, modify those activities, delete the activities, or assign existing activities to a class, a group, or an individual student. These items are described in #97-100.

33—Access Reports

This is a link found on the Instructor Home Page. When clicked, a sub-menu is displayed that permits the user to choose to view a variety of reports. The reports are categorized as Student Status Reports, Instructor Log Reports, and Other Reports. These reports are described in #101-103.

34—Change User Mode

This is a link found on the Instructor Home Page. When clicked, the instructor will be directed to a series of screens that allows him/her to choose to see a given course as it would be presented to students of any learning preference.

They are asked to choose one of the four basic formats in which the courses are presented, and then choose among six of the metacognitive styles each time an activity is triggered within the course. They are able to move back and forth through various presentations at multiple points within each module.

35—Course Setup

This link is found on the Administrator's Home Page. When clicked, the Administrator will be asked to choose whether he/she wants to create a new course section and description, modify an existing course record, delete a course record, or assign an instructor to a specific course. These modules are described in #I 04-107.

36—Manage Instructors

This link is found on the Administrator's Home Page. When clicked, the Administrator will be asked to choose whether he/she wants to create a new instructor's record, modify an existing instructor record, or delete an instructor record. These modules are described in #108-110.

37—Manage Assistants

This link is found on the Administrator's Home Page. When clicked, the Administrator will be asked to choose whether he/she wants to create a new authorized assistant record, modify an assistant instructor record, or delete an assistant record. These modules are described in #111-113.

38—Access Reports

This link is found on the Administrator's Home Page. When clicked, the Administrator will be asked to choose which report they wish to view. These reports are described in #115-119.

39—Configure System

This link is found on the Administrator's Home Page. When clicked, the Administrator will be asked to choose whether he/she wants to set the initial course environment defaults for his/her company, or modify defaults that have been previously set. These modules are described in #120-121.

40—Course Content

Once a student clicks on the “Course” button on the Student Home Page, they are transferred to the Course Environment Area. Displayed on this screen will be a menu from which the student can choose the course module in which he/she wants to work. Once they click on the appropriate module, the first screen of that module content will be displayed. See page 19 of the flowchart for a detailed description of how course content is created and displayed.

41—Course Syllabus

This is a link found on the Course Environment Page. When clicked, the syllabus that was created for this course will be displayed to the student. This process is described in #67.

42—Course Objectives

This link is found on the Course Environment Page. When clicked, the student will see the objectives that the instructor created for each module of the course. This process is described in #70.

43—Course Projects

This link is found on the Course Environment Page. When clicked, the student will see any special project assignments (along with the project due date) that were created and assigned to that student by the course instructor. This process is described in #73.

44—Testing Center

This link is found on the Course Environment Page. Students will click this button when it is time to take a module pre-test, a module post-test, or a final test for the course on which they are working. All of these tests would have been created by the instructor and assigned to the class. See #123-125 for details.

45—Supplemental Activities

This link is found on the Course Environment Page. When students click this button, they will be transferred to a supplemental activity that was created by the 7 instructor using the learning system Toolkit (see #97). Activities can consist of games, free-form answer questions, checklists, polls, or team activities.

46—Discussion Area

This link, found on the Course Environment Page, is what a student would click to participate in an online discussion.

47—Virtual Library

This link is found on the Course Environment Page. When students click this button, they will be transferred to a virtual library. The library contains links to other online sites that have applicability to the course in which they are working. The links were created by the course instructor and made available to this student. (For details, see #60).

48—Course FAQ's

This link, found on the Course Environment Page, provides the student access to course frequently asked questions. These questions and answers were created by the course instructor (see #54).

49—Course Glossary

This link is found on the Course Environment Page. When clicked, the student will be able to access a list of course-specific terms and their definitions. The glossary entries were created by the course instructor (see #57).

50—Configure Course

This link is found on the Instructor's Home Page. When clicked, the instructor is transferred to a screen where they can toggle course environment features on or off. They can choose to include (or not include) the following features in the course environment that students see: course syllabus, course objectives, course-specific FAQ's, a course glossary, a course virtual library, instructor-created projects, instructor-created tests, threaded discussions, and student-to-student messaging.

51—Work with FAQ's

Instructors who choose to work with FAQs are transferred to this screen. Here they click on a menu choice to create, modify, or delete course-specific frequently asked questions. Depending on their choice, they are transferred to #54, #55, or #56.

52—Work with Glossary

Instructors who choose to work with glossary entries are transferred to this screen. Here they click on a menu choice to create, modify, or delete course-specific glossary entries. Depending on their choice, they are transferred to #57, #58, or #59.

53—Work with Library

Instructors who choose to work with virtual library entries are transferred to this screen. Here they click on a menu choice to create, modify, or delete course-specific library entries. Depending on their choice, they are transferred to #60, #61, or #62.

54—Create FAQ's

In this series of screens instructors are asked to enter course-specific frequently-asked questions and their answers. Once submitted, the questions and answers are made available to the students enrolled in the course whenever they click on the FAQ button in their course environment.

55—Modify FAQ's

In this area all of the instructor's previously-created frequently-asked-questions and answers are displayed. Instructors are given the opportunity to make any desired changes to these entries and re-submit them. Once this occurs, the modified entries are made available to students in this class.

56—Delete FAQ's

This is the area where instructors can delete previously-created FAQs and their answers. Before the entry is permanently deleted, they are asked to select the specific entry they wish to erase and then confirm that that they really wish to complete the deletion.

57—Create Glossary

In this series of screens instructors are asked to enter glossary terms and their definitions. Once submitted, the glossary entries are made available to the students enrolled in the course whenever they click on the “Glossary” button in their course environment.

58—Modify Glossary

In this area all of the instructor's previously-created glossary entries are displayed. The instructor may make any desired changes to these entries and re-submit them. Once this occurs, the modified entries are made available to students in this class.

59—Delete Glossary

This is the area where instructors can delete previously-created glossary entries. Before the entry is permanently deleted, they are asked to select the entry they wish to erase and then confirm that that they really wish to complete the deletion.

60—Create Library Entry

In this series of screens instructors are led through the process of creating links to other online sites that may be useful to their students. In addition to entering the URL of the site, instructors are also asked to enter comments that will guide students as to what kind of information can be found there. Once submitted, these virtual library entries are made available to the students enrolled in the course whenever they click the “Virtual Library” button in their course environment.

61—Modify Library Entry

In this area all of the instructor's previously-created virtual library links and comments are displayed. Instructors may select and make any desired changes to specific entries and re-submit them. Once this occurs, the modified entries are made available to students in this class.

62—Delete Library Entry

This is the area where instructors can delete previously-created links to other online sites. Before the entry is permanently deleted, they are asked to select the entry they wish to erase and then confirm that that they really wish to complete the deletion.

63—Work with Syllabus

Instructors who choose to work with a course syllabus are transferred to this screen. Here they click on a menu choice to create, modify, or delete a course-specific syllabus. Depending on their choice, they are transferred to #67, #68, or #69.

64—Course Objectives

Instructors who choose to work with course objectives are transferred to this screen. Here they click on a menu choice to create, modify, or delete course-specific glossary entries. Depending on their choice, they are transferred to #70, #71, or #72.

65—Test Builder

On this screen, instructors can choose to create, modify, or delete course-specific test questions. They can also select the type of test they wish to create. This can be a module pretest, a module post-test, or a course final test. Depending on their choices, they are transferred to #I 26, #I 27

66—Project Builder

Instructors who choose to work with projects are transferred to this screen. Here they click on a menu choice to create, modify, or delete course-specific special projects. Depending on their choice, they are transferred to #73, 74, or #75.

67—Create Syllabus

If the instructor chooses to create a syllabus, they will be transferred to this area of the learning system. Here they will be led through the process of creating an online syllabus for their students. They have the ability to include (or not include) any of the following information in the syllabus: general information, such as instructor name, course name, instructor contact information, course begin-and-end dates, etc.; a course introduction outlining the purpose of the course; a course materials description that includes a list of the materials that are required, as well as those that are elective; a course grading policy outlining how evaluations will be weighted in the student's final grade; additional general information where the instructor can include any miscellaneous information not included in any of the above sections; and a task list that identifies and describes each assignment and test as well as the date on which that assignment is due.

68—Modify Syllabus

If the instructor chooses to modify an existing syllabus, they will be transferred to this area of the Preferred learning system. Here they will be led through a process of modifying syllabus entries and submitting the changes. They have the ability to change any area of the existing syllabus or to delete individual task entries that are no longer desired.

69—Delete Syllabus

If the instructor chooses to delete an existing syllabus, they will be asked to identify the syllabus they wish to delete and then confirm that they really wish to permanently erase the document. If they agree, the syllabus will be deleted.

70—Create Objectives

If the instructor chooses to create objectives for the course, they will be transferred to this area of the Preferred learning system. Here they will be asked to enter and submit objectives for each module of the course in question. Once submitted, these objectives will be available to students of the course whenever they click the “Course Objectives” button in their course environment.

71—Modify Objectives

If the instructor chooses'to modify existing course objectives, they will be transferred to this area of the Preferred learning system. Existing course objectives will be displayed and the instructor may change any entry that they wish. Once the changes have been submitted, they will become available to students.

72—Delete Objectives

If the instructor chooses to delete an existing course objective, they will be asked to identify the objective they wish to delete and then confirm that they really wish to permanently erase the entry. If they agree, that course objective will be deleted.

73—Create Projects

If the instructor elects to create a course project, they will be transferred to this screen. Here they will be asked to enter the project's title, it's description, detailed instructions on how the project should be carried out, and the date by which the project should preferably be completed. Once submitted, the project instructions will be made available to students of the course through area #43.

74—Modify Projects

If the instructor chooses to modify an existing project assignment, they will be transferred to this area of the Preferred learning system. Here they will be asked to select the project they wish to modify. The chosen project's title, instructions, and due date will be displayed, and the instructor will be permitted to make changes and re-submit the entry.

75—Delete Projects

If the instructor chooses to delete an existing project, they will be asked to identify the project they wish to delete and then confirm that they really wish to permanently erase the assignment. If they agree, the project will be deleted.

76—Work with Student Contact Log

Instructors who choose to work with student contact log entries are transferred to this screen. Here they click on a menu choice to create, modify, or delete course-specific glossary entries. Depending on their choice, they will be transferred to #80, #81, or #82.

77—Assess Activities

During the progress of a course, students will be asked to complete activities that cannot be graded or critiqued without instructor intervention. This is the area of the Preferred learning system where instructors can access the work of this type that has been submitted for their review. Instructors are guided through a process in which they write a critique of the student's work and, optionally, assign a grade or points earned. Once the instructor submits the critique, it is automatically sent to the student and recorded in the instructor's critique log.

78—Assess Projects

During the progress of a course, instructors may choose to assign special projects to either individual students, or all students taking the class. These projects may be performed off-line and/or sent to the instructor off-line, but the project is always evaluated through this area of the Preferred learning system.

Instructors are guided through a process in which they write a critique of the student's project and, optionally, assign a grade or points earned. Once the instructor submits the critique, it is automatically sent to the student and recorded in the instructor's project log.

79—Work with Groups

On this screen, instructors can choose to create, modify, or delete small groups within a class. These temporary groups can be formed for a specific course-related purpose and then dissolved when that purpose has been achieved. Depending on the instructor's choice, they will be transferred to #83, #84, or #85.

80—Create Contact Log Entry

If the instructor chose to create a new contact log entry, he/she will be transferred to this area. He/she will be asked to select the appropriate course, the student for whom they wish to log a contact, and the method of the contact (i.e.: face-to-face, e-mail, online discussion area, telephone, or other). They will then be asked to enter the date of the contact and a description of the event. Once the instructor submits the entry, it will be saved in their contact log.

81—Modify/View Contact Log Entry

Once an entry has been saved in the contact log, an instructor may choose to modify or view a specific entry. The instructor may choose to view entries for an individual student, within a specific date range, or by type of contact (i.e.: e-mail, phone, etc.). Once the selected entries are displayed, they may then choose a specific entry from the list to modify. Upon submission, the entry is updated in the instructor's contact log.

82—Delete Contact Log Entry

An instructor may also choose to delete an entry from their Contact Log. This is done by selecting the “Delete” button that appears next to the entry on the list described above under #81—The entry is then displayed, and the instructor is asked to confirm that they wish to permanently erase the entry.

83—Create Groups

Instructors may choose to create small working groups within their course for purposes such as working on a project or participating in a team-building exercise. This is the area in which they would be able to create those groups. Instructors select individual students from a class list to become members of the group, give this group a unique name and submit their choices.

84—Modify Groups

If an instructor chooses to modify an existing group description, they are transferred to this area. Here they can add a new member to the group, remove a member, or even re-name the group. Once the changes have been made and submitted, the group definition is updated.

85—Delete Groups

Instructors who choose to delete an existing group are transferred to this area. The instructor is asked to select the group from a drop-down list and then confirm that they wish to permanently erase that group.

86—View Courses

This is a link found as a sub-choice under the “Manage Students” button on the Instructor Home Page. When clicked, the instructor will be directed to a series of screens that allow him/her to view a specific module as it would be presented to a specific student in the selected class. Instructors are asked to select the student's name from a drop-down class list. The module is then displayed just as that student would see it. This feature is intended for use when an instructor is working one-on-one with a student.

87—Manage Students

This is the area of the Preferred learning system where an instructor can create, modify, or delete student records. The Preferred learning system allows the initial entry of student records by automatic upload from existing computer data, by manual entry by the instructor (or an instructor's assistant), or by manual entry by the student. Data gathered includes typical course registration and student contact information.

Once student information has been entered into the system and associated with registration in a particular class, the data can be viewed and/or modified by the instructor at any time. The record for the selected student is displayed and the instructor is instructed to change any data they wish (except for the user name and password). Once the data is submitted, the original student record is modified.

Instructors may also delete a student record. This is done by selecting the record and then verifying that the displayed record is to be permanently erased.

88—Work with Discussions

If the instructor clicks on the “Discussion” button on their home page, they are transferred to the Discussion Area for the chosen course. In this area instructors can monitor, moderate, initiate, participate in, or delete a discussion. They are also able to lock a topic to prohibit additional replies, or flag a topic that should receive priority attention from students.

89—Work with Notes

Instructors who click on the “Notes” button on their home page are transferred to this screen. Here instructors can choose to create, modify, view, or delete records in their personal note log. Once they make their choice, they will be transferred to #92, #93, or #94.

90—Personal Preferences

This is the area of the Preferred learning system where the instructor can personally take the same learning Assessment as that given to students. The first time the instructor enters this area, the assessment instrument is automatically generated for their use. Once they have completed the assessment, the instrument will no longer be displayed when they enter this area. Instead, their own learning Preference Guide will be displayed.

As was true of the student's Preference Guide, this document consists of 24-40 pages and/or screens of detailed information about the instructor's individual learning preferences, information about how people learn, suggestions on how to utilize individual preferences, and tips on how to improve recall.

91—Work with Profile

On this screen, instructors can choose to create, modify, view, or delete data from their personal profile record. Once they make their choice, they-will be transferred to #95, #96, or #97.

92—Create Note Entry

Instructors are asked to enter a title to identify the personal note they wish to enter. They may then enter text of any length in a free-form “note” box. Once this note is submitted, it is date stamped, stored in the instructor's personal note log, and can be retrieved through the learning system reporting function.

93—Modify Note Entry

Instructors choose the note they wish to modify or view from a list of note titles. By clicking on this title, the matching note will be displayed and changes can be made. When the revised note is submitted, it will replace the original note in the instructor's note log.

94—Delete Note Entry

To delete a personal note, the instructor is asked to select the title of the note they wish to delete from a displayed list. They are then asked to confirm that they wish to permanently erase that note.

95—Create Profile

Instructors are asked to enter personal data that will be used within the Preferred learning system. Contact information includes name, work telephone number, home phone number, and e-mail address. Alias information includes the name by which the instructor wishes to be known in the Discussion Area, the Message Center, and on the Course Syllabus. In addition, instructors are able to change and verify their learning system password.

96—Modify Profile

Instructors who choose to modify or view their profile information are transferred to a screen that displays all of the information they entered into their personal profile in #95. They can change any of that data by retyping it and then submitting it for replacement in the Profile Table.

97—Create Activities

Instructors are able to create supplemental assignments for courses through the Toolkit Activity Builder. The current embodiment of the builder includes fifteen pre-configured activity templates into which instructors can insert their own material. The number of templates available will be greatly increased in future iterations of the product to provide instructors with more choice and flexibility.

Additional templates may be developed by identifying the discrete common elements of a proven and effective learning activity, creating a series of screens and step-by-step instructions to enable instructors or other users to insert their own content into the template, coding a program to display those elements in the proper order, providing appropriate feedback to the user, and scoring and/or storing activity results in the learning system database for later reporting. An example of one of the many types of activities that can be developed using such a template is an online simulation of a process.

Instructors are guided through a process in which they give the activity a title, write student instructions for the activity, and then insert data in the form of questions, answers, terms, or additional material. Creation specifics may differ for each activity, depending on the activity requirements.

Once the instructor submits the data, the game, exercise, or interactive task is generated. Activities are scored as they are completed (unless otherwise noted) and the results are placed in the student's record. Some preferred activity templates are illustrated at Appendix B, which is hereby incorporated by reference, and are as follows:

a. Ask the Audience—An online polling activity. This activity is not graded. Instead, results of the poll are posted to the student's home page.

b. Category Solitaire—A graphic solitaire game in which the student places each card in the deck on a stack representing a specific category related to the subject matter. Includes sound effects and animation.

c. Check the Match—An activity where students place a checkmark next to each item in a list that belongs to a specific category. Includes animation.

d. Draw a Straight—A graphic game similar to drawing a straight in poker where students try to complete a “straight” by selecting only the cards from a deck that are representative of characteristics of a predefined subject. Includes sound effects and animation.

e. Flash the Facts—An online version of flash cards that provides a way for students to review facts related to a subject. Includes sound and animation.

f. Free Form Response—An exercise where the instructor creates one or more questions and the students reply in a free-form box that is submitted to the instructor for evaluation. Short-answer and essay questions are both supported.

g. Life or Death—An online version of the “Hangman” game. Includes animation and sound.

h. Multiple Choice Challenge—A multiple choice quiz where students try to beat the clock in choosing the correct answers to questions. Includes animation and sound.

i. One Step At A Time—An online exercise where students try to arrange items in a timeline according to directions. Includes animation and sound effects.

j. Opinions—An interview exercise where students are asked to conduct off-line interviews and report their results online. Data is collected and results are reported to the class.

k. Ring the Bell—An online version of “Who Wants to Be A Millionaire”. Students proceed through several levels of questions. If they get to the top, it causes “Chuckles the Clown's” head to spin. Includes animation and sound effects.

l. The learning Challenge—An online learning tournament. The class is divided into teams and they compete on their knowledge of a subject through three rounds of questions spread out over several days. Results are reported back to the class after each round so each team knows how it is doing at every stage. Providing a reward for the winning team is recommended.

m. The Perfect Match—A graphic version of a typical matching exercise. Students are asked to match one item from the “A” list to one item in the “B” list.

n. Treasure Quest—Students are asked to participate in a treasure hunt for facts on a subject. Clues to the location of information are provided. Locations can include both online and off-line sources.

o. Why—This exercise is a variation of the typical “True-False” question. In addition to choosing the “answer” (i.e.: true or false), the student is expected to use a free-form box to explain why they chose that answer. Results are submitted to the instructor for critique.

98—Modify Activities

Once a supplemental activity has been created, the activity can be modified. The instructor is asked to select the appropriate activity title from a list. The same screens that were used to create the activity are then displayed, and the instructor can change any element that they originally entered. Once the changes are submitted, the modified activity replaces the original in the activity table.

99—Delete Activities

An instructor can delete any activity by selecting it from a list and then confirming that they wish to permanently erase the activity.

100—Assign Activities

Once instructors have created a supplemental activity, they are able to assign that activity to an entire class, individual students, or a student group. They are asked to click on a button to assign the activity to the class, or to select individual students or student groups from a class list. In addition, they are asked to select a date on which the assignment will begin and a due date for assignment completion. Once these choices are submitted, a message alerting students that a new supplemental activity has been assigned will be displayed on the course environment page. Students may access this activity by clicking on the “Supplemental Activity” button found on that page. See #45 for details.

101—Student Status Reports

Instructors who click on the “Status Reports” sub-menu item (see #33) can choose to display and/or print any one of six reports designed to provide useful information on student status. Those reports are as follows:

a. Student Progress Report

Instructors can choose to generate this report for one or more selected students, or for the whole class. The report lists the students in alphabetical order and indicates which modules the student has completed and the date on which this occurred.

b. Student Activity or Project Status Report

Instructors can choose to generate a report on built-in course activities, instructor-assigned course projects, or instructor-assigned supplemental activities. The instructor can also choose to include one, several, or all activities, or one, several, or all class projects in the report. The report generated lists the course title, the date on which the report is being generated, the appropriate module name, the activity (or project) name that is executed within that module, the students'names (in alphabetical order), the date the activity (or project) was completed, and the student's score on that activity (or project). At the bottom of the report the class average score for the activity or project is shown.

c. Student Detail Report

Instructors choose the student whose work they want to review. The report generated lists the task title, the date completed and the score for everything the student has done in that course. This includes all module pre-tests, all module post-tests, all course activities, all supplemental activities, all projects related to the course, and the course final test.

d. Student Test Results

Instructors choose to see a report that includes data on only pre-tests, only post-tests, specific tests (such as a final exam), or all tests. They can also choose to see the report for an individual student, or all students in the class. If the instructor chooses to generate a report for one specific student, the report will list the student's name, the test names, the date each test was taken, and the student's score. If the instructor chooses to generate a report for the entire class, they can choose to see the report organized in alphabetical sequence by student name, or in sequence by test name.

e. Student Averages

This report displays the name of each student in the class in alphabetical order, the student's average score for all post-tests taken, the student's average score for all built-in course activities completed, the student's average score for all supplemental activities completed, the student's average score for all course projects completed, and the student's total average. At the bottom of the report the class overall average in each of the above categories is displayed.

f. Test Score Summary

This report displays student grades for tests only. It covers each module pre-test, each module post-test, and any special tests (such as the final exam). It lists all students in the class in alphabetical order, along with each student's individual score and the date on which the test was taken.

102—Instructor Logs

Instructors who click on the “Instructor Logs” sub-menu item (see #33) can choose to display and/or print four of the five reports designed to provide information extracted from any of the instructor's logs. (The “Browse Logs” report cannot be printed.) Those reports are as follows:

a. Browse Logs Online

Instructors choose a course and whether they want to view the entries for that course in their student contact log, their critique log, or their personal note log. Entries will be displayed by date in descending order.

b. Personal Note Log

Instructors can choose to see every entry in this log, or choose to see only entries within a specific date range. Once these choices have been made, the report displays the date of the entry, the subject of the entry, and the entry itself.

c. Student Contact Log

Instructors can generate this report to include every contact with every student in a class, only contacts with a specific student, or only contacts made within a specific date range. The report includes the date of the contact, the student's name, the type of contact that was utilized (i.e. face-to-face, e-mail, etc.), and a description of what occurred during that contact. The instructor can choose to see the report displayed in alphabetical order by student, on in descending order by date.

d. Critique Log

Every time an instructor critiques a student's work on a class project, or a free-form activity, that critique is stored in the instructor's Critique Log. This report can be generated to display only project critiques, only free-form critiques, or both. In addition, instructors also have the option to view critiques in the chosen category for only those falling within a specific date range, for only those that apply to a specific student, or for all students in a class. The report includes the date of the critique, the project or free-form activity name, the student's original submission, the instructor's critique, and the student's score (if any).

e. Critique Summary

This report is designed to display summary information on only one project, one free-form activity, or within a specific date range. The report lists each student whose project or free-form activity was critiqued, the title of the project or free-form activity, the date it was critiqued, and the score the student earned (if any).

103—Other Reports

Instructors who click on the “Miscellaneous Reports” sub-menu item (see #33) can choose to display and/or print any one of seven reports designed to provide useful information on student status. Those reports are as follows:

a. Course Configuration Report

This report displays a list of the course environment features that the instructor turned on or off in #27 above. It provides a record of the current course environment setting for any given course.

b. Class List

This report is a class roll for a course selected by the instructor. It includes each student's name, their physical address, their telephone number, their e-mail address, whether they are an active or inactive student, and the date of their enrollment. Instructors may choose to organize this report in alphabetical sequence on the student name, or in ascending sequence on enrollment date.

c. Group List

This report lists the name of all groups that have been created in a selected course, the names of the members of each group, and the date the group was created.

d. Student Active Status

Instructors are asked to choose the class for which they wish to generate this report. They can choose to display active students only, inactive students only, or all students who have ever been registered for the class. If the instructor chooses to see active students only, the report includes the active students'names (in alphabetical order) along with their enrollment date. If the instructor chooses to see inactive students only, the report shows the names of all inactive students, the student's enrollment date, and the date the student was withdrawn from the class. If the instructor chooses to see a report including both types of students, the report will list the student's name, their enrollment date, their end date, and their current status (i.e. active or inactive).

e. Student Usage Report

This report is designed to report on the actual time each student in a course has spent to-date working in the selected course. It lists all students in a class, shows the date of the student's first log-in, the date of their most recent log-in, the total number of log-ins, and the total elapsed time the student has spent in the course. Students are listed in alphabetical order.

f. Project List

This report provides information on each project that the instructor has created for a selected course. Each project title is listed, along with the project description, the date the project was assigned, and a list of the groups (if any) that were created for this project.

g. Activity List

Instructors are asked to select the course for which they wish to generate this report, and then choose whether they want the report to include information on all of the customizable activities available in the learning system Toolkit, on only those customizable activities that the instructor has already created, or on only the built-in activities that exist within the course. Depending on their choices, different reports are generated.

If the instructor chooses to see a list of all available Toolkit customizable activities, the report will list in alphabetical order the title of each available activity along with a description of how the activity works.

If the instructor chooses to see a list of the Toolkit activities they have already created, the report will list the title the instructor gave to the activity when they created it, the date the activity was created, the Toolkit title for that activity, and whether or not the activity is currently in use.

If the instructor chooses to generate a report on the non-customizable activities that are built into the course, the report will list the activity identifier of each built-in activity, the name and number of the module in which it appears, and the abbreviation of the metacognitive styles for which that activity was built. A legend of metacognitive-style abbreviations will be listed at the bottom of the report.

104—Open a Course Section

Initially, only custom courses for clients built by Solutions 9 will be offered within the preferred learning system. Therefore, the course, along with the learning environment of the preferred system, will be preferably provided as a package.

learning system administrators in a company or educational institution, who are setting up the learning system-supplied course for the first time, will be instructed to click on the “New Section” button. The administrator will then be transferred to a screen where he/she will be asked to enter the title by which they wish this course to be known, the unique section number by which this section of the course can be identified, a description of the course, and either a course begin-date and end-date, or a flag that identifies the course as an open entry/open exit course. If at a later time the administrator wants to open up another section of the same course, they will again click on the “New Section” button. A screen will be displayed that contains all of the information that was recorded when the first section was opened and the administrator will be asked to enter a new section identifier. The administrator may also choose to change the “begin“and “end” dates, or the open entry/open exit flag settings.

105—Modify a Course

In this function, administrators can modify a course by clicking on the “Modify” button that appears next to the course title on the opening screen of the “Course Setup” area. They will then be transferred to a screen where they will be able to change the course title, the course section identifier, the course description, the course begin and end dates or the open entry/exit flag setting.

106—Delete a Course

In this function, administrators can delete one or more course sections. To do so they are asked to click on the “Remove Section” button that appears next to the course title on the opening screen in the “Course Setup” area (#35). They should preferably confirm that they really wish to permanently delete that section before the action is carried out.

107—Assign Instructors

Instructors are assigned to teach a section of a course by the organization's administrator. To do this, administrators are asked to click on the “Assign Instructor” button that appears next to the course title on the opening screen of the “Course Setup” area (#35). They are then transferred to a screen where they choose the name of the instructor from a drop-down list of valid instructors, and then submit their choice.

108—Create Instructor Record

Administrators are charged with the responsibility of entering valid instructors into the learning system database. When'they choose to create a new instructor record, they are asked to choose whether they wish to enter the record themselves, let the instructor enter their own information, or select the instructor's information from an already-existing internal database. Once the data has been entered, a unique key is generated for that instructor.

Data entered includes the instructor's name, address, e-mail address and phone number, as well as a computer-generated key that will be assigned to that instructor for their first login. If the administrator personally entered the data, the administrator receives a list of the key and name of each instructor entered, as well as instructions for using the key to logon to the system for the first time. The administrator is instructed to pass this information along to each instructor listed.

If the administrator chose to activate the feature that permits instructors to enter their own data, or if the administrator is importing the required data from an already-existing database, the administrator will be asked to enter the number of keys they wish to generate. A list of the keys generated will be displayed, and the administrator is asked to distribute a key to each instructor, along with instructions for the key's use.

109—Modify Instructor Record

Administrators who choose to modify an existing instructor record will be shown a listing of all valid instructors, along with the information contained therein. The administrator will be asked to click on the name of the instructor whose record they wish to modify. The instructor's record will be displayed and changes may be made. Once the modified record is submitted, the data in the original record will be updated.

110—Delete Instructor Record

Administrators who choose to delete an existing instructor's record will be shown a checklist of all instructors in the system. They will be instructed to click on the checkbox next to the names of any instructors whose records they wish to delete. Once these selections are submitted, the administrator will be asked to verify the deletions before the records are permanently erased.

111—Create Assistant Record

Administrators can authorize employees other than the course instructor to enter student, course, or instructor records into the learning system database. In addition, instructors may wish to utilize teaching assistants who work with students in their course, and will, therefore, ought to access the preferred learning system. This is the area where records for all non-instructor assistants are created.

The administrator is asked to enter the non-instructor's contact information (such as address, phone number, and e-mail address), as well as the name of the instructor or administrator whom they will be assisting. As was the case with creating an instructor record, administrators can choose to acquire the data and provide keys in each of the ways described in #108 above.

112—Modify Assistant Record

The administrator can change any of the data in an existing assistant's record. The administrator who enters this area (by clicking on the “Modify Non-Instructor” button on the Administrator Home Page), is asked to click on the name of the assistant whose record they wish to change, enter the modified data into the appropriate field of the record that is displayed, and then click on the “Submit” button to save the updated information.

113—Delete Assistant Record

The administrator can delete an assistant's record from the database by clicking on the “Remove Non-Instructor” button and then selecting the name of the assistant whose record they wish to remove. Before the record is permanently deleted, the administrator will be asked to confirm the removal.

114—Default Settings Report

This report displays a list of the course environment features that the institution's administrator for the Preferred learning system turned on or off in #39 above. It provides a record of the current settings that are available for course instructors to configure.

115—Instructor List

The purpose of this report is to provide a list of all instructors assigned to a specific course. In addition to the instructor's name, the report also lists the their address, their telephone number, and their e-mail address.

116—Course List

This report lists all courses being offered in the Preferred learning system. The course title, course description, course begin-date and course end-date are displayed for each course.

117—Instructor/Course List

This report lists all instructors authorized to teach a course in the Preferred learning system, as well as the courses to which they are assigned. Administrators can choose to view this report in two ways . . . by course, or by instructor.

If the administrator chooses to generate the report by course, the course name is displayed, followed by a list of all instructors that are authorized to teach that course, as well as the section number of the course to which each authorized instructor is linked, followed by the number of students enrolled in that section of the class.

If the administrator chooses to generate the report by instructor, the instructor's name is displayed, followed by a list of all courses to which that instructor is assigned, the section number for that course that is related to that instructor, and the number of students enrolled in that section of the course.

118—Student Course List

The administrator chooses the course for which they want to generate this report. A list of all students enrolled for that course will be displayed in alphabetical order.

119—Non-Instructor List

Administrators can authorize employees other than the course instructor to enter student, course, or instructor records into the learning system database. In addition, instructors may wish to utilize teaching assistants who work with students in their course, and will, therefore, ought to access the preferred learning system. This report lists the name, title, telephone number, and email of each of these non-instructors that are active in the system.

120—Set Initial Course Defaults

On this screen, administrators are asked to either accept system defaults, or turn off features of the Preferred learning system on behalf of their company. The product will be delivered with all features enabled, but a company may elect to disable a feature for use within their institution. The features that can be disabled include the ability to use course objectives, course-related FAQ's, a course glossary, student-to-student messaging, a course syllabus, the testing center, the discussion area, course projects, supplemental activities, and the ability of each student to print their learning Preference Guide.

121—Modify Course Defaults

Any of the features described in #120 can be turned back on, or turned off by the administrator at any time. This is accomplished by the use of a toggle switch for each feature. One click changes the switch setting for that feature from “on” to “off (or vice versa).

122—Course Content

In Version 1.0 of the learning System, course content may be created by developers. The preferred development process that is followed is described below. Once the course has been created, it is stored in a course content database that is accessible to the learning system. When a user signs on to a course, the course is dynamically assembled from learning objects and/or modules in this database and displayed in a way that is dependent upon one or more learning preferences or a preference profile for particular student. It is preferred that this profile is generated from the performing of a learning assessment in accordance with a preferred embodiment. The preference profile used in retrieving the learning objects and/or learning modules and/or courses of study may also be selected by a student or professor, or otherwise determined than by performing a preferred learning assessment such as by using a conventional learning assessment.

The content of the course will be presented to the user in a format that has been designed to emphasize their strongest sensory preference (i.e. visual, verbal, kinesthetic, or auditory) and/or their strongest organizing metacognitive preference (i.e.: sequential or global). In addition, interactive learning objects, based on three other individual metacognitive preferences, may be preferably displayed, interacted with, and feedback provided at points within the content presentation.

For instance, a first interactive learning object presented to the user might be based on either a concrete or abstract metacognitive preference, whichever is stronger for that user. A second learning object presented might be based on whether or not the student is primarily active or reflective, and a third might be based on whether or not the student is more intuitive than analytical. If more than three interactive devices are used within any given module content, any of these metacognitive pairs might be repeated in an additional interactive learniig object. As mentioned, a module may be weighted toward a learning preference. For example, a student that has a concrete preference may be presented with two concrete objects and an abstract object in a learning module that is weighted toward a concrete preference by 2 to 1. At the end of each module of a course, the student is preferably transferred to the Recall Room (#22 above) to begin the process of fixing the important points presented in the module in their long term memory.

123—Module Pre-Test

When this page is displayed to a student, they are able to take a brief test that measures how much they know about the subject to be taught in the upcoming module. This pre-test is created by the course instructor (see #I 26), consists of multiple choice and/or true-false questions, and is automatically graded by the system. The student receives feedback and the pretest score is stored in the learning system database for future reference.

124—Module Post-Test

When this page is displayed to a student, they are able to take a brief test that measures how much they know about the subject after they have completed the module. This post-test is created by the course instructor (see #I 26), consists of free-form answer, multiple choice and/or true-false questions, and is automatically graded by the system. The student receives feedback, including the difference between their pre-test and post-test scores, and the post-test score is stored in the learning system database for future reference.

125—Course Final Test

When this page is displayed to a student, they are able to take a course final examination that measures how much they have learned in the course. This test is created by the course instructor (see #126), consists of free-form, multiple choice and/or true-false questions, and is automatically graded by the system. The student receives feedback and the final test score is stored in the learning system database for future reference.

126—Create Test

When an instructor enters the learning system Test Builder, they are first asked to choose the course for which they wish to create a test, and then to select the module of that course to which the test will refer. Once they have indicated the course and the module, they are then asked to choose whether they want to create a pre-test or a post-test. They also have the ability to choose to create a final exam for the entire course.

If the instructor chooses to create a module pre-test, they are led through a process in which they select the type of question they wish to create (i.e.: true-false or multiple-choice (with 3, 4, or 5 choices)), enter the point value of the question, and then create the question and indicate it's correct answer. They can continue to create questions until the test is complete. If the instructor chooses to create a module post-test, they are led through a process in which they select the type of question they wish to create (i.e.: true-false, multiple-choice (with 3, 4, or 5 choices), or free-form essay-type), enter the point value of the question, and then create the question and indicate it's correct answer. They can continue to create questions until the test is complete. Final tests for the course can include any of the question types that are acceptable for post-tests and are generated in the same manner.

127—Modify Test

Instructors can modify any test or question within a test that they wish. To do so, they select the course, the module, and the test type that they wish to revise. Once the test is displayed, they choose the question within the test they wish to change. The question, it's correct answer, and it's point value are then displayed and the instructor can modify the content. Once the changes have been submitted, the question is modified and stored in the test table.

128—Delete Test

Instructors can delete any test or question within a test that they wish. To do so, they select the course, the module, and the test type they wish to delete. Once the test is displayed, they can choose the question within the test they wish to delete, or they can choose to delete the entire test. Instructors are asked to confirm the deletion before it occurs.

Learning Assessment

The following is set forth with reference to FIGS. 22-24. The numbers in parentheses in FIGS. 22-24 correspond to the numbers below referencing a description of the function of that portion of the learning assessment flow chart. That is, match the number in FIGS. 22-24 to the corresponding number below. Then read the description of what takes place within that process.

201. User Logon

Students enter the learning system by using the “Logon” screen described in #2 above and a FIG. 1. However, it should be noted that students may complete the learning Assessment surveys before they are able to access their home page or an online course. Therefore, the User Logon screen described in this paragraph will be explained from the viewpoint of a student who has not yet completed the learning Assessment.

The student who enters this screen for the first time (ie: a new student) will have received an e-mail from a company trainer prior to their arrival at this screen. That communication would have contained a 15-to-16-digit key that they may use to enter the system for the first time. This key includes an imbedded course ID, an imbedded student code, and nine digits randomly generated by the computer. It is unique to that particular student and gives him/her access to the system. Once the student enters the key and submits it, he/she will be transferred directly into the learning Assessment process. Because the assessment process consists of several surveys of multiple questions each, students are not required to complete the surveys in one session. If they wish, they may partially complete the surveys, exit the system, and return later to finish the process. If this occurs, they will have already created their own unique user ID and password and their key will no longer be operative. Keys are only used for first time access. Access thereafter will always require the user to enter a valid ID and password on this screen.

202. New User?

Once the student submits their key (or ID and password), the data entered will be checked for authenticity. If the logon was valid and a key (rather than an ID) was entered, the student will be transferred to the “Fill In Personal Information” screen (#3). If a user ID and password was entered, the Profile Table in the learning system database will be accessed to locate the last assessment question answered (#4).

203. Fill in Personal Information

First-time students will be asked to enter personal information on this page. Requested data includes the student's name, address, telephone number, and e-mail address. In addition, the student is asked to enter and verify a unique user ID and password that they wish to use to enter the learning system from now on. It should be noted that some data on this page may have been automatically uploaded from existing client files. If so, the student will only be asked to enter the missing information. Once the data is entered and submitted, the student will be transferred to #4.

204. First-Time-User Instructions

The user ID and password that the student chose in #3 is displayed and the student is told they should use them (instead of the key) to access the learning system in the future. The URL that will be used to access the learning system is also listed.

Students are given a chance to print this page for future reference, and are asked to choose whether or not they want to “Enter the learning System” now. If they click this button, they are transferred to the welcome page for first time users (#8). Otherwise, they can exit the system and return later to actually take the assessment.

205. Check Assessment Progress

Students who are entering the learning system for the second (or later) time may be students who completed all three surveys in their first session, or may be students who are still working on the survey. The Profile Table in the learning system database is accessed to determine where the student stopped at the end of their last session.

206. Assessment Complete?

Data received from the Profile Table is checked to see whether or not the student entering the system completed all surveys. If so, the student is transferred directly to the Student Home Page within the learning system (#7) and the rest of this flowchart is skipped. If the student has not completed the assessment, data received is checked to determine the last question completed and the student is transferred to the Welcome Back Page (#9).

207. Student Home Page

Students who have completed the learning Assessment will be transferred directly to their Student Home Page. This page is not an integral part of the learning Assessment predefined process. For a description of this page, please refer to the learning system flowchart and narrative described above with reference to FIGS. 1-21.

208. First-Time Welcome Page

This page is displayed to first-time users. It welcomes the students to the learning system Assessment and explains why they are being assessed. The sensory and metacognitive traits are described, students are instructed in the mechanics of taking the assessment, and the results they can expect to receive after completing the assessment are defined. Finally, the student is asked to click on the “Detailed Instructions” button or the “Begin Assessment” button (see #10).

209. Welcome Back Page

This page is displayed to students who only partially completed the assessment in the last session. It does not include the detailed information included in the “First-Time Welcome Page” (#8), but merely welcomes the student and asks him/her to choose to read detailed instructions (ie: the “Instructions” button), or resume the assessment where they left off (ie: the “Resume Assessment” button).

210. Need Help?

The choices made by students on the “First-Time Welcome Page” (#8) or the “Welcome Back Page” (#9) are examined. If the student in either case chose to request detailed instructions, he/she will be transferred to the “Assessment Instructions” page (#11). Otherwise, they will be transferred directly to the first question in Survery #1 (#12).

211. Assessment Instructions

This screen displays step-by-step instructions that guide a student through the process of answering questions, changing answers, and submitting completed surveys. When a student has finished reading these instructions, they are asked to click the “Begin Assessment” button to start answering questions.

212. Survery #1

Survery #1 consists of questions which measure the strength of a student's sensory learning preferences (ie: visual, verbal, auditory, or kinesthetic). The learning system Question Table is accessed, a statement is displayed, and the student uses a sliding bar to indicate their degree of agreement with the statement along a 1-to-10 Lickert scale. A “1” indicates strong disagreement with the question, while “10” indicates strong agreement. Since a slider is used to answer the question, the student can choose any degree of agreement they choose.

Once a student answers a question, his/her response is stored in the “LS Response Table” of the learning system database, Students move to the next question by clicking “Next”, or can move backward to review and possibly change the answer to a previous question (by clicking “Back”), This process continues until all questions in the survey have been answered.

Once all questions have been answered, a screen is displayed letting the student know they have completed Survery #1 and asking if they want to review their answers one last time before the results are final, If they decide to edit answers, they are transferred to “Edit Survery #1 Answers” (#13) to make changes. If not, Survery #1 is scored (see “Score Survery #1” (#14)).

213. Edit Survery #1 Answers

If the student chose to edit responses to the questions in Survery #1, the “LS Response Table is accessed so that a scrollable screen listing all questions and responses can be displayed. The student can adjust the slider on any displayed question to fine-tune the answer. Once all changes have been completed, the survey is scored (see “Score Survery #1” below).

214. Score Survey #1

The survey is made up of several questions for each sensory preference to be measured. Once the student submits their answers, the degree of agreement on each question in a category is totaled. Once all four categories have been summed, the totals are compared to determine which of the four is the preferred sense used by the student.

Since some individuals have developed more than one extremely strong sensory preference, it is important to identify those individuals so that either or both senses could be targeted when presenting new information. Therefore, if the highest sensory score achieved is within 5% of another sensory score, the student is considered to have a preference for that sense as well. Using that percentage of difference identifies dual preferences without producing significant number of false positives, In our research, greater percentages produced too many false positives, while smaller percentages excluded preferences that were very strong. However, a different percentage might be effective for a survey utilizing different questions.

All results are stored in the Profile Table of the learning system database.

215. Survery #2

Survery #2 consists of questions which measure the strength of a student's metacognitive learning preferences (eg: analytical, intuitive, concrete, and abstract). The learning system Question Table is accessed, a statement is displayed, and the student uses a sliding bar to indicate their degree of agreement with the statement along a 1-to-10 Lickert scale. A “1” indicates strong disagreement with the question, while “10” indicates strong agreement. Since a slider is used to answer the question, the student can choose any degree of agreement they choose.

Once a student answers a question, his/her response is stored in the “LS Response Table” of the learning system database. Students move to the next question by clicking “Next”, or can move backward to review and possibly change the answer to a previous question (by clicking “Back”). This process continues until all questions in the survey have been answered.

Once the questions have been answered, a screen is displayed letting the student know they have completed Survery #2 and asking if they want to review their answers one last time before the results are final. If they decide to edit answers, they are transferred to “Edit Survey #2 Answers” (#16) to make changes. If not, Survey #2 is scored (see “Score Survey #2” (#17 >>.

216. Edit Survey #2 Answers

If the student chose to edit responses to the questions in Survey #2, the “LS Response Table is accessed so that a scrollable screen listing all questions and responses can be displayed. The student can adjust the slider on any displayed question to fine-tune the answer. Once all changes have been completed, the survey is scored (see “Score Survey #2” below).

217. Score Survey #2

The survey is made up of several questions for each of the metacognitive preferences being measured. Once the student submits his/her answers, the degree of agreement on each question in a category is totaled. Once all four categories have been summed, the totals are compared in pairs to determine which of each member of a pair is the preferred organizing method used by the student. The analytical organizing preference score is compared to the intuitive score, and the concrete organizing preference score is compared to the abstract score.

Since some individuals have developed both organizing modes of a metacognitive pair, it is important to identify those individuals so that either or both organizing modes could be used when presenting new information to that student. Therefore, when comparing the scores of a metacognitive pair, if the highest score is within 5% of another sensory score, the student is considered to be equally proficient in using both organizing patterns. Using that percentage of difference identifies dual preferences without producing a significant number of false positives. In our research, greater percentages produced too many false positives, while smaller percentages excluded preferences that were very strong. However, a different percentage might be effective for a survey utilizing different questions.

All results are stored in the Profile Table of the learning system database.

218. Survey #3

Survey #3 consists of a number of questions which measure the strength of a subject's metacognitive learning preferences (eg: global, sequential, active and reflective). The learning system Question Table is accessed, a statement is displayed, and the student uses a sliding bar to indicate their degree of agreement with the statement along a 1-to-10 Lickert scale. A “1” indicates strong disagreement with the question, while “10” indicates strong agreement. Since a slider is used to answer the question, the student can choose any degree of agreement they choose.

Once a student answers a question, his/her response is stored in the “LS Response Table” of the learning system database. Students move to the next question by clicking “Next”, or can move backward to review and possibly change the answer to a previous question (by clicking “Back”). This process continues until all questions in the survey have been answered.

Once all questions have been answered, a screen is displayed letting the student know they have completed Survey #3 and asking if they want to review their answers one last time before the results are final. If they decide to edit answers, they are transferred to “Edit Survey #3 Answers” (#19) to make changes. If not, Survey #3 is scored (see “Score Survey #3” (#20)).

219. Edit Survey #3 Answers

If the student chose to edit responses to the questions in Survey #3, the “LS Response Table is accessed so that a scrollable screen listing all questions and responses can be displayed. The student can adjust the slider on any displayed question to fine-tune the answer. Once all changes have been completed, the survey is scored (see “Score Survey #3” below).

220. Score Survey #3

The survey is made up of several questions for each of the metacognitive preferences being measured. Once the student submits his/her answers, the degree of agreement on each question in a category is totaled. Once all four categories have been summed, the totals are compared in pairs to determine which of each member of a pair is the preferred organizing method used by the student. The global organizing preference score is compared to the sequential score, and the active organizing preference score is compared to the reflective score.

Since some individuals have developed both organizing modes of a metacognitive pair, it is important to identify those individuals so that either or both organizing modes could be used when presenting new information to that student. Therefore, when comparing the scores of a metacognitive pair, if the highest score is within 5% of another sensory score, the student is considered to be equally proficient in using both organizing patterns. Using that percentage of difference identifies dual preferences without producing a significant number of false positives. In our research, greater percentages produced too many false positives, while smaller percentages excluded preferences that were very strong. However, a different percentage might be effective for a survey utilizing different questions.

All results are stored in the Profile Table of the learning system database.

221. Learning Preference Guide

Once all three surveys have been completed, a PDF document containing information about the individual's learning preferences will be displayed. This document may be printed, or viewed online. For more information about the contents of this document, please refer to the “learning Style Guide”, “learning Style Helper” or “My Preferences” processes in the learning system Version 1.0 flowchart and narrative provided above with reference to FIGS. 1-21.

Course Development and Delivery

The following narrative illustrates how course creation may occur in a system in accordance with a preferred embodiment. Learning modules, learning objects and/or courses of study may be created with according to learning preference profiles. The learning modules, learning objects and/or courses of study are then stored in accordance with learning preference profiles for dynamic retrieval, assembly and delivery to students based on their individual learning preferences. Some assembly may be involved or a course, module or object may be delivered on its own upon retrieval from the database.

Each of the numbered paragraphs below represent an explanation of the purpose and content of a particular function that is provided in a block of the flow diagram provided at FIGS. 25-27.

301. Identify Desired Outcomes

The first step in the process of creating a course to be delivered in the preferred learning system engine is to identify each skill, each bit of knowledge, each understood concept, and the level of expertise that is expected of each student upon completion of the course. These outcomes are ascertained through input from content providers and/or instructors who will be teaching the course.

302. Identify Content Needed

After the desired outcomes are identified, content that may be used to achieve each outcome is defined. As was the case with #301 above, this step will also be completed preferably with the assistance of relevant content providers and/or instructors.

303. Is Content Available?

Once desired content is identified, content that is currently available will be matched with each specific outcome. Existing content will be examined to determine whether it is directly relevant to achieving the identified student outcomes, and whether the format of the existing content is the best way to present the material. In addition, existing content will be examined for its applicability for each learning preference. Specific areas in which new or modified content should be provided will be identified.

304. Create Media and Text Elements

For each area in which no content exists that meets the criteria described in #303, graphics, videos, animations, diagrams, charts, audio recordings, textual explanations, and other content elements to fill the gaps will be preferably created. Existing text may be edited to better meet the new requirements.

305. Create Course Record

Once the goals have been identified and content has been created and/or retrieved to achieve those goals, a record in the Courses table of the learning system database will be created. This record will include a course title and a description of the course. A unique ID pointing to the course will be automatically assigned to this record by the database software. This ID will be used to identify and retrieve course content as it is required.

306. Separate Content Into Modules

Once the course record and its unique ID have been created, the existing content is assigned to a specific module. Each module should be focused on one specific skill, concept, or knowledge base, and existing content will be grouped accordingly.

Research in cognitive psychology has shown that for best results, study sessions should be completed in twenty minutes or less. Therefore, each module is designed with this time limit in mind. While estimating how long it will take a particular student to complete a module will not be exact, an attempt will be made to construct modules that would likely be completed within this time limit. If it is felt that any given module will take a student longer than twenty minutes to complete, the concept, skill, or knowledge base will be broken down into sub-units so the information to be imparted can be split into two or more modules. It should be noted that while study sessions lasting longer than twenty minutes might still be effective for some individuals, all students can improve their concentration and comprehension by breaking up their study sessions into smaller (i.e.: twenty minutes or less) units.

This process will continue until all identified outcomes have been addressed. It should be noted that there is no limit to the number of modules that can be created for a course, and that a short course of study may include a single module.

307. Order Modules.

Once the content has been separated into twenty-minute modules (approximate), they are preferably numbered according to the order in which they will be presented. If the course will be presented in a linear order, the modules may be numbered according to an identified logical progression. If, on the other hand, the course will be presented as a course in which students can learn concepts, develop a skill, or acquire knowledge in a non-linear or user-selected order, the modules may be numbered in a sequence dependent upon difficulty. For example, modules that present elementary content could be assigned lower numbers than modules that contain more difficult material.

308. Create Module Record

For each module that is created, a corresponding record is preferably stored in a Modules Table of the learning system database. This record will preferably contain the course ID (see #305 above), the module title, the sequential number of the module within the course, and the module description. The Course ID and Module ID may be used to identify and retrieve course content for individual students.

309. Create Visual-Global Version

Numbers 309-312 provide four examples of learning modules based on different preference profiles. Each is based on a preference profile including a sensory preference and a metacognitive preference. A learning preference profile corresponding to a module, object or course of study may include only a single sensory or metacognitive preference or may include several. Also, a student's preference profile or a selected preference profile may include a single sensory or metacognitve preference, or one each as in the examples, or several. If a student profile included only a visual preference, it would be more likely that either the visual-sequential or visual-global modules would be retrieved from the database for that student, assuming their content is relevant, than either of the auditory-global or auditory-sequential modules. A module not having any visual sensory preference may still be retrieved in a system that is configured to select only a weighted visual preference, while a system configured to require a total visual preference would not select a module not having some visual-oriented preference.

In general, a module will have a weighted preference if it has a majority preference or if it has a greater preference than any other preference in the category selected. For example, a module that is four parts visual, three parts auditory and three parts kinesthetic may be considered to have a visual preference. This exemplary profile would perfectly match a student having a preference profile that is also four parts visual, three parts auditory and three parts kinesthetic, may weightedly match a visual only student or selection that requires that visual be the sense with maximum preference, and may not match a visual only student or selection in a majority weight configured system.

The version #309 module is built to meet the preferences of a learner whose primary sensory preference is visual and whose primary preference for organizing information in long-term memory is global. The “visual-global” version of the module may actually be made up of a number of separately created and stored content learning objects that can be accessed and dynamically assembled. Based on research that addresses the transfer of data from short-term to long-term memory, each learning object will preferably contain only the content that could be absorbed by the student within an approximately two to five minute time frame, e.g., within a three-minute time frame. Multiple related content objects could be included within the dynamically assembled module as long as their combined delivery time was within an acceptable time limit.

The following describes how multiple content objects may be ordered within a module to deliver a seamless presentation for the student. To meet the student's “visual preference”, each screen may include appropriate visual elements. This may involve the use of color, graphics, diagrams, charts, video dips, animations, and/or other visual elements. Most explanatory material will be presented using text rather than audio narration.

To meet the student's “global preference”, the content will preferably be presented by beginning with an overview of the concepts to be learned in the module. It would not be a list, but may instead be motivational in nature (e.g.: a video or animated presentation, a story, or a brief description of how the knowledge to be taught is used in real-life situations). In addition, the content may be related to other areas of knowledge that the student would be expected to have.

After the student has been given the “big picture”, each element to be used to master the concept or skill will be preferably presented in detail. The appropriate content objects are retrieved and displayed in a logical order that relates directly to one or more of the elements included in the initial overview.

After all concepts contained within the module have been explained, a brief summary of the important points covered in the module may be outlined. Again, it will be preferably linked back to the “big picture”.

310. Create Visual-Sequential Version

This version of the course may be built to meet the preferences of a learner whose primary sensory preference is visual and whose primary preference for organizing information in long-term memory is sequential. It should be noted that the “visual-sequential” version of the module may actually be made up of a number of separately created and stored content learning objects that can be accessed and dynamically assembled as desired. Based on research that addresses the transfer of data from short-term to long-term memory, each learning object may preferably contain only the content that could be absorbed by the student within, e.g., a three-minute time frame. Multiple related content objects could be included within the dynamically assembled module as long as their combined delivery time is preferably twenty minutes or less.

The following description clarifies how multiple content objects may be ordered within a module to deliver a seamless presentation for the student. To meet the student's “visual preference”, each screen, substantially each screen, a majority of screens or simply a weighted preference of screens presented would preferably include appropriate visual elements. This would involve the use of color, graphics, diagrams, charts, video clips, animations, and/or other visual elements. Most explanatory material will be presented by using text rather than audio narration.

To meet the student's “sequential preference”, the content may be presented by beginning with a very brief motivational exercise or explanation so the student knows what category or framework into which the information to be presented will fit. This might be nothing more than a sentence or two identifying the category into which the elements presented in the module will fall (ex: “There are at least five ways to handle an angry customer. Wouldn't it make your job easier if you knew what they were?”), a question relating to the how the information might be used (ex: “Did you know that you can create a perfectly formatted letter by following just five rules?”), or an exercise or game in which the student is asked to identify or interact in some way with the concept.

After the student has been given the general framework into which each of the elements to be used to master the concept or skill will fit, each element is preferably presented in a “step-by-step”, “numbered”, or “cookbook fashion in accordance with the sequential learning preference of the student.

After all elements associated with the module have been explained, a summary of the important points covered in the module may be outlined and the elements will be related to the “big picture” into which the elements fit. This may be accomplished through the use of a video clip, a diagram or chart, an animation, or another visual exercise.

311. Create Auditory-Global Version

This version of the course would be built to meet the preferences of a learner whose primary sensory preference is auditory and whose primary preference for organizing information in long-term memory is global.

It should be noted that the “auditory-global” version of the module may actually be made up of a number of separately created and stored content learning objects that can be accessed and dynamically assembled as desired. Based on research that addresses the transfer of data from short-term to long-term memory, each learning object may contain only the content that could be absorbed by the student within, e.g., a three-minute time frame. Multiple related content objects could be included within the dynamically assembled module as long as their combined delivery time is preferably twenty minutes or less.

The following description clarifies how multiple content objects may be ordered within a module to deliver a seamless presentation for the student. To meet the student's “auditory preference”, each screen, substantially each screen, a majority of screens or a weighted preference of screens presented would preferably include appropriate auditory elements. This would involve the use of narration, music, sound effects, rhythmic presentations, the use of animated avatars who present ideas and/or give feedback, and/or brief video clips. Most explanatory material will be presented by using more audio narration or other audio devices than text.

To meet the student's “global preference”, the content will be presented by beginning with an overview of the concepts to be learned in the module. It will preferably not be a list, but will be motivational in nature (e.g., a video or animated presentation, a story, or a brief description of how the knowledge to be taught is used in real-life situations). In addition, the content may be related to other areas of knowledge that the student would be expected to have.

After the student has been given the “big picture”, each element used to master the concept or skill will be presented in detail. After each detailed explanation, the element will be related back to the larger concept.

After all elements associated with the module have been explained, a brief summary of the important points covered in the module will be outlined. Again, it will be linked back to the “big picture”.

312. Create Auditory-Sequential Version

This version of the course is built to meet the preferences of a learner whose primary sensory preference is auditory and whose primary preference for organizing information in long-term memory is sequential. It should be noted that the “auditory-global” version of the module may actually be made up of a number of separately created and stored content learning objects that can be accessed and dynamically assembled as desired. Based on research that addresses the transfer of data from short-term to long-term memory, preferably each learning object will contain only the content that could be absorbed by the student within, e.g., a three-minute time frame. Multiple related content objects could be included within the dynamically assembled module as long as their combined delivery time is preferably twenty minutes or less.

The following description clarifies how multiple content objects may be ordered within a module to deliver a seamless presentation for the student. To meet the student's “auditory preference”, each screen or a preference of screens, etc., presented will include appropriate auditory elements. This would involve the use of auditory narration, music, sound effects, rhythmic presentations, the use of animated avatars who present ideas and/or give feed back, and/or brief video clips. For example, a majority of explanatory material may be presented by using more audio narration or other audio devices than text or pictures.

To meet the student's “sequential preference”, the content may be presented by beginning with a very brief motivational exercise or explanation so the student knows what category or framework into which the information to be presented will fit. This might be nothing more than a sentence or two identifying the category into which the elements presented in the module will fall (ex: “There are at least five ways to handle an angry customer. Wouldn't it make your job easier if you knew what they were?”), a question relating to the how the information might be used (ex: “Did you know that you can create a perfectly formatted letter by following just five rules?”), or an exercise or game in which the student is asked to identify or interact in some way with the concept. In the case of auditory learners, the questions or sentences above would most often be delivered using the spoken word rather than text.

After the student has been given the general framework into which each of the elements used to master the concept or skill will fit, each element is presented in a “step-by-step”, “numbered”, or “cookbook fashion.

After all elements associated with the module have been explained, a summary of the important points covered in the module may be outlined and the elements will be preferably related to the “big picture” into which the elements fit.

313. Store Course Versions

After the creation of each of the four exemplary versions of a module (built in #309 through #312 above), course content (in the form of content learning objects) will be stored in the Course Content Table of the learning system database. Each content object may be labeled with the module name and number for which it was created, the course ID to which it belongs, and the learning preference to which it applies (i.e.: visual-sequential, visual-global, auditory-sequential, or auditory-global, or other preferences or preference profiles). This table may be accessed to dynamically generate and deliver the correct version of the course to an individual student. There may also be a search engine that would use a pointer to access a look up table and automatically provide one or more relevant objects and/or modules based on the search term (e.g., visual or auditory or sequential or global or concrete or abstract, etc., or tow or more of such terms). Again, a weighting may be applied to the terms an the engine may be configured to provide modules, objects or courses of study that best match the weighting and/or may provide a group of modules or objects that as a group weightedly match the selection preference profile or single preference, even if a particular object or module does not exact match.

314. Create Concrete Interactive Learning Object

This interactive object is built to meet the preferences of a student whose meta-cognitive processes are more concrete than abstract. This means that the student finds it easier to learn if they deal with concrete facts, things that can be verified with their five senses, and can be related to the “real world”.

The activity will preferably be created using one of the automated activity builders included in the preferred learning system. These include the Project Builder, the Discussion Builder, and some of the Toolkit Activity Builders (see Appendix B for a description of exemplary Toolkit activities).

Activities created using the Project Builder, the Discussion Builder (found in the Instructor's section of the learning system), or the Free-Form Response Builder (found in the Toolkit Activities section) are advantageously flexible. In the case of a project being built for a concrete learner, e.g., the project could require fieldwork, the use of a real-world application, the creation of a mini case study based on real-world observation, or the design and implementation of a real-world experiment. Creating a discussion activity for a concrete learner might include participation in an online discussion revolving around solving a real-world problem, discussing specific examples of the topic being studied, or participating in a discussion via role playing. Creating a free-form activity would involve responding to thought-provoking questions through an online free-form response tool, and might require the concrete learner to compare and contrast, categorize, or serially order data.

On a less general level, the student could be asked to categorize information using the “Category Solitaire”, “Check the Match”, or “Draw a Straight” activities. The concrete organizer could exercise their preference to observe and/or participate in fieldwork using the “Opinions” or “Treasure Quest” activity, or they could use “The Perfect Match” activity to exercise their preference to organize things through matching. Finally, they might use a serial ordering organizing pattern to complete a “One Step at a Time” activity (For Toolkit Activity descriptions, see Appendix B).

Whatever the activity, all exercises created for concrete learners will preferably emphasize one or more of their natural metacognitive organizing patterns. These include using observation, fieldwork, case studies, role playing, their physical senses, or real-world references to organize new information. In addition, concrete learners respond well to organizing information by classification, serial ordering, or reversibility.

315. Create Abstract Interactive Learning Object

This activity is built to meet the preferences of a student whose metacognitive processes are more abstract than concrete. This means that the student finds it easier to learn if he/she can organize new information by relating it to a concept, theory, or inference. Their preferred method of mental organization often involves identifying connections and creating a mental “meaning” for the new information. They like to do independent research and explore new information on their own.

The activity will be created using one of the automated activity builders included in the preferred learning system. These include the Project Builder, the Discussion Builder, and some of the Toolkit Activity Builders (see Appendix B for a description of exemplary Toolkit activities).

Activities created using the Project Builder, the Discussion Builder (found in the Instructor's section of the learning system), or the Free-Form Response Builder (found in the Toolkit Activities section) are advantageously flexible. Any of these formats could be used to ask the abstract learner to gather data, build a model that explains how new information works, solve an example problem, create a demonstration, answer questions based on independent research, or identify facts that support a concept or theory.

On a more specific level, the student could be asked to gather data using an online polling device such as the “Ask the Audience” activity, or an interviewing device such as the “Opinions” activity. They could also engage in online and library searches using the “Treasure Quest” activity, or utilize independent research to create an in-depth answer to the “Why” activity. (For Toolkit Activity descriptions, see Appendix B).

Whatever the activity, exercises created for abstract learners may emphasize one or more of their natural metacognitive organizing patterns. These include identifying data or facts to support an existing concept, theory, or “big picture”, or conversely, using data or facts to create a new theory, concept, or mental model.

316. Create Active Interactive Learning Object

This activity is built to meet the preferences of a student whose metacognitive processes are more active than reflective. Like concrete organizers, active learners find it easier to recall and use new ideas if they can “do” something with the new material. They desire to try it out, find out how it is useful, and experience it first hand. However, unlike concrete learners, active organizers easily make mental connections to new ideas by interacting with others during the learning process. They are also more likely to want to explore new ideas via trial and error and require less structure in their activities.

The activity will preferably be created using one of the automated activity builders included in the learning system software engine. These include the Project Builder, the Discussion Builder, and some of the Toolkit Activity Builders (see Appendix B for a description of exemplary Toolkit activities).

Like concrete learners, a project created for an active learner could require fieldwork, the use of a real-world application, the creation of a mini case study based on real-world observation, or the design and implementation of a real-world experiment. However, active learners might also be asked to explain or demonstrate the new concept to others, create and tell a story relating to the information, or embark on a trial-and-error project from which they will draw conclusions.

Creating a discussion activity for an active learner might include participation in an online debate, online role playing, online brainstorming with others, or participating in a mock conference online. Creating a free-form activity would involve responding to thought-provoking questions through an online free-form response tool, and might require the active learner to plan a demonstration, explain a process to be posted online for the use of others, or explain how they were able to use new information or apply a new skill in their everyday life.

On a less general level, the active student could be asked to participate in an online learning contest between students (i.e.: “The learning Challenge”), gather related information from others using the “Opinions” activity, or work with a team to complete a “Treasure Quest” activity. (For Toolkit Activity descriptions, see Appendix B).

Whatever the activity, exercises created for active learners preferably emphasize one or more of their natural metacognitive organizing patterns. These include using trial and error to explore new material, being able to relate new material to a practical application, and creating a link between the new material and interactions with others.

317. Create Reflective Interactive Learning Object

This activity is built to meet the preferences of a student whose metacognitive processes are more reflective than active. This means that the student finds it easier to learn if they have time to reflect on new material. Reflective organizers usually prefer to work alone while processing new information.

The activity will preferably be created using one of the automated activity builders included in the learning system engine. These include the Project Builder, the Discussion Builder, and some of the Toolkit Activity Builders (see Appendix B for a description of exemplary Toolkit activities).

A project built for a reflective learner might require the student to log reflections on new concepts or information in a journal, record ideas or observations, develop and/or respond to thought questions, create a plan for acquiring and/or applying new information, or brainstorm about new ways to apply the information. Creating a discussion activity for a reflective learner might include brainstorming an idea off line and then posting conclusions to a discussion thread, contributing ideas on how to solve a problem, or contributing observations on a topic.

Creating a free-form activity would involve responding to thought-provoking or rhetorical questions through an online free-form response tool, and might require the reflective learner to compare and contrast, categorize, list similarities and differences, sequence or order data, summarize new material in their own words, or list possible applications of new skills or concepts.

Like concrete learners, reflective organizers thrive on categorizing, matching, comparing, contrasting, and sequencing data. Therefore, on a less general level, the student could be asked to categorize information using the “Category Solitaire”, “Check the Match”, or “Draw a Straight” activities, to match information items using “The Perfect Match”, use reflection to respond to the “Why” activity, or sequence items using the “One Step at a Time” activity. (For Toolkit Activity descriptions, see Appendix B). Reflective learners also respond well to the use of memory aids, so they also might enjoy the “Flash the Facts” and “Life or Death” activities. Unlike concrete learners, however, reflective organizers typically prefer to be able to do their work alone and not in a group.

Whatever the activity, exercises created for reflective learners preferably emphasize one or more of their natural metacognitive organizing patterns. These include using such organizing tools as observation, classification, noticing similarities and differences, comparing and contrasting, and serial ordering. In addition, it is important that all activities created for a reflective learner include a requirement for the student to work alone so they are able to reflect on new material in depth.

318. Create Analytical Interactive Learning Object

This activity is built to meet the preferences of a student whose metacognitive processes are more analytical than intuitive. This means that the student finds it easier to learn if he/she can work within organized, linear tasks, is asked to focus on details, and can solve the problem or acquire new knowledge by following a logical, step-by-step progression.

The activity will be created using one of the automated activity builders included in the learning System engine of the preferred embodiment. These may include the Project Builder, the Discussion Builder, and some of the learning system Toolkit Activity Builders (see Appendix B for a description of exemplary Toolkit activities).

A project built for an analytical learner might present the student with a problem or mini case study and ask the student to analyze it in the light of a concept or theory, identify what the student feels are the most essential principles or goals to be gleaned from the case study, or draw a diagram representing how specific facts are related to specific concepts.

Creating a discussion activity for an analytical learner might include asking the student to participate in a discussion to ferret out root causes of a problem, describe real-world examples of the application of a concept or procedure, or design an organized process that would result in the achievement of an identified goal.

Creating a free-form activity would involve responding to thought-provoking or rhetorical questions through an online free-form response tool, and might require the analytical learner to create a list of the most important facts supporting a particular concept or theory, identify the topics which should be preferably mastered to achieve a particular goal, or respond to a question that requires the student to relate causes to effects.

On a less general level, the student could be asked to analyze information using the “Treasure Quest” activity, or explore cause and effect using the “Why” activity. Because of their preference to analyze through attention to detail, they would also profit from a categorizing activity such as “Draw a Straight” or one of the more conventional quiz games such as the “Multiple Choice Challenge”, “The learning Tournament”, or “Ring the Bell”. (For Toolkit Activity descriptions, see Appendix B).

Whatever the activity, exercises created for analytical learners preferably emphasize one or more of their natural metacognitive organizing patterns. These include using logic, a linear step-by-step approach and the preference to create mental relationships between the known and the new (i.e.: known facts to new concepts or theories, specific details to the “big picture”, existing general knowledge to new ideas having some of the same characteristics, etc,).

319. Create Intuitive Interactive Learning Object

This activity is built to meet the learning preferences of a student whose metacognitive processes are more intuitive than abstract. This means that the student finds it easier to learn if they can begin with an idea, image, or concept, develop a mental framework into which that idea or concept fits, and then fill in the details. The activity will be created preferably using one of the automated activity builders included in the learning system software engine. These may include the Project Builder, the Discussion Builder, and some of the learning system Toolkit Activity Builders (see Appendix B for a description of preferred Toolkit activities).

A project built for an intuitive learner should accommodate the “discovery method” of learning. Intuitive learners are essentially risk takers and prefer to structure their own learning to a greater extent than other organizers. Therefore, an “intuitive” project might present a description, theory, or application and ask the student to answer the question “why?”. Conversely, the student might also be asked to practice an application before they are introduced to the theory. In both cases, only general guidelines and suggestions on where the student might obtain helpful information should be provided.

Creating a discussion activity for an intuitive learner might include asking the student to participate in a discussion to identify possible ways to solve a problem, share the results of their investigation into a subject, or share their ideas on how some process really works. Creating a free-form activity would involve responding to thought-provoking or rhetorical questions through an online free-form response tool, and might require the intuitive learner to create a theory to explain a grouping of facts, or create a personal study plan to meet a goal.

On a less general level, the student could be asked to use their preference to explore by answering the question raised by the “Why” activity. (For some preferred Toolkit Activity descriptions, see Appendix B).

Whatever the activity, exercises created for intuitive learners preferably emphasize one or more of their natural metacognitive organizing patterns. These include their tendency to wish to “intuitively” jump to a conclusion in the form of an idea or concept before knowing the facts of the matter, and to then build the mental framework that justifies this concept by adding details through a cycle of trial and error, concept revision, more exploration, more revision, etc., until all of the details are clear.

320. Store Interactive Learning Objects

After the creation of each of the interactive learning objects (built in accordance with #314 through #319 above, for example), the objects may be stored in a Course Activity Table of the learning system database. Each completed activity may be labeled with a module name and number, the course ID to which it belongs, and a metacognitive and/or sensory preference to which it applies (e.g.: concrete, abstract, active, reflective, analytical, intuitive and/or kinesthetic and/or any of many other existing metacognitive and/or sensory preferences or preference combinations that may be employed for active learning depending or based upon the technology that will be used to implement it). This table will be accessed to dynamically generate and deliver the correct version of the activity to an individual student.

321. Student Login or Identification

When a student wishes to work on a course module, they sign on to the preferred learning system in one of two ways. In an authenticated environment, access to the learning system is transparent and automatically granted by the authenticating servers. One example of this is a Microsoft Active Directory environment, where Active Directory automatically controls access to certain courses. In the second scenario, authentication is not transparent and the user will be presented with a ‘log-in’ screen where they enter a user name and password for verification. (User data may be stored both within Microsoft Active Directory and the learning system Database for redundancy purposes). The user's unique ID and dominant learning preferences, both sensory and metacognitive or either/or, or a more complex preference profile, may be stored in both the MS Active Directory and the Profile table in the Database. They are retrieved at this time and remain persistent while the user is in the application.

322. Student Selects Course

Once logged on to the system, the students select the “Course” button on their home page to access course content. If the student is only enrolled in a single course, they are immediately transferred into the course environment for that course. If the student is enrolled in multiple courses, they are transferred to a menu where they are asked to click on the title of the course in which they wish to work before the appropriate course environment is displayed. In either case, the course ID is retrieved from the Courses Table in the learning system database and remains persistent while the student remains in the course.

323. Student Selects Module

Once the student reaches the course environment, a menu is displayed which lists the number and title of each module in the selected course. The student is asked to click on the title of the course module in which they wish to work. The module ID, the module title, and the module number are retrieved from the Modules Table in the learning system database and remains persistent while the student remains in the module.

324. Access Module Content

The course ID, module ID, and student's learning preferences (obtained preferably in accordance with steps #321 through #323) are preferably used to access the Course Content Table of the learning system database. Using the student's major learning preferences (i.e.: visual-sequential, visual-global, auditory-sequential, or auditory-global), or a single preference, or a more complex preference profile, the appropriate content objects are retrieved from the Course Content Table and assembled.

325. Display Individual Content

The appropriate course module is displayed on the student's screen or other output device for immediate learning, or alternatively for storing for later learning, and the student begins to view or otherwise sense or experience the appropriate course content. As the student proceeds through the module, links to interactive learning objects may be displayed following each individual concept explanation. When the student encounters one of these links, they may be asked to click on that button.

326. Access Individual Activity

Once the student clicks on the activity link, the Course Activities Table in the learning system database will be accessed. Using the student's metacognitive learning preferences (preferably as retrieved from the Profile Table in step 320 above), a concrete or abstract learning object may be retrieved, an active or reflective learning object may be retrieved, and/or an analytical or intuitive learning object may be retrieved, and/or a kinesthetic object may be retrieved.

327. Display Activity

Once the appropriate activity is retrieved, it will be displayed or otherwise output for learning or storing for later learning. The student will be preferably asked or suggested or otherwise prompted to interact with the activity by using a concept preferably that they were just taught. These activities may require a wide variety of interactions in many different formats, but all will preferably require some thought, application, and/or the use of the computer keyboard, mouse or other input device to respond.

328. Input Responses

As the student proceeds through the activity, responses from the keyboard or mouse or other input device are evaluated and moved into temporary storage.

329. Activity Scored?

When the student clicks on the button that signals they have completed the activity, if the results can be automatically scored as a numeric value, that score will be computed and the results will be stored in the Activity Scores Table in the learning system database. Otherwise, the results will be preferably passed to #330 below for a second test.

330. Is Activity Critiqued?

If the results could not be scored automatically, they could be tested to see whether they could be critiqued instead. If they are in the form of a free-form answer, or a project submission where the activity/project should instead be reviewed by the instructor, the results will be stored in the Submissions Table and a message may be sent to the instructor to inform him/her that a student's activity is awaiting their critique.

331. Access Critique Predefined Process

Interactive-learning-object results that are submitted for critique may not be assessible by the instructor in real-time. There may be a delay of several days before the instructor critiques the student's submission. (For a greater understanding of this process, refer to the narrative descriptions for the “Assess Activities” (#77) and “Assess Projects” (#78) processes in the Learnin system narrative described above with reference to FIGS. 1-21.)

For the purposes of explaining the course delivery methodology, however, it should be noted that if, after reviewing the student's free-form submission, the instructor assigns a numeric grade to the activity, the numeric grade may be stored in the Activity Scores Table. If no numeric grade is stored, the instructor's written critique may be sent to the student through the Message Center, and may be stored permanently in the Replies Table.

332. Has Module Been Completed?

Once an activity has been completed, input may be checked to determine whether or not the student has reached the end of the module. If not, the module content may be again displayed or otherwise output. The course content may be presented beginning with the line or image that immediately followed the point from which the student was transferred to the activity described. Working with the content will continue until another activity is detected, or the end of the module is reached. If another activity is detected, the student will preferably be transferred to the new activity and the functions covered in items #326 through 331 may again be executed. If the activity has been completed, control may be passed to item #333 below.

333. Access Recall Room

At the end of a module, the student may be preferably automatically transferred to the Recall Room to complete their first recall activity in connection with the concepts or skills taught in the completed module. For a complete description of how Recall Room works, see the below description with reference to FIGS. 28-32.

Recall Room

The following description is set forth with reference to FIGS. 28-32. Each of the numbered paragraphs below represent an explanation of the purpose and content of a particular recall room function as provided in FIGS. 28-32.

401. Enter Recall Room

Students may enter the Recall Room from two different locations. In one instance, students are sent directly to the Recall Room by clicking on an icon at the end of each module of a course. In the other instance, students may choose to enter the “Recall Room” by clicking the appropriate button on their home page. The page that is displayed at this location is a “Welcome” screen that describes how the Recall Room works and why it will help students to be able to recall anything they want to remember for as long as a lifetime. Students progress to the next screen by clicking the “Continue” button.

402. Check Link Data

Once the student enters the Recall Room (#401 above), the link data that is attached to that event is checked to determine the location from which the student entered the recall room: If a course ID and module number are present, it is assumed that the student arrived in the Recall Room by clicking a button placed at the end of a course module. If the module number is not present within the link data, it is assumed that the student entered the Recall Room by clicking the “Recall Room” navigation button on their home page.

403. Check Recall Aid Table

Next, the Recall Aid table in the learning system database is checked to see whether a mneumonic memory aid for the appropriate course module exists.

404. Is Entry From Module?

Based on the information gathered in steps #402 and #403 above, the student is transferred to either the area of the Recall Room that has been constructed for students who entered the room from a course module, or the area of the Recall Room that has been constructed for students who entered the room from their home page.

405. Is Memory Aid Present?

If the student entered the Recall Room from a course module and a memory aid exists, the student is transferred to the Module Recall Menu (#406). However, if the student entered the Recall Room from a course module and a memory aid is not present, the student is transferred directly to the Create New Recall Activity function (#408).

If the student entered the Recall Room from their home page and a memory aid does exist, they are transferred a version of the Home Page Recall Menu (#407) that contains four menu choices. If, on the other hand, they entered the Recall Room from their home page and a memory aid is not present, they are transferred to a version of the Home Page Recall Menu that contains only three choices.

406. Module Recall Menu

A two-choice menu is displayed. The student is asked to choose whether they want to “Create a New Recall Activity” for the module from which they were transferred, or whether they wish to “View a Module Memory Aid”. They indicate their choice by clicking on the appropriate menu entry and are transferred to the first page of the chosen function.

407. Entry From Home Page

If the student entered the Recall Room by clicking on the “Recall Room” navigation button on their home page and if a memory aid exists, they are transferred to the “four choice” menu. Here they are asked to select an activity they wish to perform. They can choose to “Create a New Recall Activity”. “Log a Recall Activity”, “Review Existing Log Entries”, or “View a Module Memory Aid”. If the student entered the Recall Room from their home page and a memory aid does not exist, they will be presented with the “three choice” menu instead. In this version the “View a Module Memory Aid” option is not available.

408. Create New Recall Activity

This is a predetermined process that is used in the Recall Room whenever a student wishes to create a new recall activity. A student enters this functional area in one of three ways. He/she may be directly transferred to the first screen of the creation function because (a) they clicked the “Recall Room” button at the end of a course module and no mneumonic was found in the Recall Aid database table, or (b) the student selected the “Create New Recall Activity” choice on the “Module Menu” screen, or (c) the student selected the “Create New Recall Activity” choice on the “Home Page Menu”. The sequence of steps in this functional area are described in items #410 through #416 below.

409. Work with Mneumonic

This is a predetermined process in which a student can retrieve and work with a memory aid that was designed for a specific module in a specific course. A student enters this functional area in one of two ways. He/she selects the “View Module Memory Aid” menu item from the Module Recall Menu, or he/she selects the “View Module Memory Aid” menu item from the Home Page Recall Menu. The sequence of steps in this functional area are described in items #417 through #422 below.

410. Select Item Association

The first page of the “Create New Recall Activity” function requires the student to select the type of recall item they wish to create. From a drop down box they are asked to choose to create a recall item that will be associated with a particular course, a recall item that will be associated with a specific module within a course, or a recall item that will not be associated with any course at all.

411. Create New Recall Activity

On this screen the student is asked to describe in detail what it is they want to be able to recall, and then to describe the activity or exercise they will practice in each recall session. This is accomplished by displaying free-from text boxes that are used to enter descriptive text of any length.

Since students may desire guidance in creating an effective exercise that they can perform, an “Examples” button is available on this page. If they choose to click this button, they will be transferred to #414 below. Once they have reviewed the examples, they will be returned to this page to continue creating the activity.

In either case, once the student clicks the “Submit” button on this page, the recall item is saved.

412. Is Example Requested?

If the student chose to view examples of effective recall activities by clicking the “Example” button in #411, they are transferred through a process described in #413 and #414 below. If they choose to create and submit their recall activity without viewing examples, they are transferred to #415 below.

413. Check Profile Table

If a student elects to view examples (#411 above), the Profile table in the learning system database is accessed. The student's individual learning preferences are extracted and are passed to #414 below.

414. Display Examples

The learning preferences gathered from the Profile table are used to dynamically generate examples that match a particular student's strengths. These examples are then displayed to the student for their use. Once they have been viewed, the student is returned to the “Create New Recall Activity” screen to finish building their exercise.

415. Store in Recall Concept Table

Once the student completes the process of creating the new activity, both the description of what they want to remember and the description of what they will do in each practice session is saved in the Recall Concept table of the learning system database.

416. Display Instructions

Once the recall activity is created, the student is expected to immediately participate in their first recall session. This screen explains how the four sessions are timed, what is expected of the student in each session, and what they should do next. After reading these instructions, students will complete their first recall exercise, and then be transferred to the Home Page Recall Menu (#407) so they can log the results of their first session.

417. Recall Aid Table

When a student selects the “Work With Mneumonic” link from either the Module Recall Menu or the Home Page Recall Menu, the Recall Aid table of the learning system database is accessed to determine whether multiple mneumonics exist for a particular module of a course.

418. Multiple Memory Aids?

Based upon the data accessed from the Recall Aid table, the student is routed to one of two paths. If multiple memory aids are present, the student is transferred to the Memory Aid Menu (#419). Otherwise, the Recall Concept table in the learning system database is immediately accessed (#420).

419. Memory Aid Menu

If multiple memory aids are available for the module within which the student wishes to work, each mneumonic is listed on the Memory Aid Menu. When the student clicks on the selected mneumonic title, the Recall Concept table is accessed.

420. Recall Concept Table

Whether the student selects a specific mneumonic from the Memory Aid Menu, or there is only one memory aid available, the appropriate mneumonic is retrieved from the Recall Concept table in the learning system database and is formatted for display.

421. Display Instructions

This page contains a description of the purpose of the memory aid that will be displayed in #422. In addition, it will contain instructions on how the memory aid is to be used. Both a global overview of the mneumonic and an element-by-element perspective will be described. The desired outcome will be emphasized. Testing features, how to use feedback, and the importance of time spent in this exercise will be explained.

422. View Memory Aid

The selected mneumonic will be displayed. Typically, the mneumonic will be a guided animation that first builds familiarity with each element of the mneumonic, and then presents a start-to-finish animation that ties each element together. Once the animation has been completed, the student will be automatically transferred to a screen where they will test their ability to recall the information that the mneumonic taught (#423).

423. Test Recall

On this screen, the student will be asked to create an ordered list of the material that was practiced in #422. The list will be submitted when complete.

424. Mneumonic Table?

The Mneumonic table in the learning system Database is accessed to retrieve the correct ordered list of things to be remembered from this particular mneumonic.

425. Recall Feedback

The ordered list that was retrieved from the Mneumonic table (#424) is compared to the ordered list submitted by the student in #423. Elements which were not remembered correctly (either in content or order) are determined and feedback is displayed. After reading the feedback, the student can choose to click a button allowing them to practice the exercise again, or click a button that indicates they wish to end this practice session.

426. Repeat Exercise?

If the student chose to repeat the exercise (see #425), they will be transferred back to the View Memory Aid screen (#423) and the exercise (including screens #423, #424, and #425) will be repeated. If the student chose to end the practice session, they will be transferred to the Log Recall Activity predefined process (#427).

427. Log Recall Activity

This is a predefined process in which the student is able to enter the results of a recall activity practice session into their Recall Log. A student can enter this process by selecting the “Log a Recall Activity” menu choice from the Home Page Recall Menu (#407), or can be automatically transferred to this process after completing a session of practice with a memory aid (ie: Work With Memory Aid (#409). The functional steps of this process are described in #428 through #432 below.

428. Automatic Entry?

If the student is automatically transferred to the Log Recall Activity predefined process from the Work With Mneumonic predefined process, they are transferred directly to the Log Entry Screen (#431). However, if they arrived here by selecting the “Log a Recall Activity” menu item from the Home Page Recall Menu (#407), then they are transferred to the “Select Concept to Log” screen (see #429 below).

429. Select Concept to Log

The student is asked to select the Recall Room activity for which they wish to log a practice session. This is done by highlighting the appropriate entry from a drop-down list of all of the active Recall Room activities. This selection is passed to the Recall Concept Table (#430).

430. Recall Concept Table

Using the data provided in #429, the Recall Concept table in the learning system database is accessed and the appropriate recall activity data is retrieved. The student is then transferred to the Log Entry Screen (#431).

431. Log Entry Screen

The recall activity title and description for which the student wishes to make an entry is displayed. The student is then asked to answer three questions by selecting the appropriate answer from a drop-down list, and then enter comments describing what they accomplished in the appropriate recall session. The questions asked are (a) Did you successfully complete this exercise? (Yes or No), (b) How long did you spend practicing/rehearsing this information? (5 minutes, 10 minutes, or 15 minutes), and (c) Were you successfully able to immediately recall the information at the end of the session? (Yes or No). Once the requested data is complete, the student is asked to submit this information.

432. Recall Log Table

The information submitted by the student in #431 is stored in the Recall Log Table. Once this has been accomplished, the student is transferred back to the Home Page Recall Menu (#407).

433. Review Existing Logs

This is a predefined process in which the student is able to view or delete entries in their personal Recall Log, or modify the practice exercise for the recall activity. A student can enter this process by selecting the “Review Existing Recall Logs” menu choice from the Home Page Recall Menu (#407). The functional steps of this process are described in #433 through #440 below.

434. Recall Concept Table

When a student enters the “View Recall Log” process, the Recall Concept table in the learning system database is accessed to retrieve the title, latest session number, and recall item course association for each of that student's recall items.

435. Display List of Titles

The log entries retrieved in #434 are displayed to the students. The screen lists the title of each recall item, the name of the course and module that is associated with the entry (or “not course specific” if the item is not related to a course), and the date on which the recall exercise was created. In addition, a “Log” button and an “Update” button are available next to each entry. A “Return” button appears at the bottom of the page.

Students viewing this page have several options. They can click the “Log” button to see all entries in their Recall Log that relate to a specific recall activity, they can click on the “Modify” button next to an entry to view or modify the original recall activity description, they can click on the “Delete” button to delete the original recall activity, or they can merely view the page and click on the “Return” button to go back to the Home Page Recall Menu (#407).

436. Select Log?

Input from the student is checked. If the student clicked the “Log” button on the display screen (#435), the Recall Log Table is accessed (#437). Otherwise, the input is transferred to the next checkpoint (#39).

437. Recall Log Table

The Recall Log table of the learning system database is accessed to retrieve all log entries made for the particular recall activity that was selected by the student in #436 above.

438. Display Log Entries

Once all log entries for the selected recall item have been retrieved, the student is transferred to a screen that displays the description that they originally entered as to what it was they wanted to remember, as well as a list of all session entries. For each entry shown, the following items are displayed: session number; the date on which the session took place; whether or not they completed the session; the time spent on that session; whether or not they were able to recall the target information after the session; and the free-form description they entered as to what it was they did in that session. Once the student has finished viewing the entries, they will click on the “Return” button and be returned to the “List of Titles” screen from which they came (#435).

439. Select Modify?

Input from the student is again checked. If the student clicked the “Modify” button on the display screen (#435), the Recall Concept Table is accessed (#440). Otherwise, the input is transferred to the next check point (#442).

440. Recall Concept Table

The Recall Concept table of the learning system database is accessed to retrieve the original definition of the recall goal and the description of the activity or exercise to be practiced for the particular recall activity that was selected by the student in #439 above. This information is passed to #41 below.

441. Display Original Recall Activity

The student who clicked on the “Modify” button is transferred to this screen that displays the original data they entered when the selected recall activity was created. Once they have made the desired changes, they can click the “Submit” button to store the revised description in the Recall Concept table.

442. Select Delete?

Input from the student is again checked. If the student clicked the “Delete” button on the display screen (#435), the student is transferred to the “Display Warning Screen” (#443). Otherwise, the input is transferred to the next checkpoint (#446).

443. Display Warning Screen

The student who chose to delete a recall item will be transferred to this screen that displays a message indicating they are about to permanently delete a recall item. The student is given a chance to abort or confirm the deletion.

444. Wish to Delete?

Input from the student in screen #443 is checked. If the student confirmed the deletion, the Recall Concepts table is accessed and the recall activity is deleted. Otherwise, the student is returned to the display screen (#435) for another choice.

445. Recall Concept Table

If the student confirmed the deletion in #443, the Recall Concept Table is accessed and the recall activity is deleted.

446. Return to Main Menu?

Input from the student is again checked. If the student clicked the “Return” button on the primary display screen in this function (#435), they are transferred back to the Home Page Recall Menu (#407).

Alternative Applications

The preceding description focuses on the ability to dynamically generate, store in a database, retrieve from a database and/or deliver learning content in the form of objects, modules and/or courses of study for students based upon or configured according to individual learning preferences and/or preference profiles, and/or upon preferences or preference profiles of the objects, modules and/or courses of study, and/or weighted distributions of learning preference profiles of the student or object, module or course of study. There are business models and underlying premises that are also applicable in other contexts. The technologies, techniques, premises and processes included in the preferred learning system's idiom can be more generally utilized and can be applied in any creation, formatting, design, development, storage, distribution, delivery, or interfacing of content that is stored, delivered and/or displayed electronically via any device.

Content can be created and/or reformatted to appeal to an individual's specific physiological and metacognitive predispositions with regard to how they receive, interact with, assimilate, organize, associate, store, access, recall and utilize information. Some, but not all, of the many potential markets include media, advertising, searching technologies, kiosks, software and applications with user interfaces.

In the media and advertising market, for example, broadcast and online content can be reformatted to reflect an individual's specific preferences and then be displayed using the appropriate sensory mode, metacognitive organization, timing, and content. The result would be improved reception and greater recall of the advertiser's message.

Another addressable market includes any application, device, or appliance with a user interface, such as software applications, kiosks, ATMs, and electronic equipment. For example, specific software applications such as word processing programs, spreadsheets, and presentation software could be created with the potential to recognize and adapt to the user's preferences, so that users with different preferences could utilize the same application, but with different interfaces and delivery structures. Furthermore, both specific-purpose and general-use devices that display data and information, like kiosks and ATMs, could also present different interfaces and information in accordance with the user's preferences.

Portals, search engines, information retrieval services, and the World Wide Web are other markets that could incorporate individual assimilation preferences for design, display and delivery. People searching for information, viewing content, or interacting with data would benefit greatly if the interfacing, displaying, and interaction with the content was conducted in accordance with the user's preferences. For example, as people move from web site to web site by utilizing a browser (or any other interface technology), devices could recognize and present Web-based information and content according to the idiom's principles, processes, technologies and techniques.

Other potential markets for the idiom could include knowledge bases, content storage, and content distribution. For example, as content is created according to preferences, that content could be stored, shared, marketed, and distributed to other entities or users for a multitude of purposes, such as marketing messaging, information services, course creation and dynamic course delivery. For example, if a particular user wanted to search for, access, and utilize information based upon, identified, and indexed by preferences, users could potentially acquire the content object by searching and accessing a repository. The user could either buy the content, or share some of his content in return. Similarly, as a user is interacting with content, intelligence built into the delivery process could recognize the appropriateness of supplementary content formatted according to the preference, and then immediately locate that content from a repository and dynamically insert it into the delivery and display.

While an exemplary drawings and specific embodiments of the present invention have been described and illustrated, it is to be understood that that the scope of the present invention is not to be limited to the particular embodiments discussed. Thus, the embodiments shall be regarded as illustrative rather than restrictive, and it should be understood that variations may be made in those embodiments by workers skilled in the arts without departing from the scope of the present invention as set forth in the appended claims and structural and functional equivalents thereof.

In addition, in methods that may be performed according to preferred embodiments herein and that may have been described above, the operations have been described in selected typographical sequences. However, the sequences have been selected and so ordered for typographical convenience and are not intended to imply any particular order for performing the operations, except for those where a particular order may be expressly set forth or where those of ordinary skill in the art may deem a particular order to be necessary.

What is claimed is:

1. A method of developing a customized electronic course of study, comprising:
(a) identifying course content relating to one or more particular courses of study;
(b) electronically generating multiple learning modules based on the identified content; and
(c) storing the learning modules according to multiple learning preference profiles for selective electronic retrieval and delivery in generating the customized electronic course of study based on a selected learning preference profile.

2. The method of claim 1, the different learning preference profiles including weighted emphasis on different learning preferences.

3. The method of claim 2, at least one of the learning modules including at least two versions that are configured according to different learning preference profiles, and at least one learning preference profile of a learning module other than the learning module including the at least two versions including a weighted emphasis on one or more learning preferences.

4. The method of claim 1, at least one learning preference profile of one or more of the multiple learning modules including a weighted emphasis on one or more learning preferences.

5. The method of claim 1, at least one of the learning modules including at least two versions that are configured according to different learning preference profiles.

6. The method of claim 1, a plurality of the multiple learning modules being configured according to a profile of one or more learning preferences.

7. The method of claim 1, the electronic generating of the multiple learning modules comprising electronically generating multiple learning objects, and assembling at least two of the multiple learning objects to form at least one of the multiple learning modules.

8. The method of claim 7, one or more of the multiple learning objects being configured according to a profile of one or more learning preferences.

9. The method of claim 8, at least one learning preference profile of the one or more of the multiple learning objects including a weighted emphasis on one or more learning preferences.

10. The method of claim 7, the multiple learning objects each having a temporal extent not greater than two minutes.

11. The method of claim 10, the multiple learning modules each having a temporal extent not greater than twenty minutes.

12. The method of claim 7, the multiple learning objects each having a temporal extent not greater than five minutes.

13. The method of claim 12, the multiple learning modules each having a temporal extent not greater than twenty minutes.

14. The method of claim 1, the multiple learning modules each having a temporal extent not greater than twenty minutes.

15. The method of claim 1, further comprising:
electronically generating multiple learning objects; and
storing the learning objects for selective electronic retrieval and delivery in generating the customized electronic course of study based on the particular learning preference profile.

16. The method of claim 15, further comprising assembling at least two of the multiple learning objects to form at least one of the multiple learning modules.

17. The method of claim 15, at least one of the multiple learning modules comprising a single learning object.

18. The method of claim 1, at least one learning module being configured for presentation according to at least one sensory preference and including at least two associative metacognitive activity objects.

19. The method of claim 18, at least one learning module being configured for presentation according to at least one sensory preference and at least one organizational metacognitive preference, and including at least one associative metacognitive activity object.

20. The method of claim 1, at least one learning module being configured for presentation according to at least one sensory preference and at least one organizational metacognitive preference, and including at least one associative metacognitive activity object.

21. The method of claim 1, at least one learning module including at least one associative metacognitive activity object.

22. The method of claim 21, the at least one associative metacognitive activity object comprising a concrete object, an abstract object, an active object, a reflective object, an analytical object or an intuitive object or a combination thereof.

23. The method of claim 21, the at least one learning module being configured for presentation according to at least one sensory preference.

24. The method of claim 1, the at least one learning module being configured for presentation according to at least one sensory preference.

25. The method of claim 24, the at least one sensory preference comprising visual, auditory or verbal or a combination thereof.

26. The method of claim 1, at least one learning module including at least one kinesthetic sensory activity object.

27. The method of claim 1, at least one learning module being configured for presentation according to at least one organizational metacognitive preference.

28. The method of claim 27, the at least one organizational metacognitive preference including a sequential preference or a global preference or a combination thereof.

29. The method of claim 1, further comprising ordering the multiple learning modules.

30. The method of claim 1, at least one learning module being configured for presentation according to at least one sensory preference and at least one organizational metacognitive preference.

31. The method of claim 30, said at least one learning module including a weighted emphasis on said at least one sensory preference and said at least one organizational metacognitive preference.

32. The method of claim 1, the storing including tagging for retrieval the multiple learning modules according the multiple learning preference profiles.

33. A method of developing an electronic course of study, comprising:
(a) identifying course content relating to a particular course of study;
(b) electronically generating multiple learning modules based on the identified content;
(c) at least one learning module being configured for presentation according to at least one sensory preference and including at least two associative metacognitive activity objects; and
(d) storing the learning modules for electronic retrieval and delivery in generating the electronic course of study.

34. The method of claim 33, at least one learning module being configured for presentation according to at least one sensory preference and at least one organizational metacognitive preference, and including at least one associative metacognitive activity object.

35. The method of claim 33, each of the multiple learning modules being configured according to a profile of one or more learning preferences.

36. The method of claim 33, a plurality of the multiple learning modules being configured according to a profile of one or more learning preferences.

37. The method of claim 36, the learning module storing including tagging said plurality of learning modules for retrieval according to said profile.

38. The method of claim 33, the electronic generating of the multiple learning modules comprising electronically generating multiple learning objects, and assembling at least two of the multiple learning objects to form at least one of the multiple learning modules.

39. The method of claim 33, at least one learning preference profile of one or more of the multiple learning modules including a weighted emphasis on one or more particular learning preferences.

40. The method of claim 33, said at least one learning module that is configured for presentation according to the at least one sensory preference and including the at least two associative metacognitive activity objects including a weighted emphasis on said at least one sensory preference

41. The method of claim 33, the storing including tagging for retrieval the multiple learning modules according multiple learning preference profiles.

42. A method of developing an electronic course of study, comprising:
(a) identifying course content relating to a particular course of study;
(b) electronically generating multiple learning modules based on the identified content;
(c) at least one learning module being configured for presentation according to at least one sensory preference and at least one organizational metacognitive preference, and including at least one associative metacognitive activity object; and
(d) storing the learning modules for electronic retrieval and delivery in generating the electronic course of study.

43. The method of claim 42, said at least one learning module that is configured for presentation according to the at least one sensory preference and the at least one metacognitive organizational preference and including the at least one associative metacognitive activity object including a weighted emphasis on said at least one sensory preference.

44. The method of claim 42, said at least one learning module that is configured for presentation according to the at least one sensory preference and the at least one metacognitive organizational preference and including the at least one associative metacognitive activity object including a weighted emphasis on said at least one organizational metacognitive preference.

45. The method of claim 42, each of the multiple learning modules being configured according to one or more profiles of one or more learning preferences.

46. The method of claim 42, a plurality of the multiple learning modules being configured according to one or more profiles of one or more learning preferences.

47. The method of claim 46, the storing of the learning modules including tagging the plurality of learning modules for retrieval according said profiles.

48. The method of claim 42, the electronic generating of the multiple learning modules comprising electronically generating multiple learning objects, and assembling at least two of the multiple learning objects to form at least one of the multiple learning modules.

49. The method of claim 42, at least one learning preference profile of one or more of the multiple learning modules including a weighted emphasis on one or more particular learning preferences.

50. The method of claim 42, the storing including storing and tagging for retrieval the multiple learning modules according multiple learning preference profiles.

51. A method of developing an electronic course of study, comprising:
(a) identifying course content relating to a particular course of study;
(b) electronically generating multiple learning modules based on the identified content;
(c) at least one learning module being configured for presentation according to a preference profile including at least one sensory preference and at least one organizational metacognitive preference; and
(d) storing the learning modules for electronic retrieval and delivery in generating the electronic course of study, including storing said at least one learning module for retrieval according to said preference profile.

52. The method of claim 51, said at least one learning module that is configured for presentation according to the at least one sensory preference and the at least one metacognitive organizational preference including a weighted emphasis on said at least one sensory preference.

53. The method of claim 51, said at least one learning module that is configured for presentation according to the at least one sensory preference and the at least one metacognitive organizational preference including a weighted emphasis on said at least one organizational metacognitive preference.

54. The method of claim 51, each of the multiple learning modules being configured, stored and tagged for retrieval according to one or more profiles of one or more learning preferences.

55. The method of claim 51, a plurality of the multiple learning modules being configured, stored and tagged for retrieval according to one or more profiles of one or more learning preferences.

56. The method of claim 51, the electronic generating of the multiple learning modules comprising electronically generating multiple learning objects, and assembling at least two of the multiple learning objects to form at least one of the multiple learning modules.

57. The method of claim 51, at least one learning preference profile of one or more of the multiple learning modules including a weighted emphasis on one or more particular learning preferences.

58. The method of claim 51, the storing of the learning module including tagging said at least one learning module for retrieval according to each of said at least one sensory preference and said at least one organizational preference.

59. The method of claim 51, the storing of the learning module including tagging said at least one learning module for retrieval according to a combination of said at least one sensory preference and said at least one organizational preference.

60. The method of claim 51, at least one learning module including at least one associative metacognitive activity object.

61. The method of claim 60, the at least one associative metacognitive activity object comprising a concrete object, an abstract object, an active object, a reflective object, an analytical object or an intuitive object or a combination thereof

62. The method of claim 60, the at least one learning module being configured for presentation according to at least one sensory preference.

63. The method of claim 51, the at least one sensory preference comprising visual, auditory, or verbal or a combination thereof.

64. The method of claim 51, at least one learning module including at least one kinesthetic sensory activity object.

65. The method of claim 51, the at least one organizational metacognitive preference including a sequential preference or a global preference or a combination thereof.

66. A method of retrieving for delivery a customized electronic course of study, comprising:
(a) accessing an electronic storage device containing data corresponding to multiple learning modules based on content relating to a particular course of study;
(b) selecting a learning preference profile for the customized course of study; and
(c) selectively electronically retrieving one or more of the learning modules from the electronic storage device for delivery based upon a comparison of the selected learning preference profile with learning preference profiles of the multiple learning modules.

67. The method of claim 66, wherein at least one of the learning modules includes at least two versions that are configured according to different learning preference profiles, the electronic retrieving further including electronically retrieving one of the two versions based upon a comparison of the selected learning preference profile with the different learning preference profiles of the two versions.

68. The method of claim 66, the different learning preference profiles including weighted emphasis on different learning preferences.

69. The method of claim 66, the electronic storage device further containing data corresponding to multiple learning objects, the selective electronic retrieval comprising:
selectively electronically retrieving one or more of the multiple learning objects, and assembling the selected learning objects into one or more learning modules.

70. The method of claim 69, the selected learning objects comprising multiple learning objects, the selected learning object assembling comprising assembling at least two of the multiple learning objects into a same learning module.

71. The method of claim 69, at least one of the selectively retrieved learning modules comprising a selectively retrieved learning object.

72. The method of claim 66, the selected learning preference profile for the course of study comprising at least one sensory preference, and at least one selectively retrieved learning module being configured for presentation according to the at least one sensory preference and including at least two associative metacognitive activity objects.

73. The method of claim 66, the selected learning preference profile for the course of study comprising at least one sensory preference and at least one organizational metacognitive preference, and at least one selectively retrieved learning module being configured for presentation according to the at least one sensory preference and the at least one organizational metacognitive preference and including at least one associative metacognitive activity object.

74. The method of claim 66, at least one selectively retrieved learning module including at least one associative metacognitive activity object.

75. The method of claim 66, at least one selectively retrieved learning module including at least one kinesthetic sensory activity object.

76. The method of claim 66, at least one selectively retrieved learning module being configured for presentation according to at least one sensory preference and at least one organizational metacognitive preference.

77. The method of claim 76, said at least one selectively retrieved learning module including a weighted emphasis on said at least one sensory preference and said at least one organizational metacognitive preference.

78. The method of claim 66, at least one learning module including at least one associative metacognitive activity object.

79. The method of claim 78, the at least one associative metacognitive activity object comprising a concrete object, an abstract object, an active object, a reflective object, an analytical object or an intuitive object or a combination thereof.

80. The method of claim 78, the at least one learning module being configured for presentation according to at least one sensory preference.

81. The method of claim 66, the at least one learning module being configured for presentation according to at least one sensory preference.

82. The method of claim 81, the at least one sensory preference comprising visual, auditory, or verbal or a combination thereof.

83. The method of claim 66, at least one learning module including at least one kinesthetic sensory activity object.

84. The method of claim 66, at least one learning module being configured for presentation according to at least one organizational metacognitive preference.

85. The method of claim 84, the at least one organizational metacognitive preference including a sequential preference or a global preference or a combination thereof.

86. An electronic database for generating a customized electronic course of study, the database having data stored therein corresponding to multiple learning modules configured for retrieval according to multiple learning preference profiles, the multiple learning modules including content relating to one or more particular courses of study.

87. The database of claim 86, at least one of the learning modules including at least two versions that are configured according to different learning preference profiles.

88. The database of claim 86, the one or more particular courses of study comprising multiple courses of study and the multiple learning modules also being stored for retrieval according to the multiple courses of study.

89. The database of claim 86, the different learning preference profiles including weighted emphasis on different learning preferences.

90. The database of claim 86, one or more of the multiple learning modules comprising multiple learning objects stored for retrieval according to forming at least a part of one or more corresponding learning modules.

91. The database of claim 90, the multiple learning objects each having a temporal extent not greater than two minutes.

92. The database of claim 91, the multiple learning modules each having a temporal extent not greater than twenty minutes.

93. The database of claim 90, the multiple learning objects each having a temporal extent not greater than five minutes.

94. The database of claim 93, the multiple learning modules each having a temporal extent not greater than twenty minutes.

95. The database of claim 86, the multiple learning modules each having a temporal extent not greater than twenty minutes.

96. The database of claim 86, at least one learning module being configured for presentation according to at least one sensory preference and including at least two associative metacognitive activity objects.

97. The database of claim 96, at least one learning module being configured for presentation according to at least one sensory preference and at least one organizational metacognitive preference, and including at least one associative metacognitive activity object.

98. The database of claim 86, at least one learning module being configured for presentation according to at least one sensory preference and at least one organizational metacognitive preference, and including at least one associative metacognitive activity object.

99. The database of claim 86, at least one learning module including at least one associative metacognitive activity object.

100. The database of claim 99, the at least one associative metacognitive activity object comprising a concrete object, an abstract object, an active object, a reflective object, an analytical object or an intuitive object or a combination thereof.

101. The database of claim 99, the at least one learning module being configured for presentation according to at least one sensory preference.

102. The database of claim 86, the at least one learning module being configured for presentation according to at least one sensory preference.

103. The database of claim 102, the at least one sensory preference comprising one or more selected from the group consisting of visual, auditory, and verbal.

104. The database of claim 86, at least one learning module including at least one kinesthetic sensory activity object.

105. The database of claim 86, at least one learning module being configured for presentation according to at least one organizational metacognitive preference.

106. The database of claim 105, the at least one organizational metacognitive preference being selected from the group consisting of a sequential preference and a global preference.

107. The database of claim 86, at least one learning module including at least one kinesthetic sensory activity object.

108. The database of claim 86, at least one learning module being configured and stored for retrieval according to at least one sensory preference and at least one organizational metacognitive preference.

109. The database of claim 108, said at least one learning module including a weighted emphasis on said at least one sensory preference and said at least one organizational metacognitive preference.

110. The database of claim 86, the data corresponding to the multiple learning modules being tagged according to the multiple learning preference profiles.

111. The database of claim 86, the data stored therein corresponding to multiple learning modules for retrieval according to multiple learning preference profiles being tagged for said retrieval according to said multiple learning preference profiles

112. An electronic database for generating a customized electronic course of study, the database having data stored therein corresponding to multiple learning modules for retrieval according to multiple learning preference profiles, the multiple learning modules including content relating to one or more particular courses of study, at least one of the learning modules including at least two versions that are configured according to different learning preference profiles, at least one of the learning modules being configured and stored for retrieval according to at least one sensory preference and at least one organizational metacognitive preference.

113. The database of claim 112, said at least one learning module that is configured and tagged according to said at least one sensory preference and said at least one organizational metacognitive preference including a weighted emphasis on said at least one sensory preference and said at least one organizational metacognitive preference.

114. The database of claim 113, said at least one learning module that is configured and tagged according to said at least one sensory preference and said at least one organizational metacognitive preference including at least one associative metacognitive activity object.

115. The database of claim 112, the data stored therein corresponding to multiple learning modules for retrieval according to multiple learning preference profiles being tagged for said retrieval according to said multiple learning preference profiles.

116. An electronic database for generating a customized electronic course of study, the database having data stored therein corresponding to multiple learning modules, the multiple learning modules including content relating to one or more particular courses of study, at least one of the learning modules being configured and stored for retrieval according to at least one sensory preference and including at least two associative metacognitive activity objects.

117. The database of claim 116, at least one learning module being configured and tagged according to at least one sensory preference and at least one organizational metacognitive preference, and including at least one associative metacognitive activity object.

118. The database of claim 117, said at least one learning module that is configured for presentation according to the at least one sensory preference and at least one metacognitive preference and including the at least one associative metacognitive activity object including a weighted emphasis on said at least one sensory preference.

119. The database of claim 116, said at least one learning module that is configured for presentation according to the at least one sensory preference and including the at least two associative metacognitive activity objects including a weighted emphasis on said at least one sensory preference.

120. The database of claim 116, the data stored therein corresponding to multiple learning modules for retrieval according to multiple learning preference profiles being tagged for said retrieval according to said multiple learning preference profiles

121. One or more processor readable storage devices having processor readable code embodied thereon, said processor readable code for programming one or more processors to perform a method of developing a course of study for learning, the method comprising:
(a) identifying course content relating to a particular course of study;
(b) electronically generating multiple learning modules based on the identified content;
(c) at least one of the learning modules including at least two versions that are configured according to different learning preference profiles; and
(d) storing the learning modules for selective electronic retrieval and delivery in generating the customized electronic course of study based on a particular learning preference profile.

122. The one or more storage devices of claim 121, the different learning preference profiles including weighted emphasis on different learning preferences.

123. The one or more storage devices of claim 122, at least one learning preference profile of a learning module other than the learning module including the at least two versions including a weighted emphasis on one or more learning preferences.

124. The one or more storage devices of claim 121, at least one learning preference profile of one or more of the multiple learning modules including a weighted emphasis on one or more learning preferences.

125. The one or more storage devices of claim 121, each of the multiple learning modules being configured according to a profile of one or more learning preferences.

126. The one or more storage devices of claim 121, a plurality of the multiple learning modules being configured according to a profile of one or more learning preferences.

127. The one or more storage devices of claim 121, the electronic generating of the multiple learning modules comprising electronically generating multiple learning objects, and assembling at least two of the multiple learning objects to form at least one of the multiple learning modules.

128. The one or more storage devices of claim 127, one or more of the multiple learning objects being configured according to a profile of one or more learning preferences.

129. The one or more storage devices of claim 128, at least one learning preference profile of the one or more of the multiple learning objects including a weighted emphasis on one or more learning preferences.

130. The one or more storage devices of claim 127, the multiple learning objects each having a temporal extent not greater than two minutes.

131. The one or more storage devices of claim 130, the multiple learning modules each having a temporal extent not greater than twenty minutes.

132. The one or more storage devices of claim 127, the multiple learning objects each having a temporal extent not greater than five minutes.

133. The one or more storage devices of claim 132, the multiple learning modules each having a temporal extent not greater than twenty minutes.

134. The one or more storage devices of claim 121, the multiple learning modules each having a temporal extent not greater than twenty minutes.

135. The one or more storage devices of claim 121, said method further comprising:
electronically generating multiple learning objects; and
storing the learning objects for selective electronic retrieval and delivery in generating the customized electronic course of study based on the particular learning preference profile.

136. The one or more storage devices of claim 135, said method further comprising assembling at least two of the multiple learning objects to form at least one of the multiple learning modules.

137. The one or more storage devices of claim 135, at least one of the multiple learning modules comprising a single learning object.

138. The one or more storage devices of claim 121, at least one learning module being configured for presentation according to at least one sensory preference and including at least two associative metacognitive activity objects.

139. The one or more storage devices of claim 138, at least one learning module being configured for presentation according to at least one sensory preference and at least one organizational metacognitive preference, and including at least one associative metacognitive activity object.

140. The one or more storage devices of claim 139, at least one learning module being configured for presentation according to at least one sensory preference and at least one organizational metacognitive preference, and including at least one associative metacognitive activity object.

141. The one or more storage devices of claim 121, at least one learning module including at least one associative metacognitive activity object.

142. The one or more storage devices of claim 141, the at least one associative metacognitive activity object comprising a concrete object, an abstract object, an active object, a reflective object, an analytical object or an intuitive object or a combination thereof.

143. The one or more storage devices of claim 141, the at least one learning module being configured for presentation according to at least one sensory preference.

144. The one or more storage devices of claim 121, the at least one learning module being configured for presentation according to at least one sensory preference.

145. The one or more storage devices of claim 144, the at least one sensory preference comprising visual, auditory, or verbal or a combination thereof.

146. The one or more storage devices of claim 121, at least one learning module including at least one kinesthetic sensory activity object.

147. The one or more storage devices of claim 121, at least one learning module being configured for presentation according to at least one organizational metacognitive preference.

148. The one or more storage devices of claim 147, the at least one organizational metacognitive preference including a sequential preference or a global preference or a combination thereof.

149. The one or more storage devices of claim 121, at least one learning module including at least one kinesthetic sensory activity object.

150. The one or more storage devices of claim 121, said method further comprising ordering the multiple learning modules.

151. The one or more storage devices of claim 121, at least one learning module being configured for presentation according to at least one sensory preference and at least one organizational metacognitive preference.

152. The one or more storage devices of claim 151, said at least one learning module including a weighted emphasis on said at least one sensory preference and said at least one organization metacognitive preference.

153. The method of claim 121, the storing including storing for retrieval the multiple learning modules according the multiple learning preference profiles.

154. One or more processor readable storage devices having processor readable code embodied thereon, said processor readable code for programming one or more processors to perform a method of developing a course of study for learning, the method comprising:
(a) identifying course content relating to a particular course of study;
(b) electronically generating multiple learning modules based on the identified content;
(c) at least one learning module being configured for presentation according to at least one sensory preference and including at least two associative metacognitive activity objects; and
(d) storing the learning modules for electronic retrieval and delivery in generating the electronic course of study.

155. The one or more storage devices of claim 154, at least one learning module being configured for presentation according to at least one sensory preference and at least one organizational metacognitive preference, and including at least one associative metacognitive activity object.

156. The one or more storage devices of claim 154, each of the multiple learning modules being configured according to a profile of one or more learning preferences.

157. The one or more storage devices of claim 154, a plurality of the multiple learning modules being configured according to a profile of one or more learning preferences.

158. The one or more storage devices of claim 154, the electronic generating of the multiple learning modules comprising electronically generating multiple learning objects, and assembling at least two of the multiple learning objects to form at least one of the multiple learning modules.

159. The one or more storage devices of claim 154, at least one learning preference profile of one or more of the multiple learning modules including a weighted emphasis on one or more particular learning preferences.

160. The one or more storage devices of claim 154, said at least one learning module that is configured for presentation according to the at least one sensory preference and including the at least two associative metacognitive activity objects including a weighted emphasis on said at least one sensory preference

161. The method of claim 154, the storing including storing for retrieval the multiple learning modules according the multiple learning preference profiles.

162. One or more processor readable storage devices having processor readable code embodied thereon, said processor readable code for programming one or more processors to perform a method of developing a course of study for learning, the method comprising:
(a) identifying course content relating to a particular course of study;
(b) electronically generating multiple learning modules based on the identified content;
(c) at least one learning module being configured for presentation according to at least one sensory preference and at least one organizational metacognitive preference, and including at least one associative metacognitive activity object; and
(d) storing the learning modules for electronic retrieval and delivery in generating the electronic course of study.

163. The one or more storage devices of claim 162, said at least one learning module that is configured for presentation according to the at least one sensory preference and the at least one metacognitive organizational preference and including the at least one associative metacognitive activity object including a weighted emphasis on said at least one sensory preference.

164. The one or more storage devices of claim 162, said at least one learning module that is configured for presentation according to the at least one sensory preference and the at least one metacognitive organizational preference and including the at least one associative metacognitive activity object including a weighted emphasis on said at least one organizational metacognitive preference.

165. The one or more storage devices of claim 162, each of the multiple learning modules being configured according to a profile of one or more learning preferences.

166. The one or more storage devices of claim 162, a plurality of the multiple learning modules being configured according to a profile of one or more learning preferences.

167. The one or more storage devices of claim 162, the electronic generating of the multiple learning modules comprising electronically generating multiple learning objects, and assembling at least two of the multiple learning objects to form at least one of the multiple learning modules.

168. The one or more storage devices of claim 162, at least one learning preference profile of one or more of the multiple learning modules including a weighted emphasis on one or more particular learning preferences.

169. The one or more storage devices of claim 162, the storing including storing for retrieval the multiple learning modules according the multiple learning preference profiles.

170. One or more processor readable storage devices having processor readable code embodied thereon, said processor readable code for programming one or more processors to perform a method of developing a course of study for learning, the method comprising:
(a) accessing an electronic storage device containing data corresponding to multiple learning modules based on content relating to a particular course of study;
(b) selecting a learning preference profile for the customized course of study; and
(c) selectively electronically retrieving one or more of the learning modules from the electronic storage device for delivery based upon a comparison of the selected learning preference profile with learning preference profiles of the multiple learning modules.

171. The one or more storage devices of claim 170, wherein at least one of the learning modules includes at least two versions that are configured according to different learning preference profiles, the selective electronic retrieving including electronically retrieving one of the two versions based upon a comparison of the selected learning preference profile with the different learning preference profiles of the two versions.

172. The one or more storage devices of claim 170, the different learning preference profiles including weighted emphasis on different learning preferences.

173. The one or more storage devices of claim 170, the electronic storage device further containing data corresponding to multiple learning objects, the selective electronic retrieval comprising:
selectively electronically retrieving one or more of the multiple learning objects, and assembling the selected learning objects into one or more learning modules.

174. The one or more storage devices of claim 173, the selected learning objects comprising multiple learning objects, the selected learning object assembling comprising assembling at least two of the multiple learning objects into a same learning module.

175. The one or more storage devices of claim 173, at least one of the selectively retrieved learning modules comprising a selectively retrieved learning object.

176. The one or more storage devices of claim 170, the selected learning preference profile for the course of study comprising at least one sensory preference, and at least one selectively retrieved learning module being configured for presentation according to the at least one sensory preference and including at least two associative metacognitive activity objects.

177. The one or more storage devices of claim 170, the selected learning preference profile for the course of study comprising at least one sensory preference and at least one organizational metacognitive preference, and at least one selectively retrieved learning module being configured for presentation according to the at least one sensory preference and the at least one organizational metacognitive preference and including at least one associative metacognitive activity object.

178. The one or more storage devices of claim 170, at least one selectively retrieved learning module including at least one associative metacognitive activity object.

179. The one or more storage devices of claim 170, at least one selectively retrieved learning module including at least one kinesthetic sensory activity object.

180. The one or more storage devices of claim 170, at least one selectively retrieved learning module being configured for presentation according to at least one sensory preference and at least one organizational metacognitive preference.

181. The one or more storage devices of claim 170, said at least one selectively retrieved learning module including a weighted emphasis on said at least one sensory preference and said at least one organizational metacognitive preference.

182. One or more processor readable storage devices having processor readable code embodied thereon, said processor readable code for programming one or more processors to perform a method of developing a course of study for learning, the method comprising:
(a) identifying course content relating to a particular course of study;
(b) electronically generating multiple learning modules based on the identified content;
(c) at least one learning module being configured for presentation according to a preference profile including at least one sensory preference and at least one organizational metacognitive preference; and
(d) storing the learning modules for electronic retrieval and delivery in generating the electronic course of study, including storing said at least one learning module for retrieval according to said preference profile.

183. The one or more storage devices of claim 182, said at least one learning module that is configured for presentation according to the at least one sensory preference and the at least one metacognitive organizational preference including a weighted emphasis on said at least one sensory preference.

184. The one or more storage devices of claim 182, said at least one learning module that is configured for presentation according to the at least one sensory preference and the at least one metacognitive organizational preference including a weighted emphasis on said at least one organizational metacognitive preference.

185. The one or more storage devices of claim 182, each of the multiple learning modules being configured, stored and tagged for retrieval according to one or more profiles of one or more learning preferences.

186. The one or more storage devices of claim 182, a plurality of the multiple learning modules being configured, stored and tagged for retrieval according to one or more profiles of one or more learning preferences.

187. The one or more storage devices of claim 182, the electronic generating of the multiple learning modules comprising electronically generating multiple learning objects, and assembling at least two of the multiple learning objects to form at least one of the multiple learning modules.

188. The one or more storage devices of claim 182, at least one learning preference profile of one or more of the multiple learning modules including a weighted emphasis on one or more particular learning preferences.

189. The one or more storage devices of claim 182, the storing of the learning module including tagging said at least one learning module for retrieval according to each of said at least one sensory preference and said at least one organizational preference.

190. The one or more storage devices of claim 182, the storing of the at least one learning module including tagging said at least one learning module for retrieval according to a combination of said at least one sensory preference and said at least one organizational preference.

191. The one or more storage devices of claim 182, the storing of the learning modules including storing for retrieval according to multiple learning preference profiles.
